(19) United States
(12) Patent Application Publication
(10) Pub. No.: US 2025/0348266 A1
(43) Pub. Date: Nov. 13, 2025

(54) Devices, Methods, and Graphical User Interfaces for Interactions Between Computer Systems

(71) Applicant: Apple Inc., Cupertino, CA (US)

(72) Inventors: Brendan B. Aronoff, San Francisco, CA (US); Aaron M. Melim, San Francisco, CA (US); Craig M. Federighi, Los Altos Hills, CA (US); Raymond S. Sepulveda, Portland, OR (US); Christopher P. Foss, San Francisco, CA (US); Chun Kin Minor Wong, Portland, OR (US); John O. Louch, Nederland, CO (US); David L. Biderman, Los Gatos, CA (US)

(21) Appl. No.: 19/169,118

(22) Filed: Apr. 3, 2025

Related U.S. Application Data
(60) Provisional application No. 63/646,932, filed on May 13, 2024.
(60) Provisional application No. 63/657,449, filed on Jun. 7, 2024.

(51) Int. Cl. G06F 3/14; G06F 3/04842; G06F 3/0486

(52) U.S. Cl. CPC G06F 3/1454; G06F 3/04842; G06F 3/0486

(57) ABSTRACT

A first computer system with a display generation component and one or more input devices is in communication with a second computer system. The first computer system displays, via the display generation component of the first computer system, a first notification generated by a first application installed on the first computer system and a second notification generated by a second application installed on the second computer system. While the first computer system displays the second notification, the computer system detects an input selecting the second notification. In response to detecting the input, the computer system displays, via the display generation component of the first computer system, a user interface that is generated by the second computer system.

### RELATED APPLICATIONS

This application claims priority to U.S. Provisional Patent Application No. 63/657,449, filed Jun. 7, 2024, and U.S. Provisional Patent Application No. 63/646,932, filed May 13, 2024, each of which is incorporated by reference in its entirety.

### TECHNICAL FIELD

This relates generally to electronic devices with touch-sensitive surfaces, including but not limited to electronic devices with touch-sensitive surfaces that interact with other electronic devices to cause performance of operations and/or functionalities at the other electronic devices.

### BACKGROUND

The use of touch-sensitive surfaces as input devices for computers and other electronic computing devices has increased significantly in recent years. Example touch-sensitive surfaces include touchpads and touch-screen displays. Such surfaces are widely used to manipulate user interfaces and objects therein on a display. However, methods and interfaces for interacting with multiple computers and other electronic devices are cumbersome and inefficient. For example, applications installed on a mobile device (e.g., a smartphone, tablet, or other mobile device) cannot be accessed via a computer system (e.g., a laptop, desktop, or other computer system). In another example, notifications received at the mobile device cannot be accessed and/or viewed at the computer system.

### SUMMARY

Accordingly, there is a need for electronic devices with faster, more efficient methods and interfaces for interactions with other electronic devices (e.g., interacting with a remote device via a computer system displaying a representation of the remote device). Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a first computer system that is in communication with a second computer system. The first computer system includes a display generation component and one or more input devices. The method includes displaying, via the display generation component of the first computer system, a plurality of notifications. The plurality of notifications includes a first notification generated by a first application installed on the first computer system and a second notification generated by a second application installed on the second computer system. The method includes, while the first computer system is displaying, via the display generation component of the first computer system, the second notification, detecting, via the one or more input devices of the first computer system, an input selecting the second notification of the plurality of notifications. The method includes, in response to the first computer system detecting the input, displaying, via the display generation component of the first computer system, a user interface generated by the second computer system.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for interactions between computer systems, thereby increasing the effectiveness, efficiency, and user satisfaction with such devices. Such methods and interfaces may complement or replace conventional methods for interactions between computer systems.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5I illustrate example user interfaces for wirelessly pairing a remote device to a computer system, in accordance with some embodiments.

FIGS. 6A-6W illustrate example user interfaces for interacting with a remote device via inputs directed at user interfaces of the remote device displayed on a computer system, in accordance with some embodiments.

FIGS. 7A-7C illustrate example user interfaces for interacting with notifications generated by applications installed on the computer system via input devices of the computer system, in accordance with some embodiments.

FIGS. 8A-8J illustrate example user interfaces for sending data from the remote device to a device other than the remote device and/or the computer system via inputs directed at the representation of the remote device displayed on the computer system, in accordance with some embodiments.

FIGS. 9A-9G illustrate example user interfaces for copying data from the remote device to the computer system via the representation of the remote device 506 displayed on the computer system, in accordance with some embodiments.

FIGS. 10A-10F illustrate example user interfaces for interacting with the remote device via the representation of the remote device while the remote device is performing standby functionality (e.g., the remote device is in a standby mode), in accordance with some embodiments.

FIGS. 11A-11B illustrate example user interfaces for selecting which remote device of a plurality of remote devices to automatically pair to the computer system 504, in accordance with some embodiments.

FIGS. 12A-12D illustrate example user interfaces for interacting with a secure application of the remote device via the representation of the remote device at the computer system and authentication hardware of the computer system, in accordance with some embodiments.

FIGS. 13A-13C illustrate example user interfaces for interacting with the remote device via the representation of the remote device displayed on the computer system 504 while the remote device is providing video captured by the remote device to the computer system, in accordance with some embodiments.

FIGS. 14A-14F are flow diagrams illustrating method 1400 of integrated interactions with multiple devices, in accordance with some embodiments.

### DESCRIPTION OF EMBODIMENTS

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

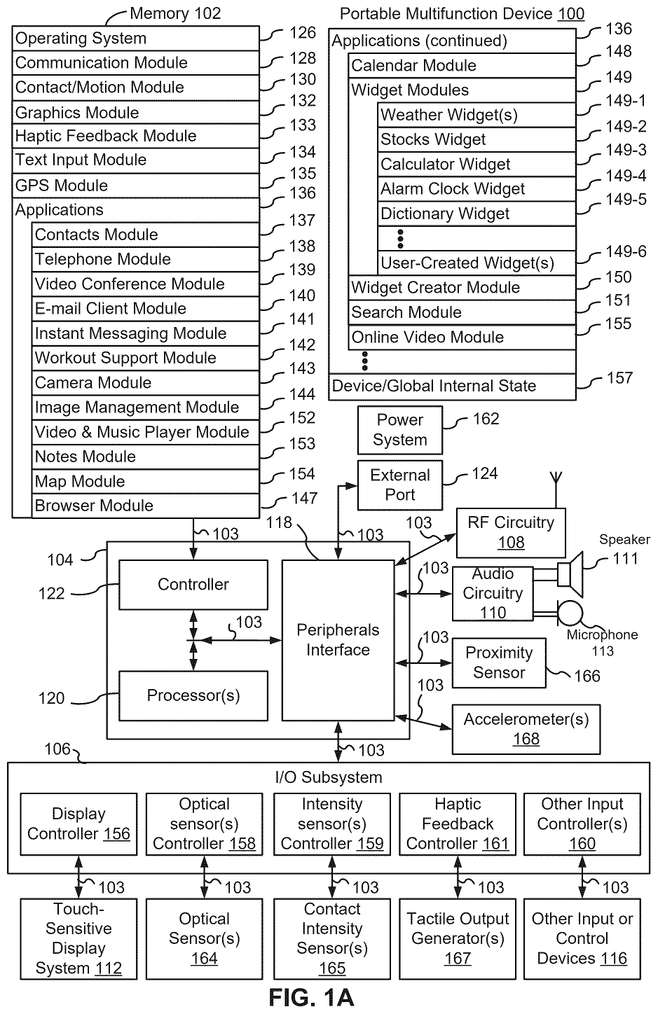

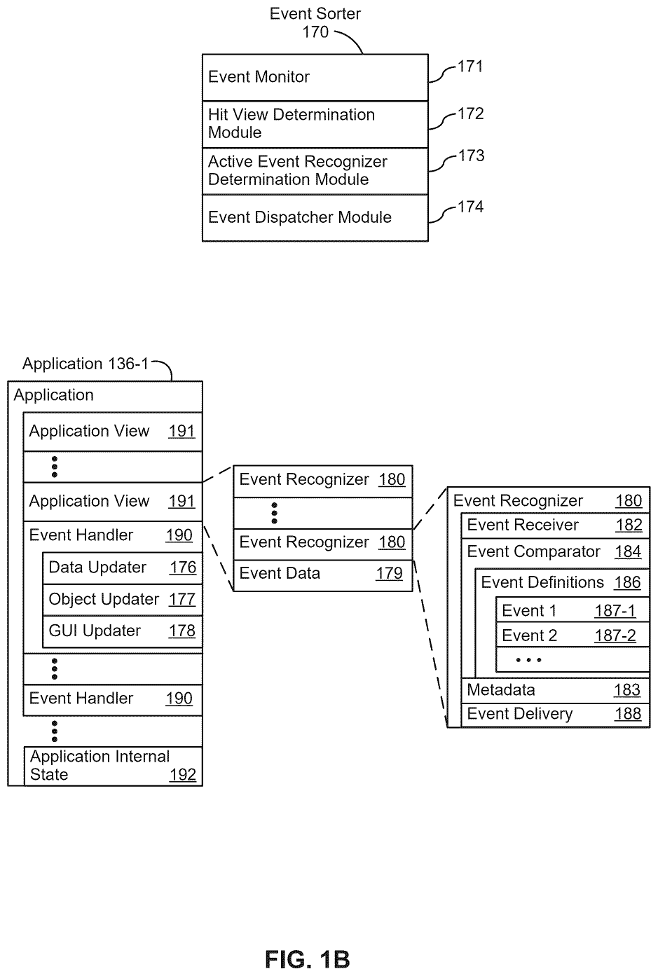

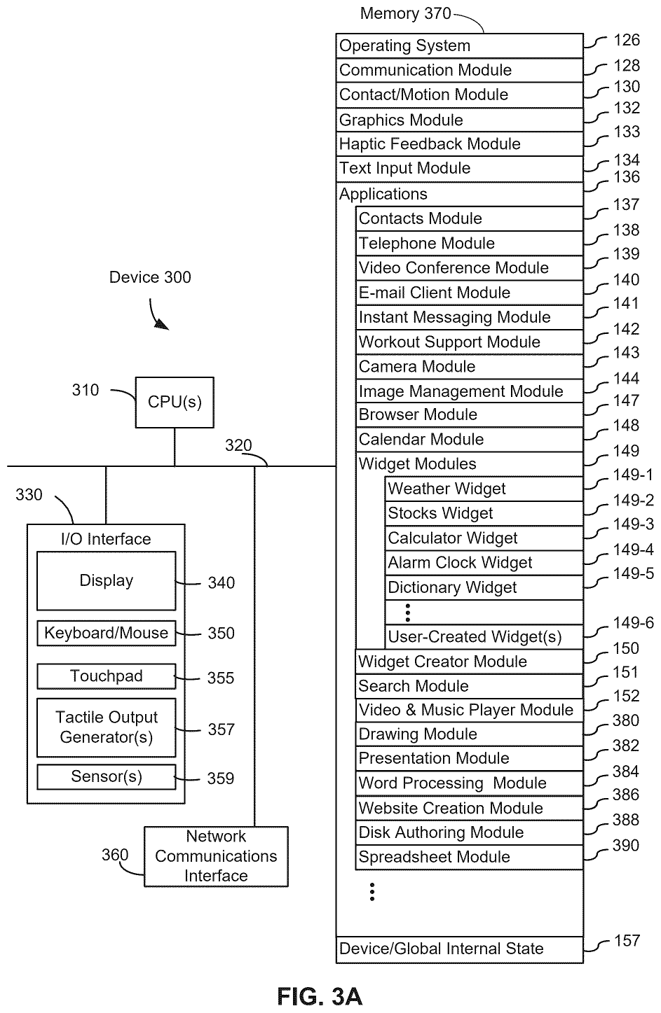

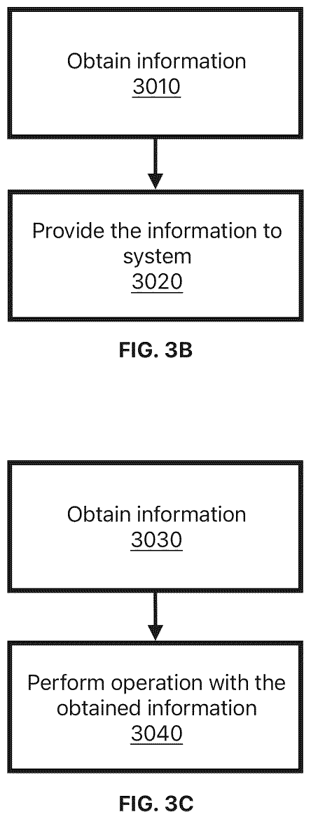

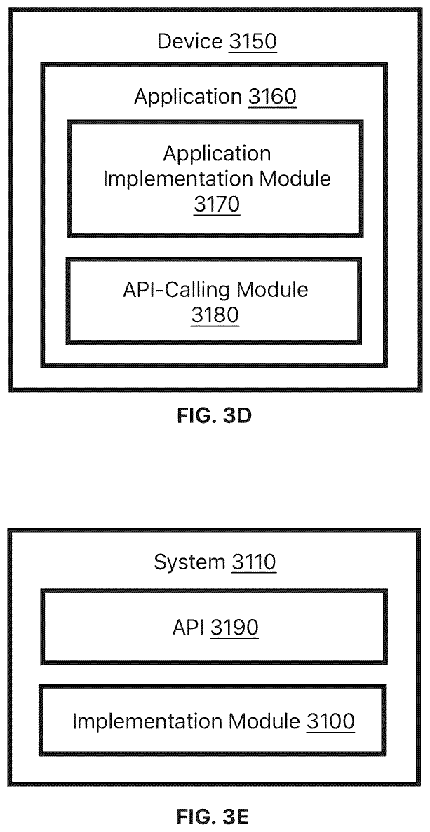

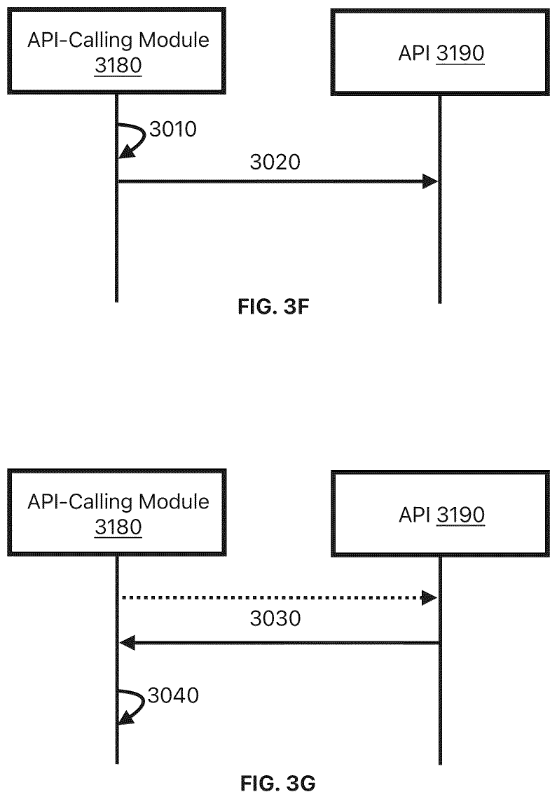

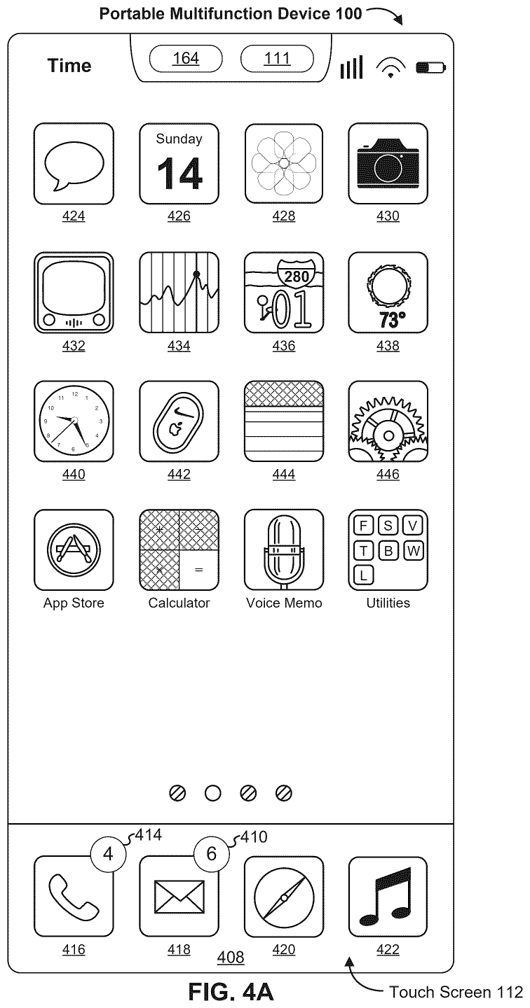

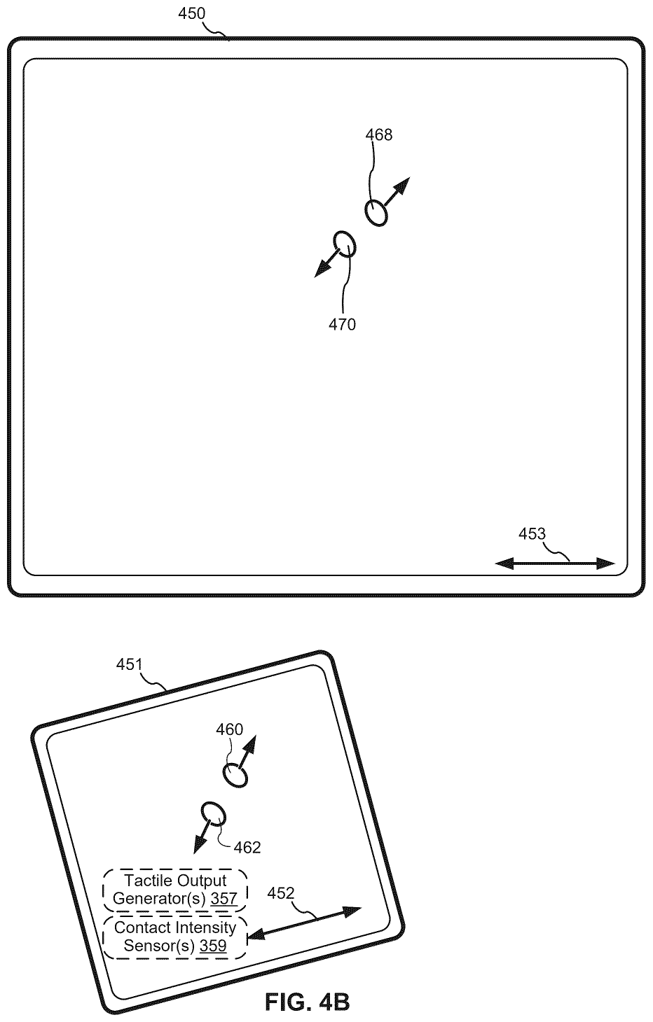

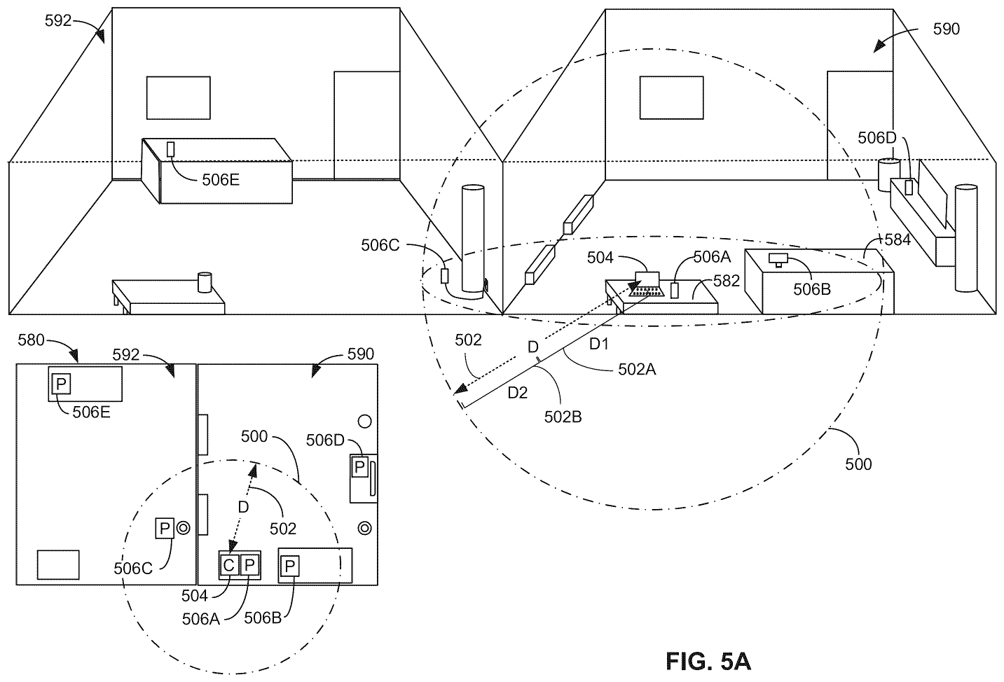

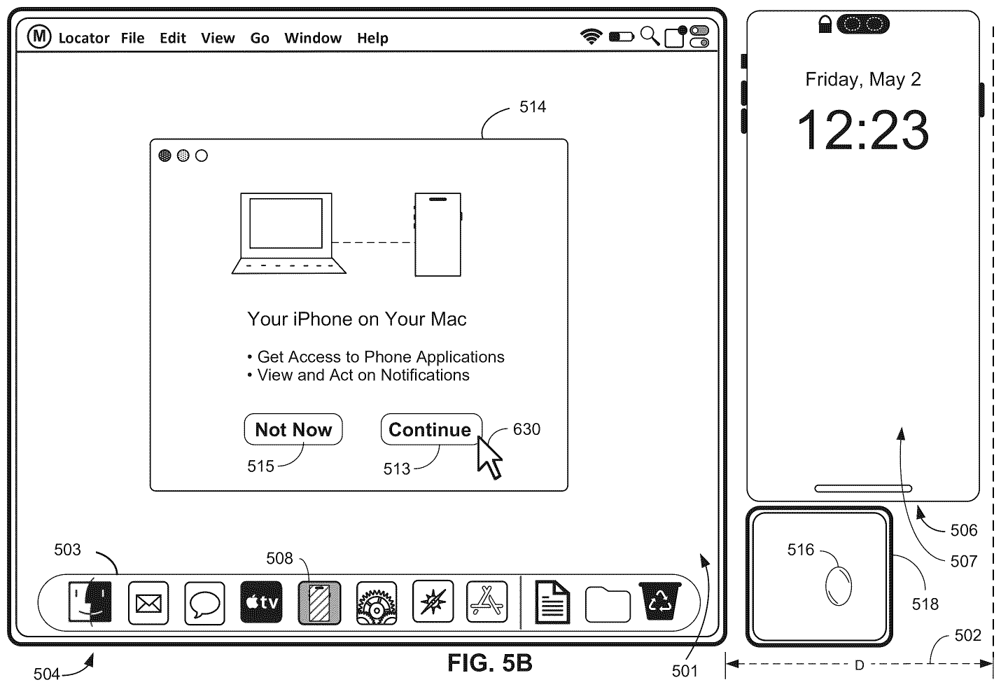

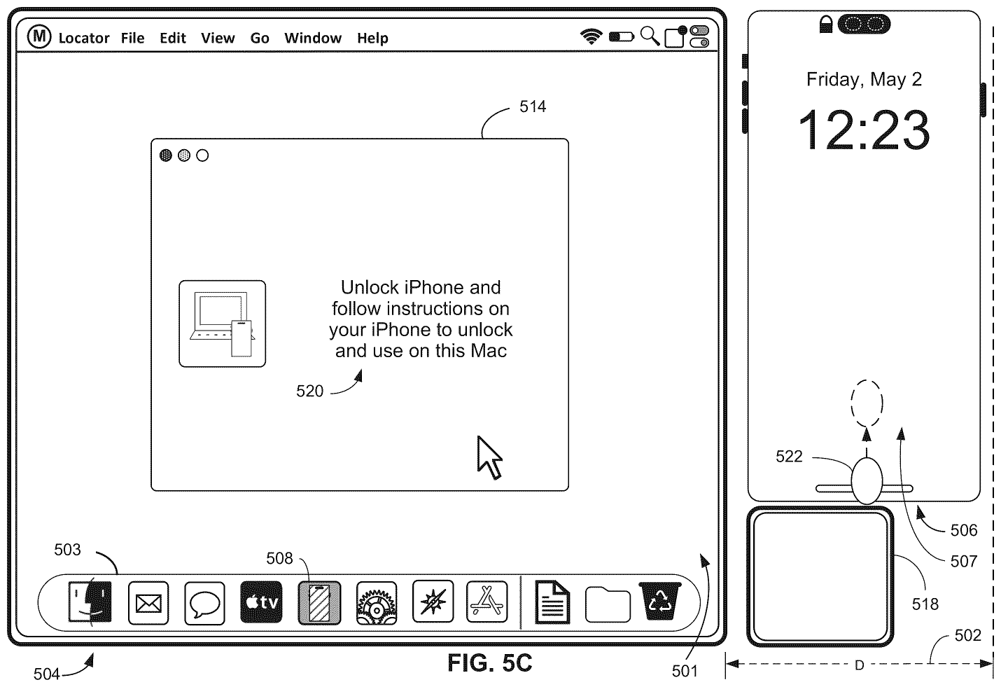

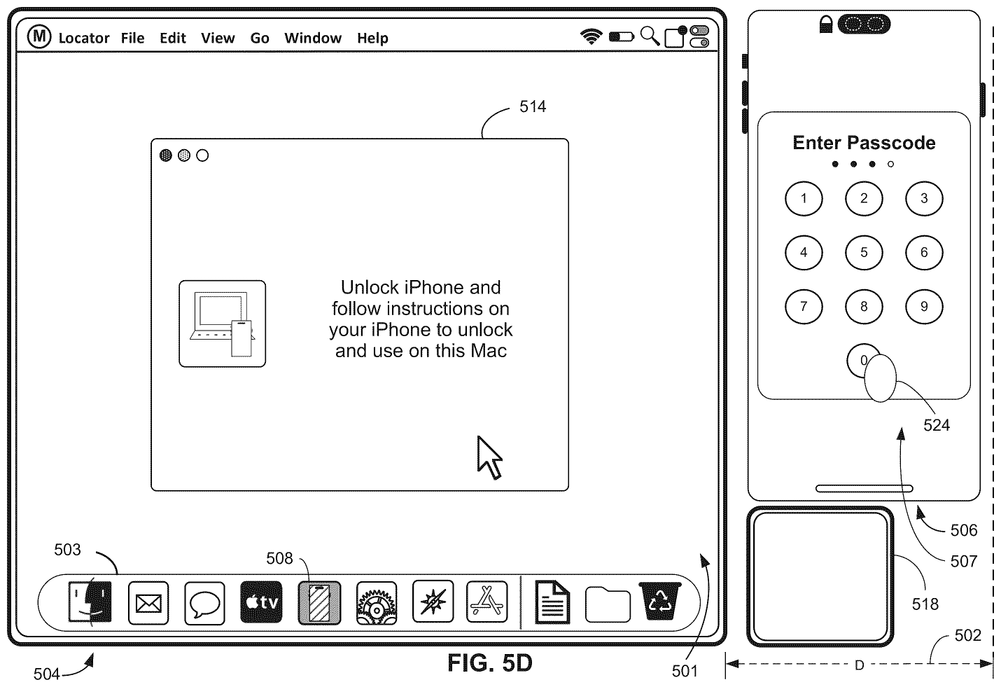

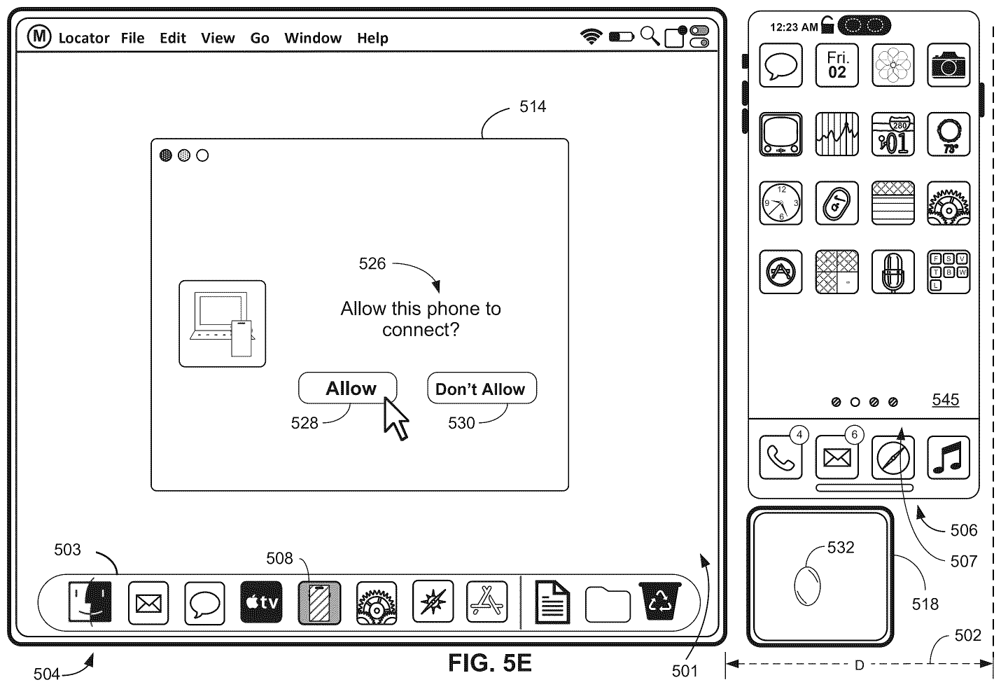

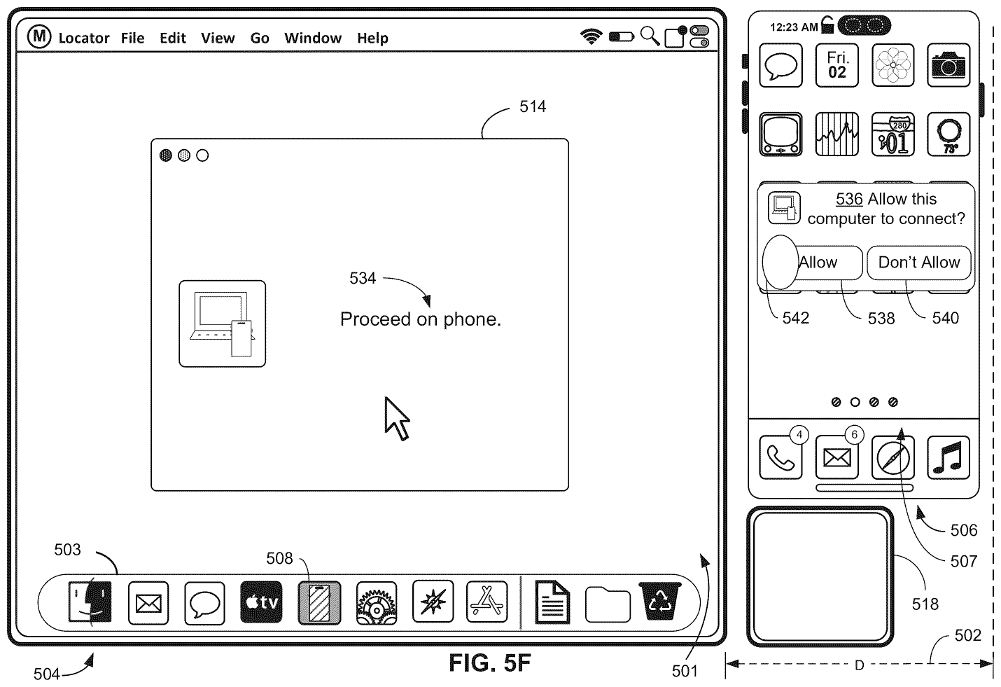

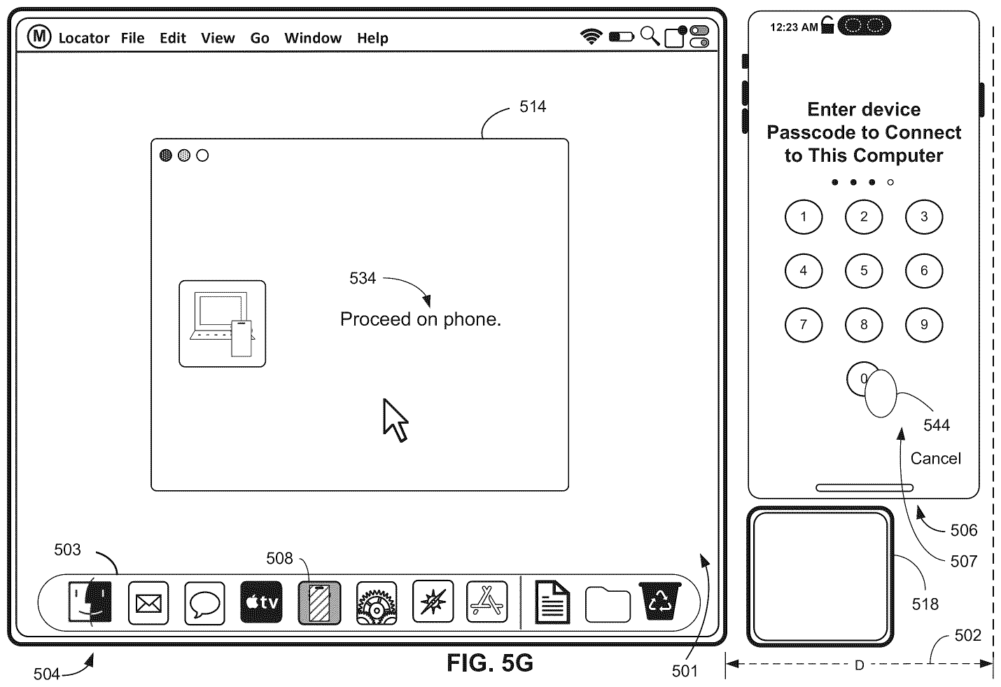

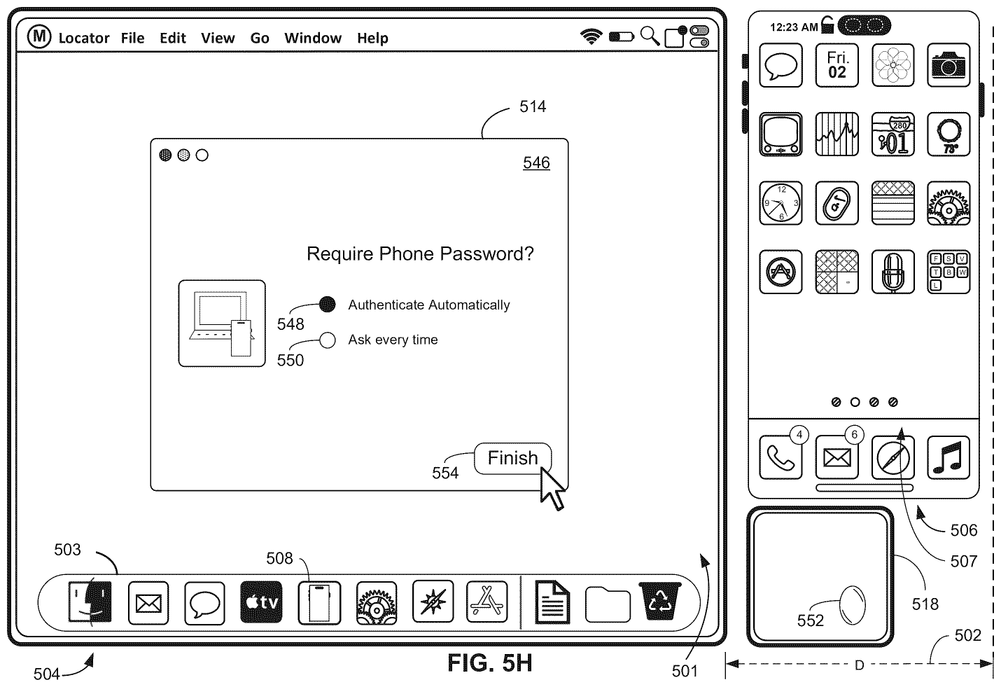

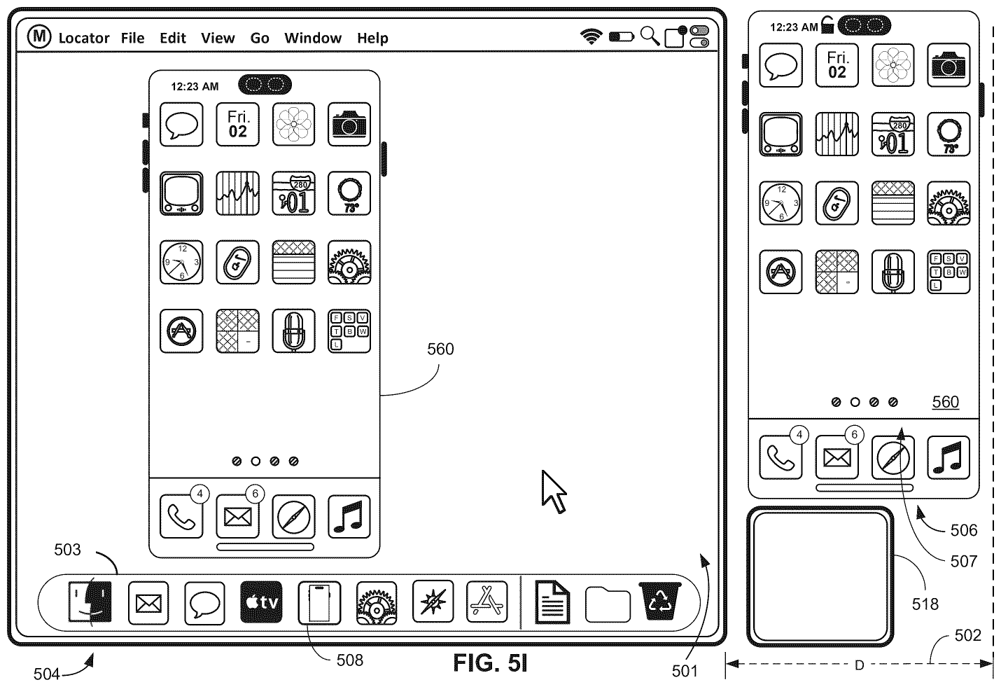

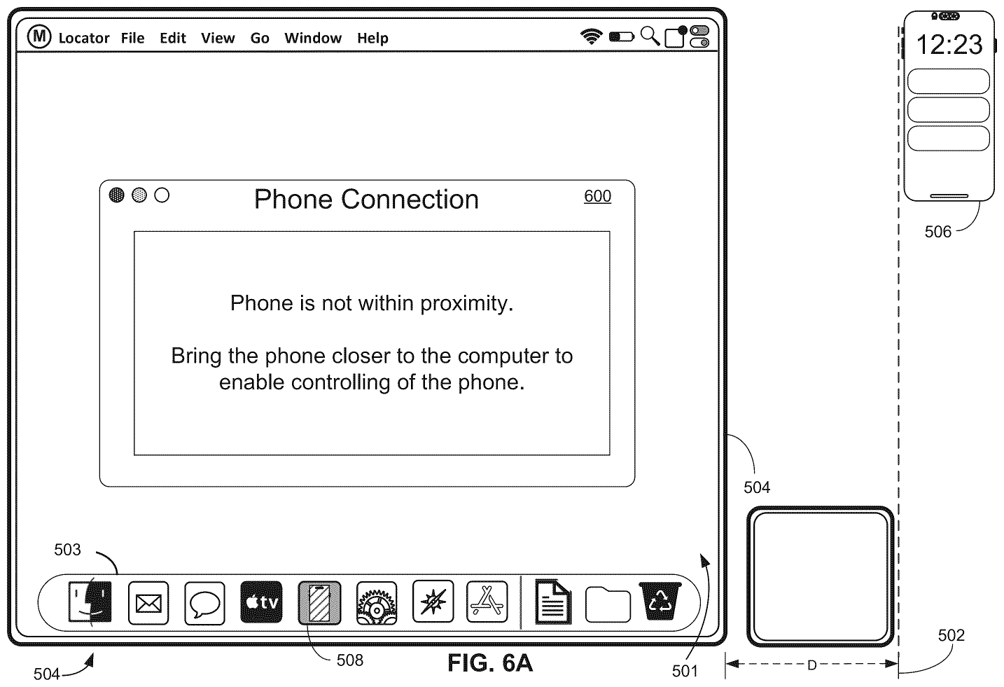

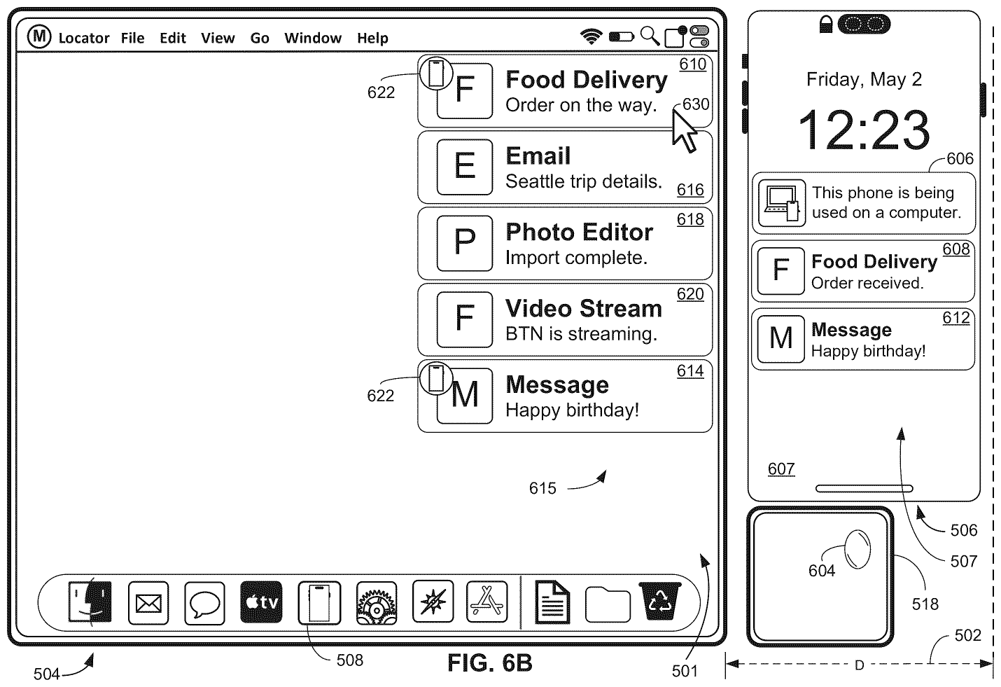

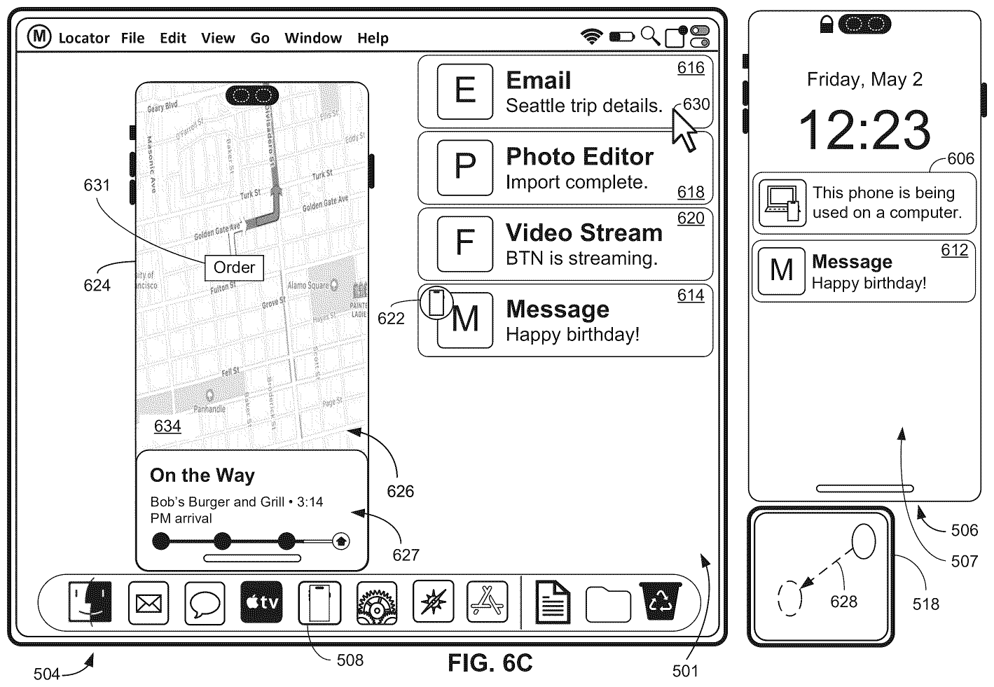

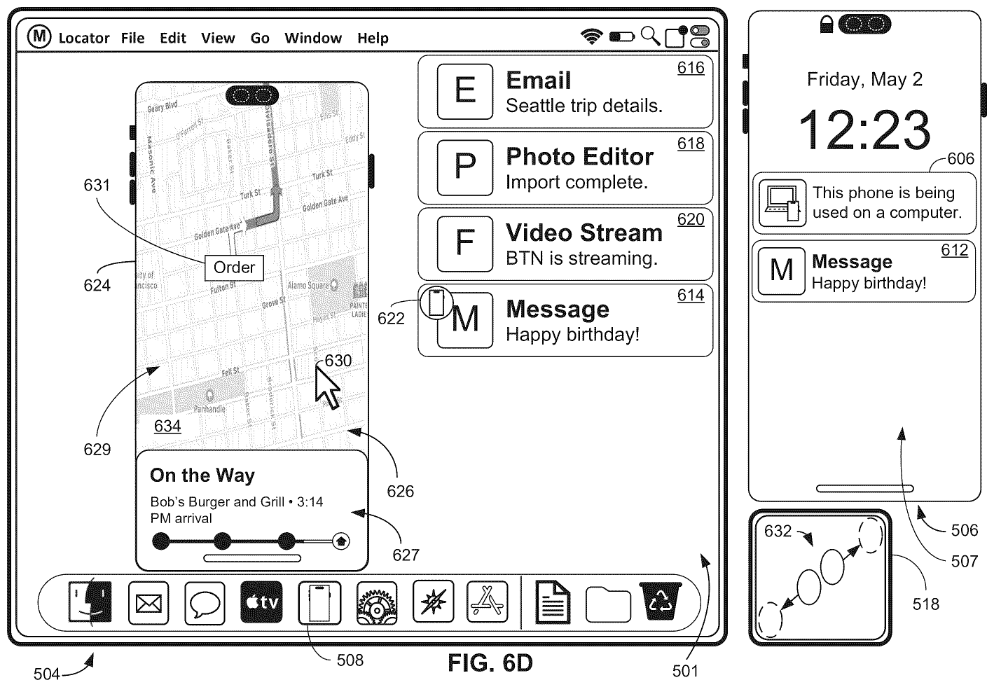

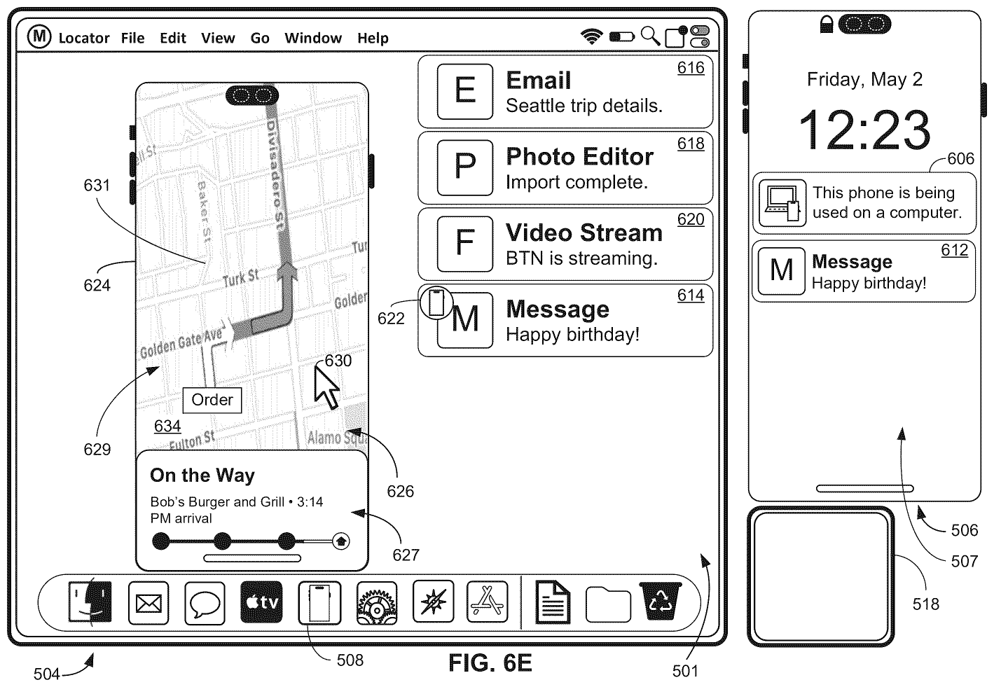

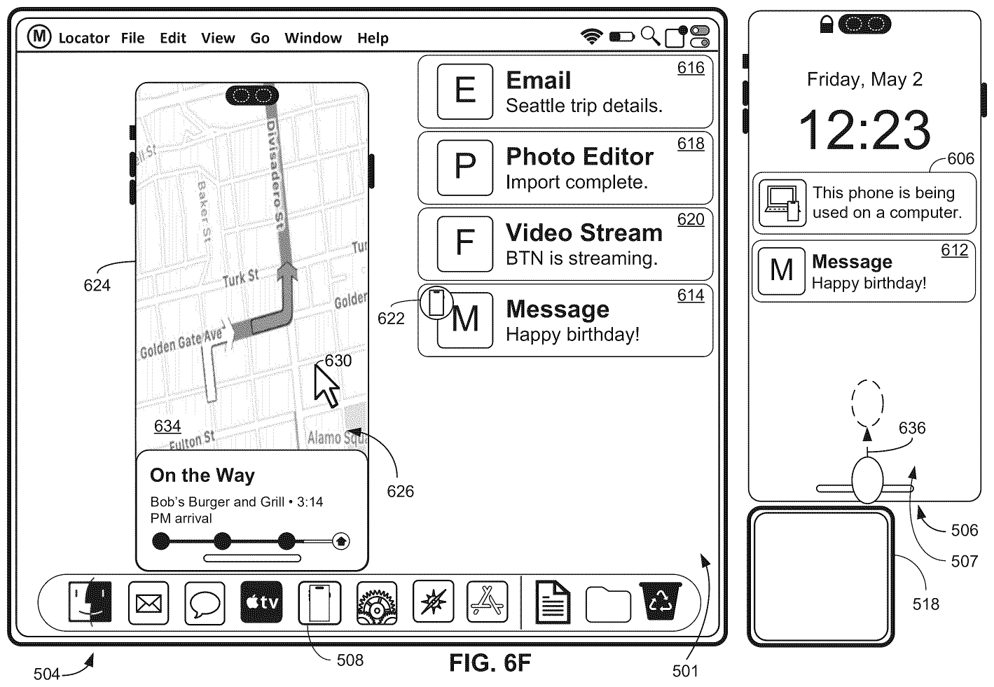

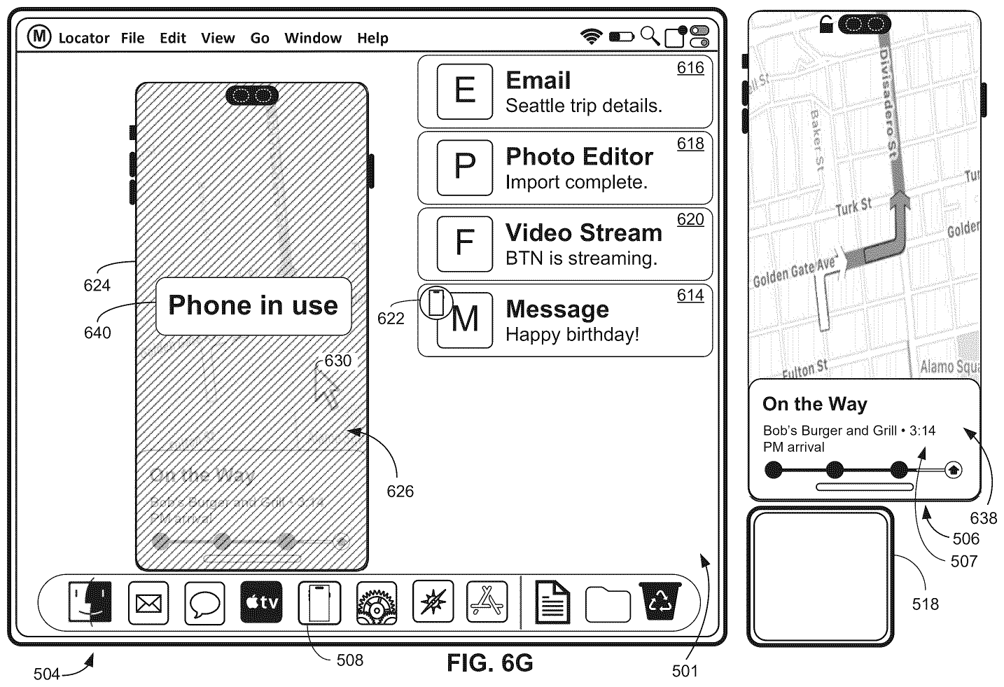

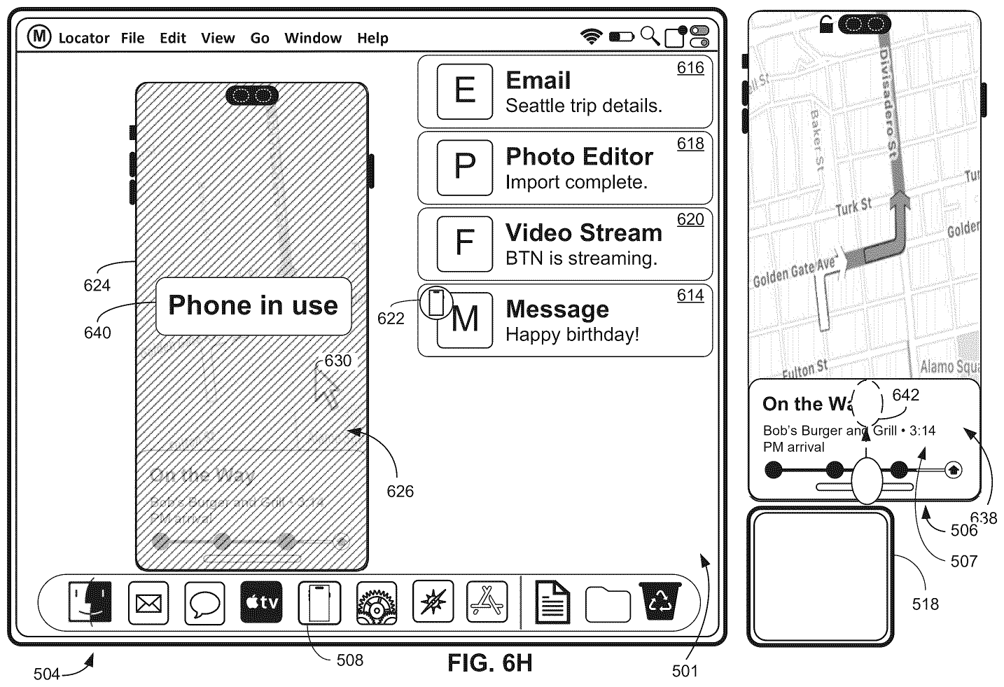

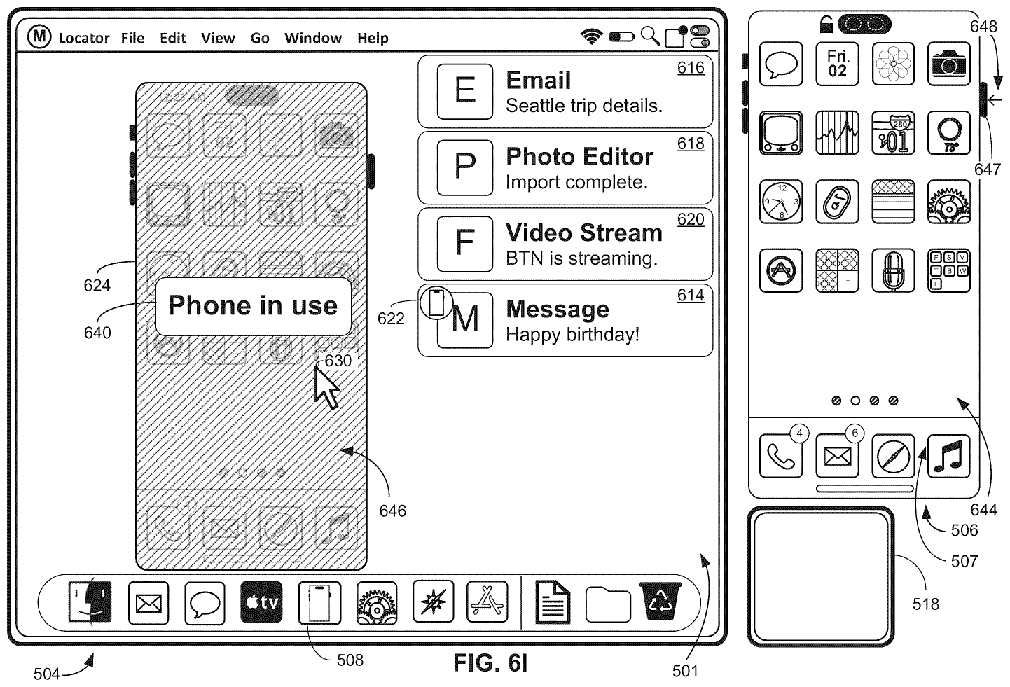

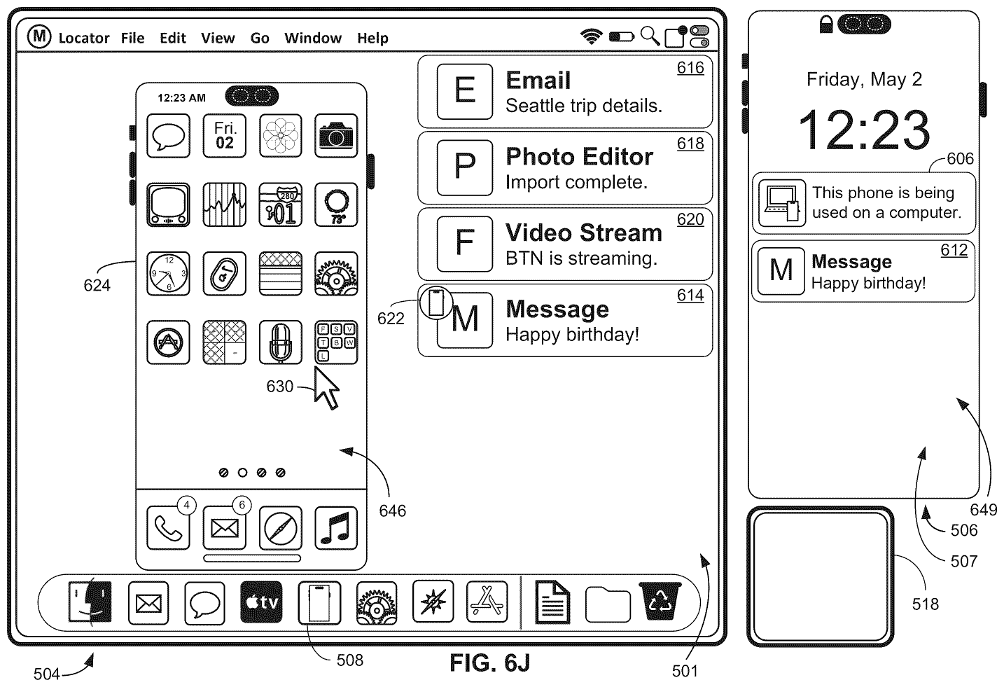

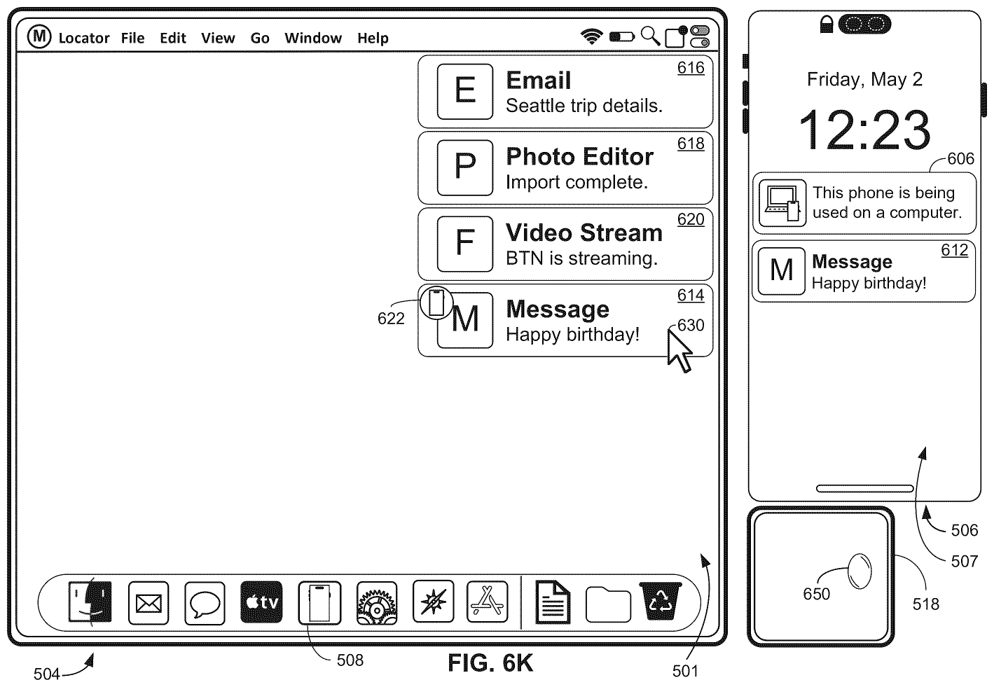

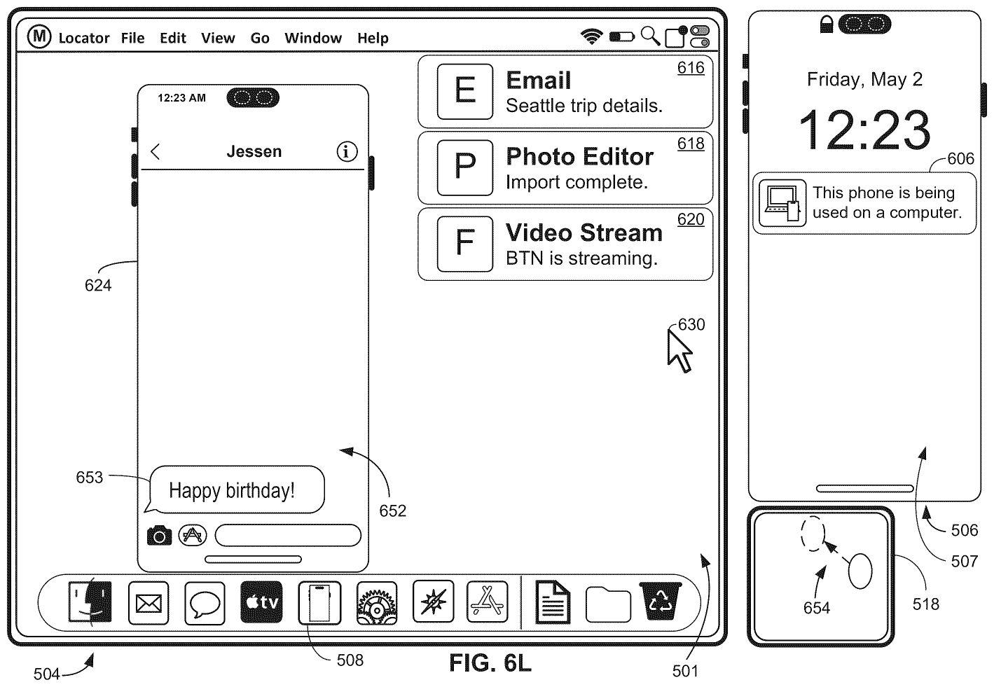

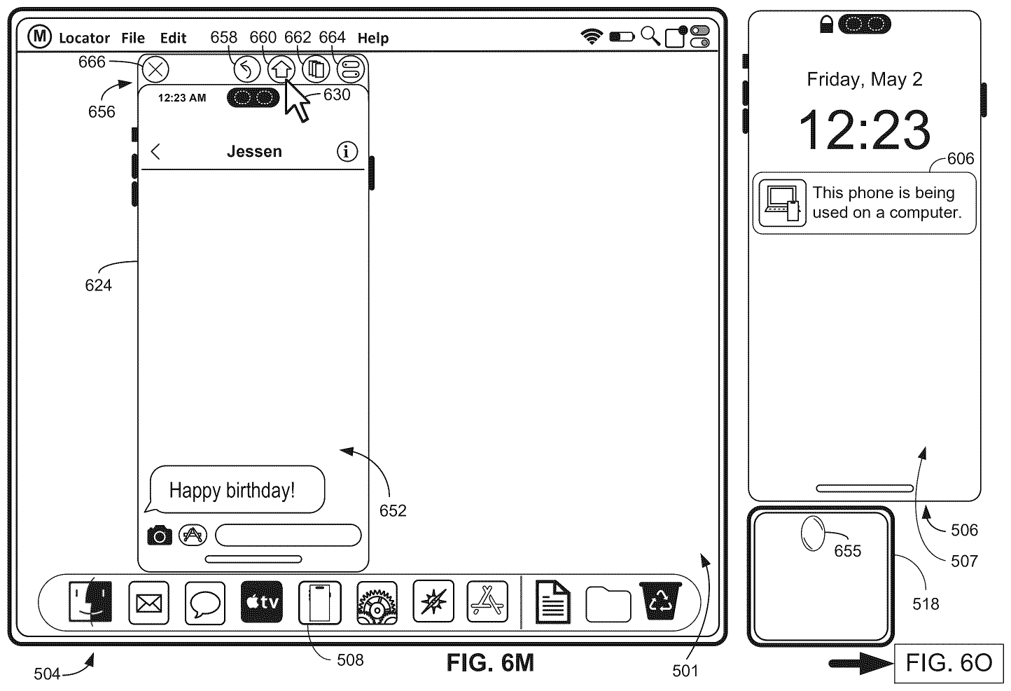

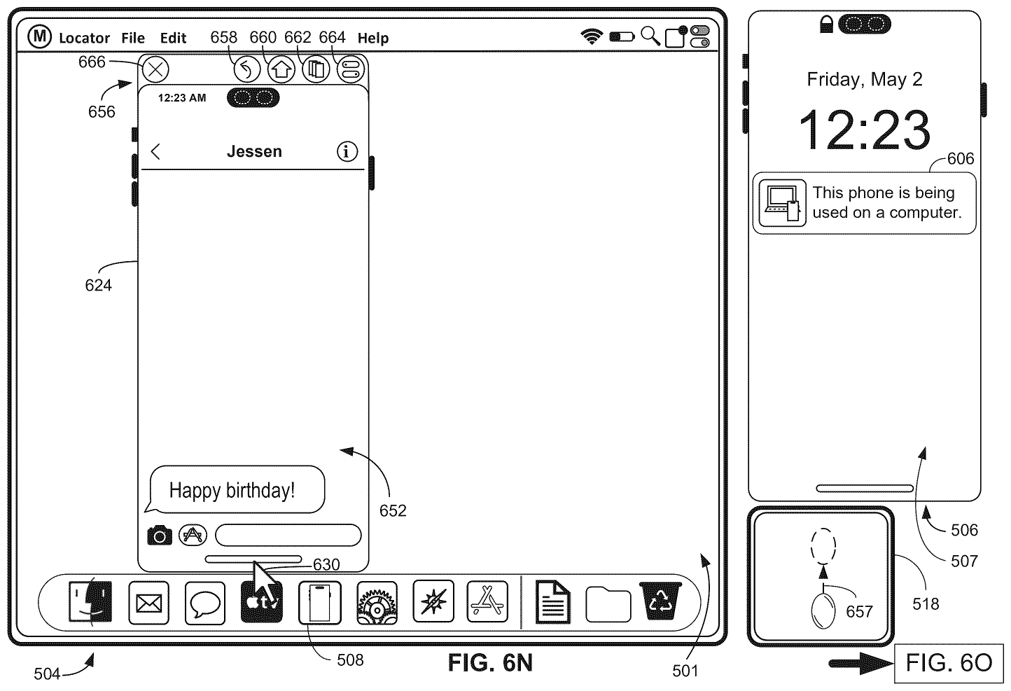

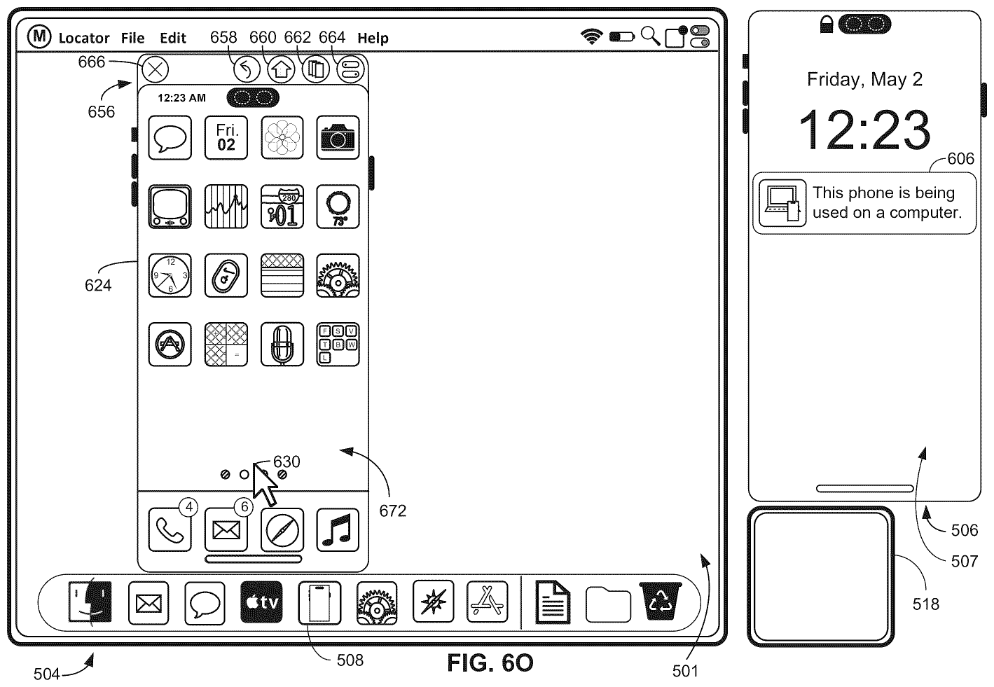

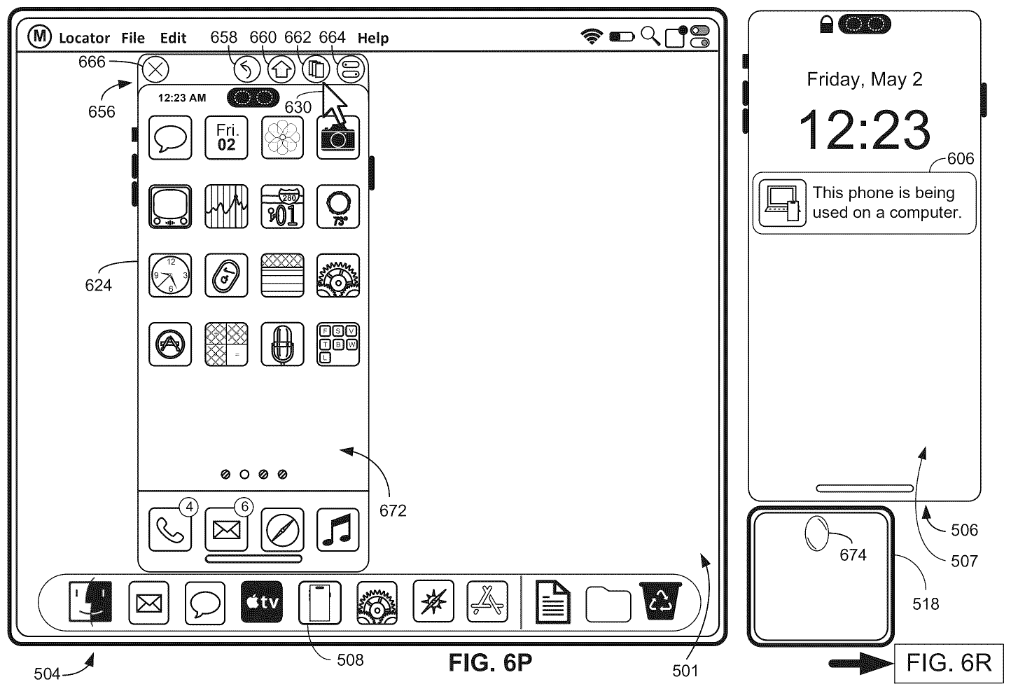

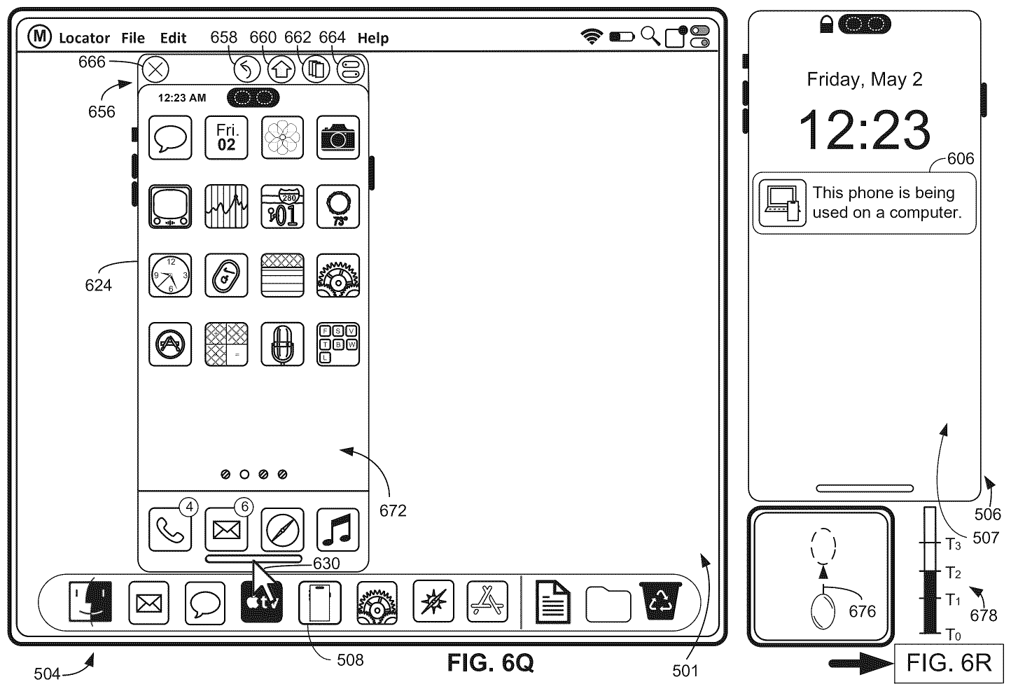

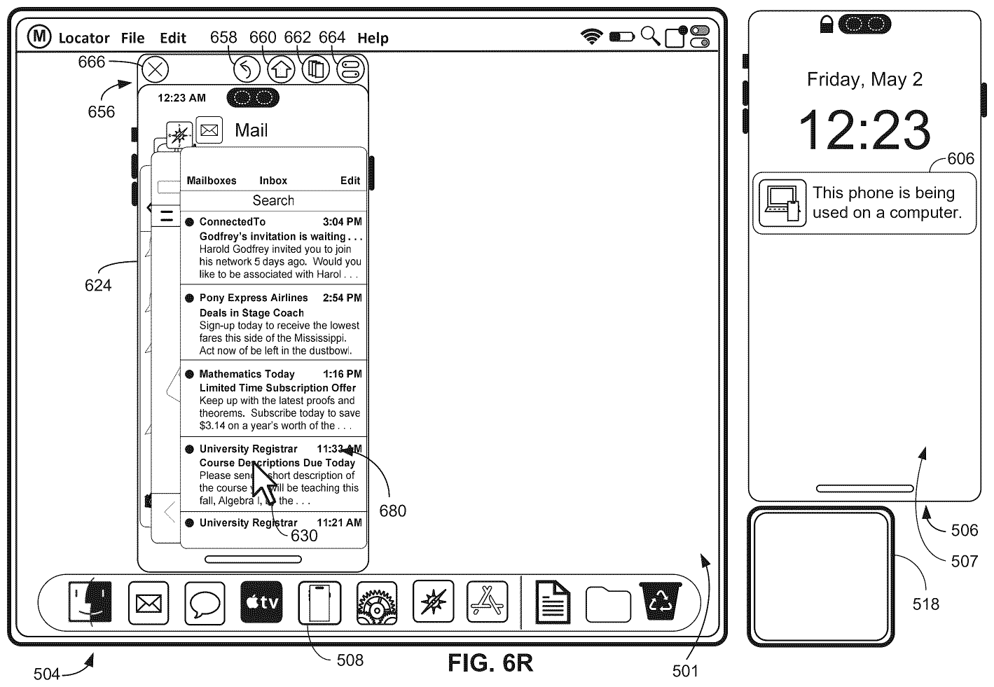

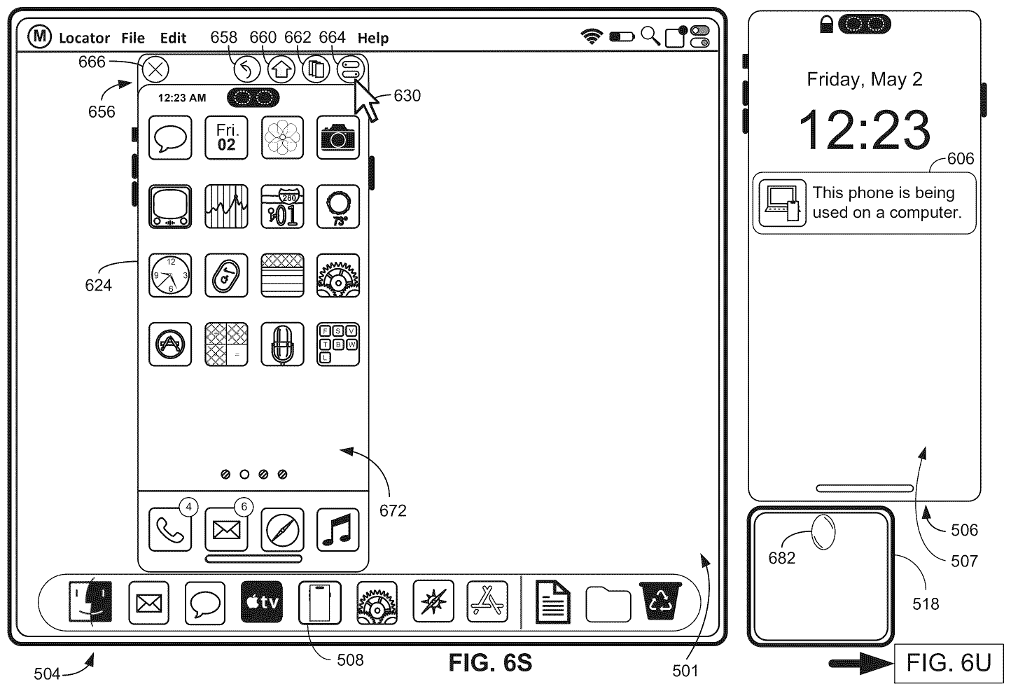

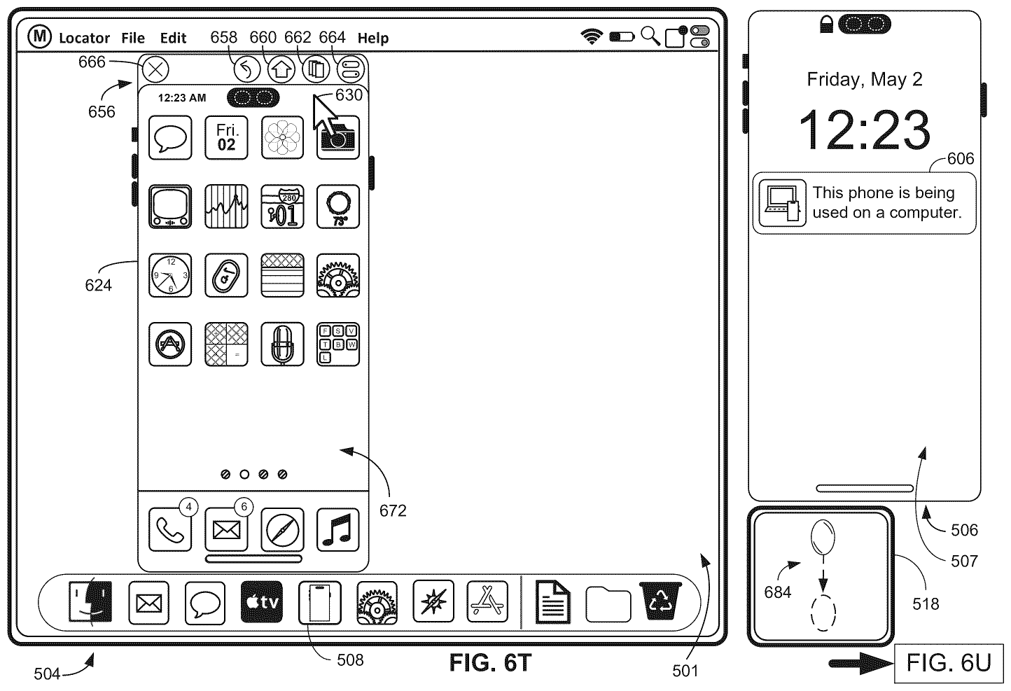

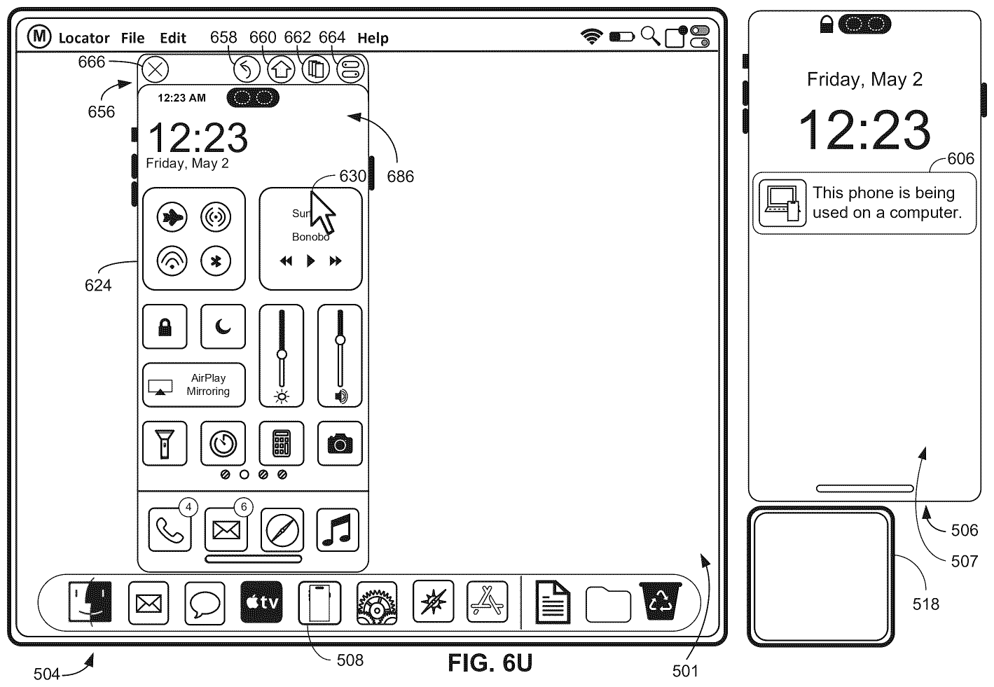

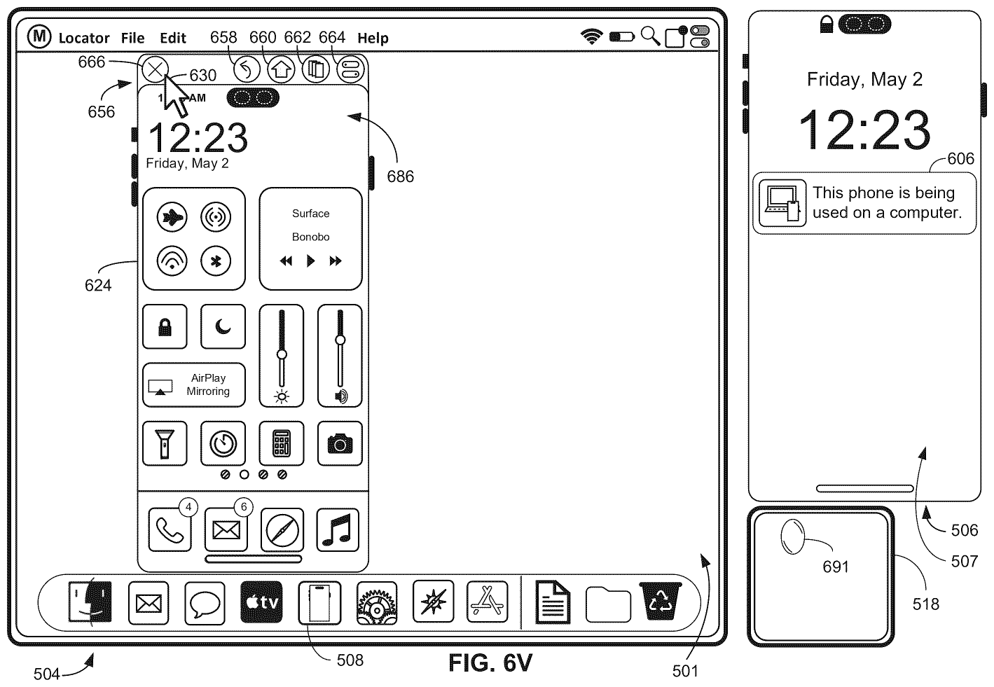

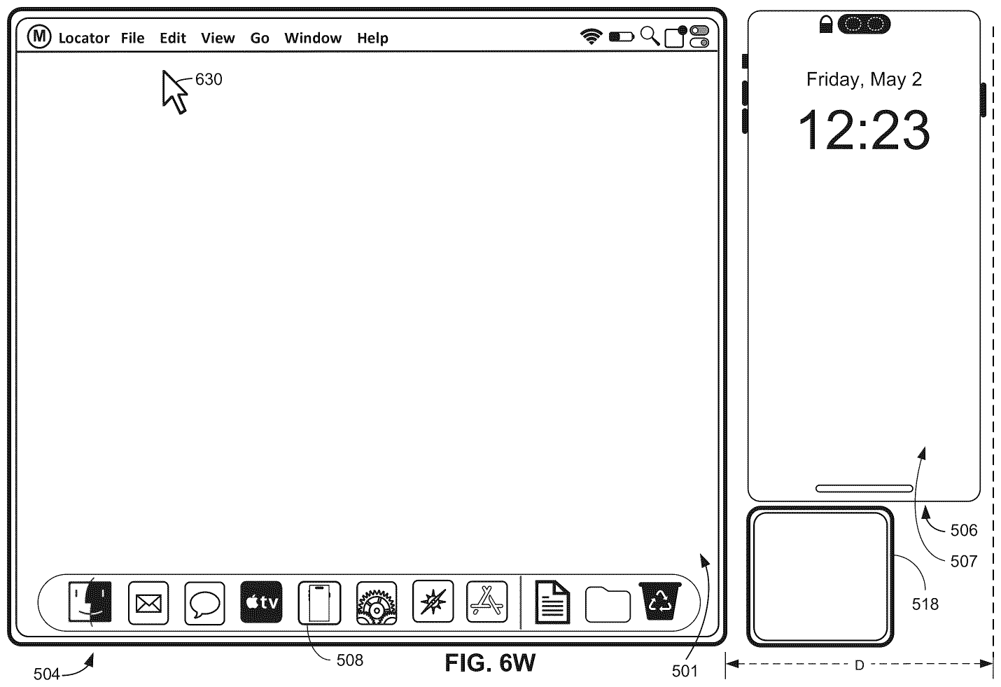

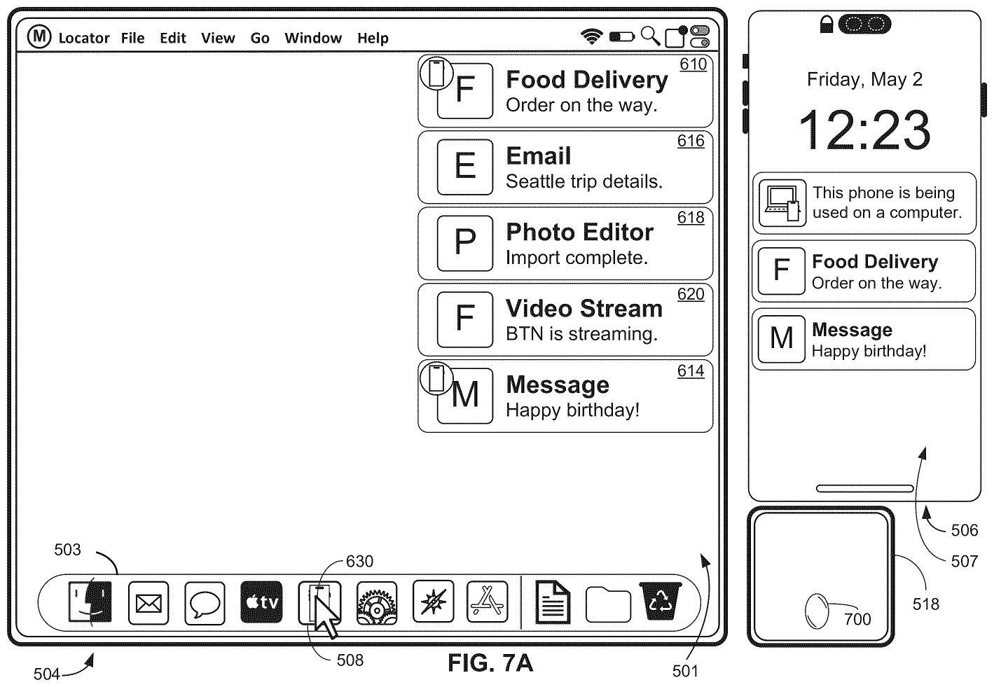

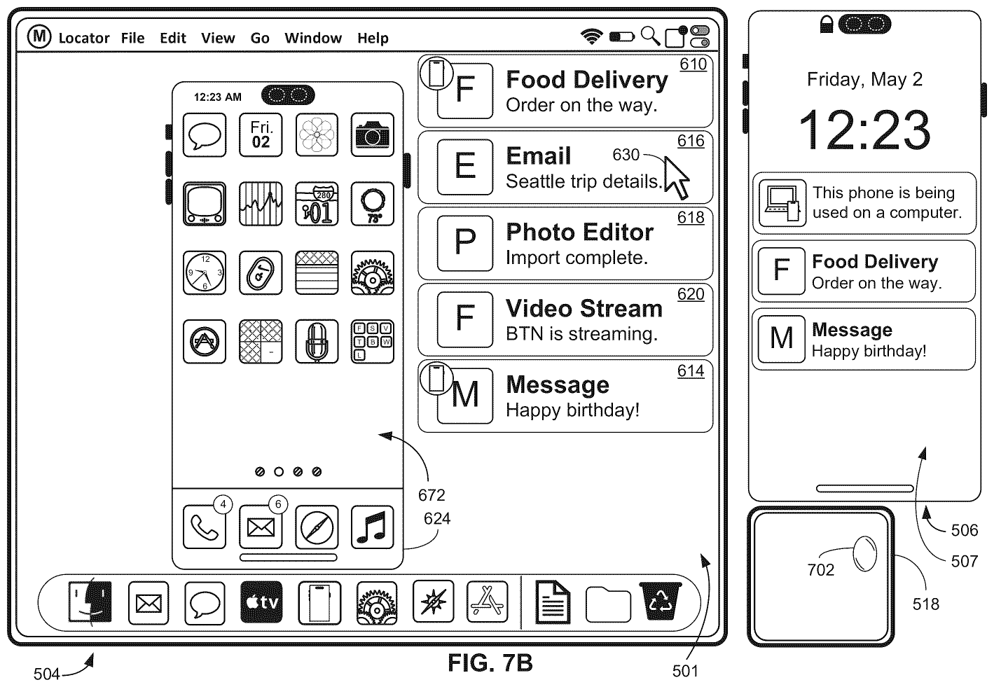

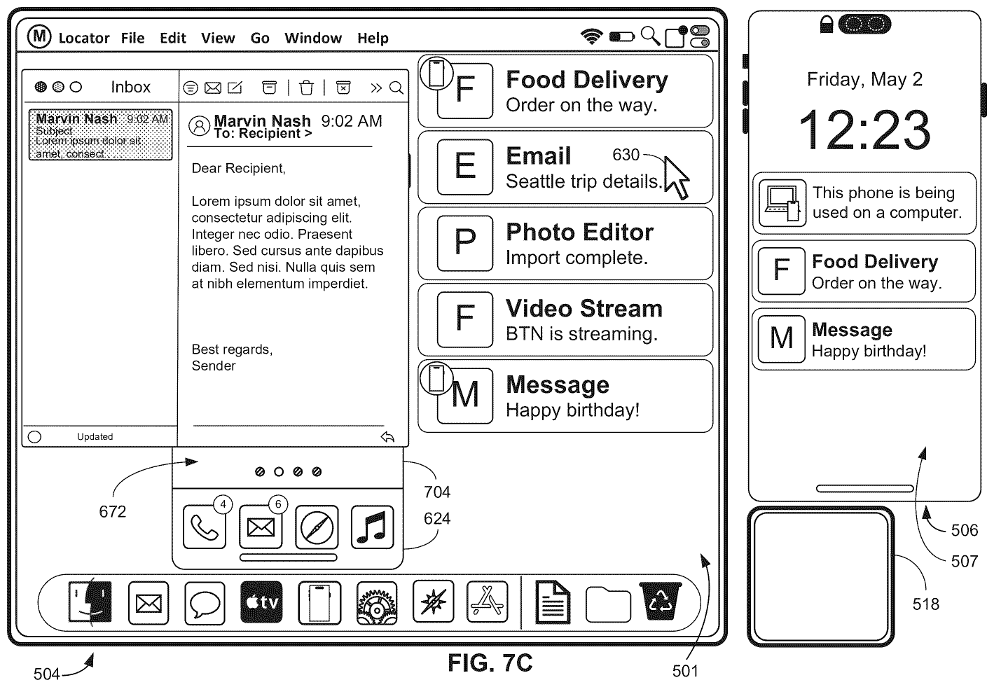

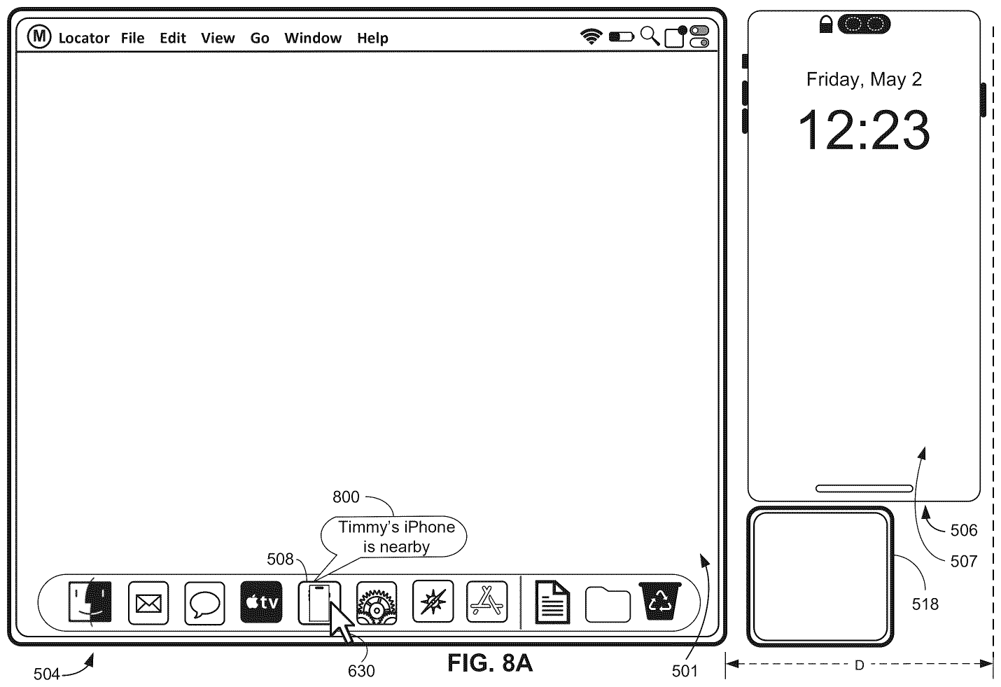

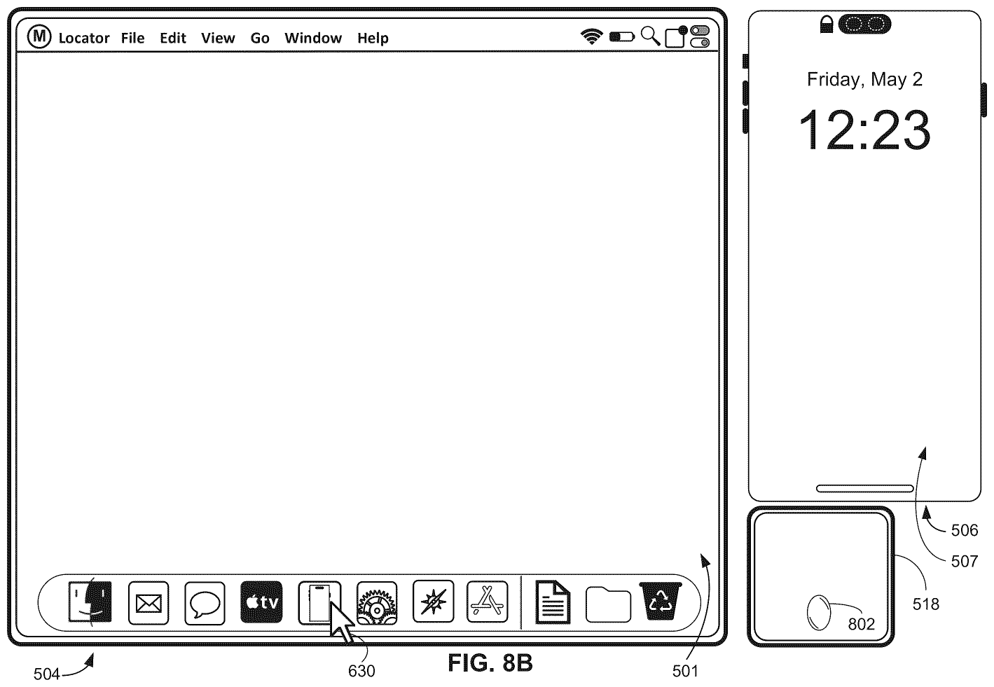

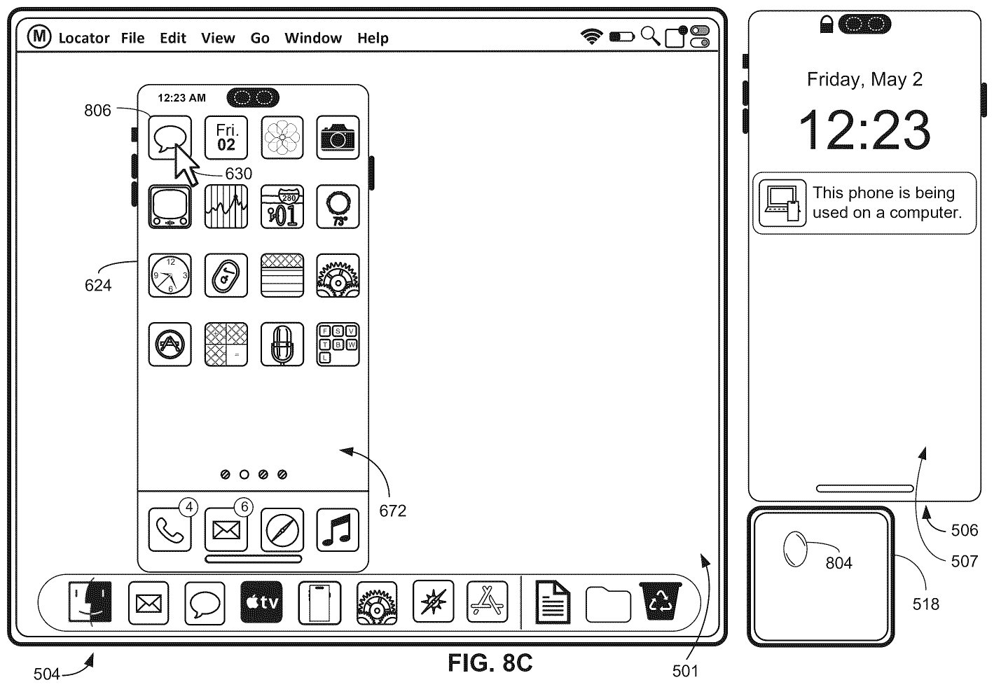

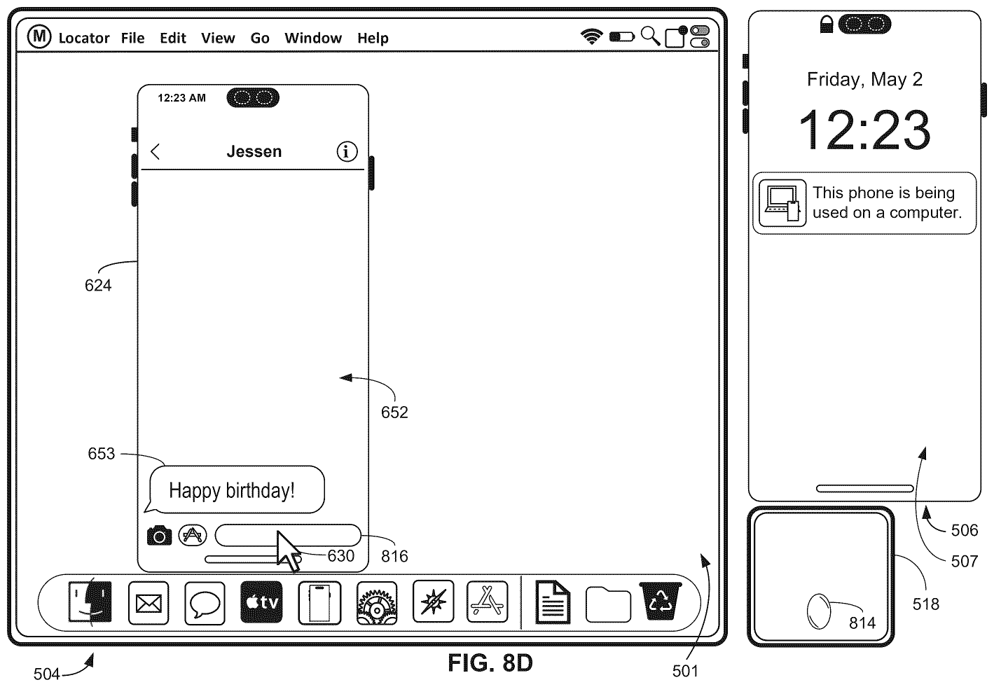

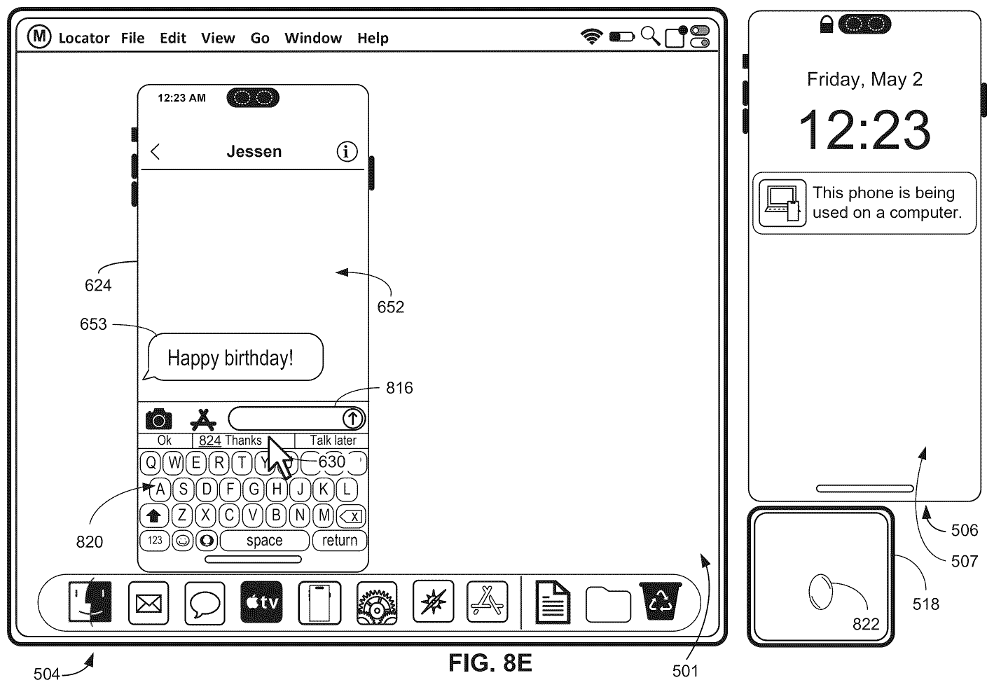

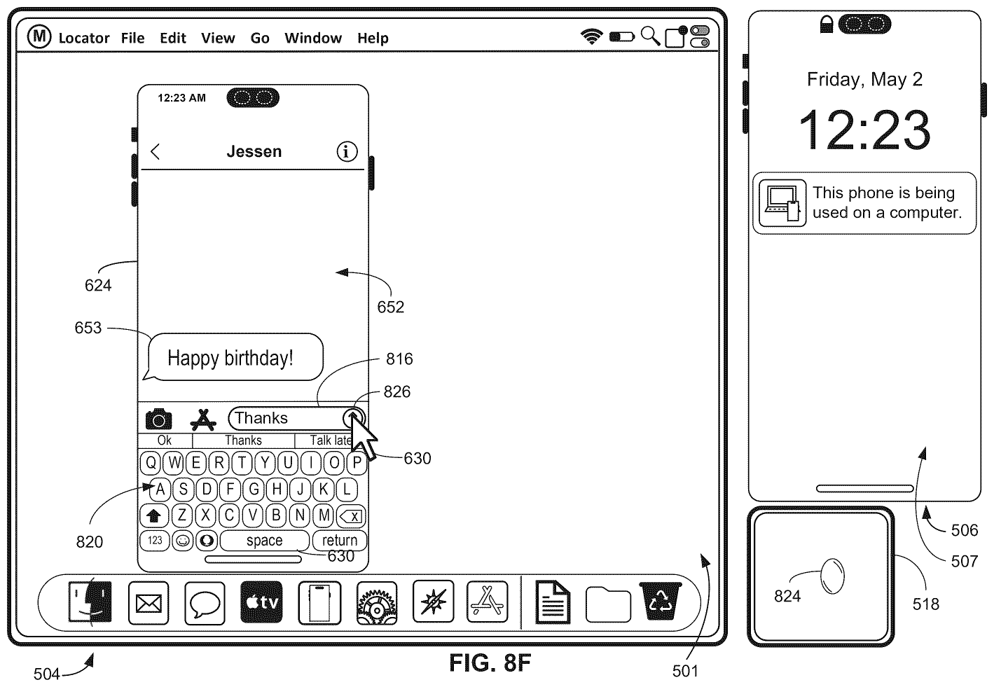

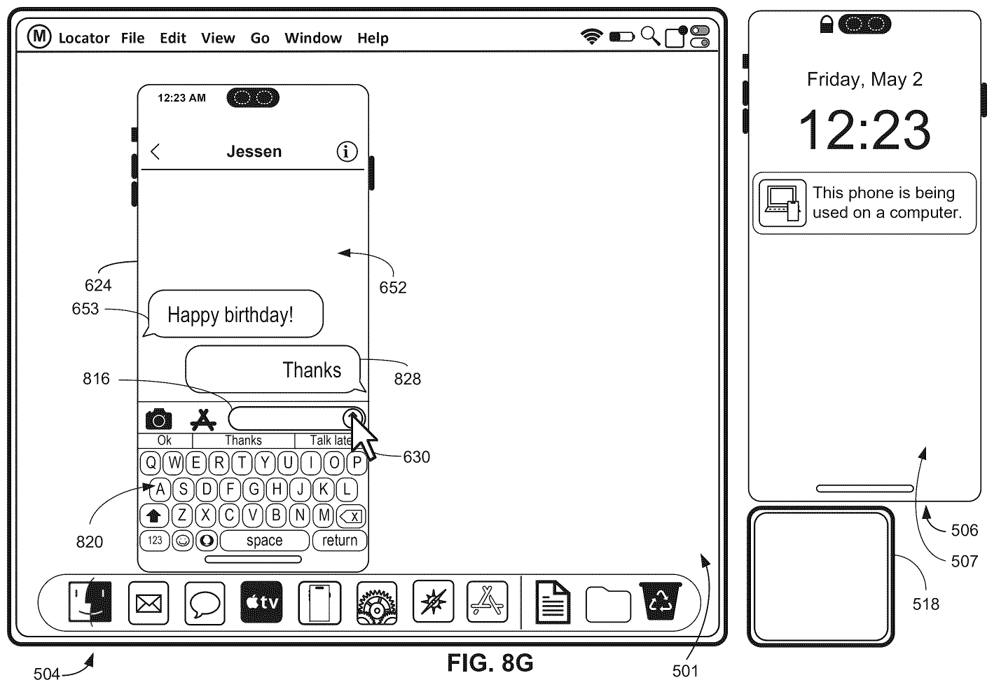

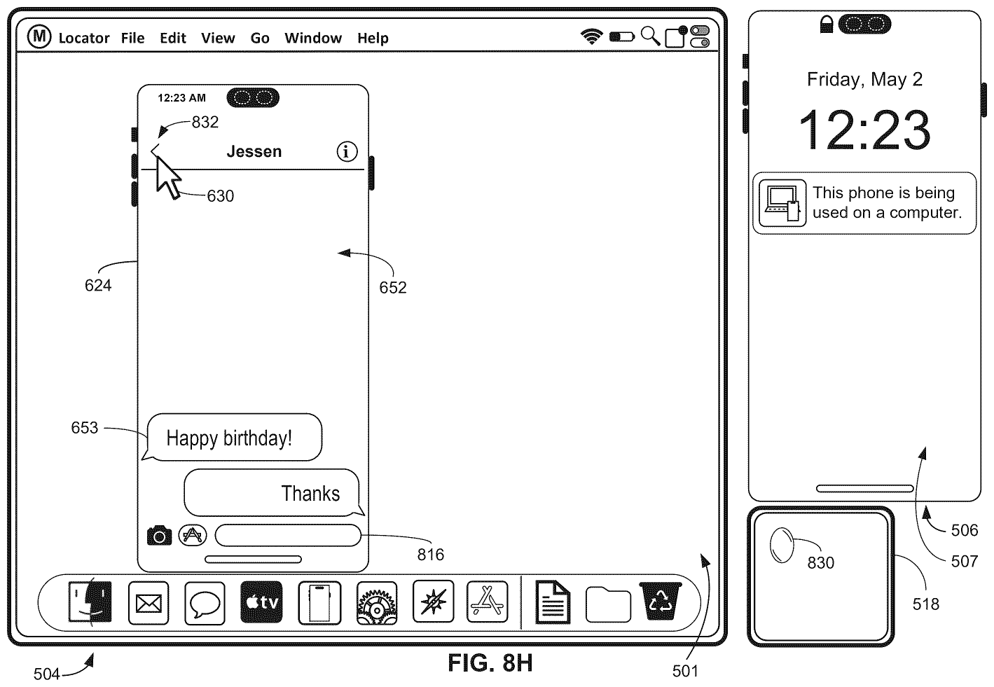

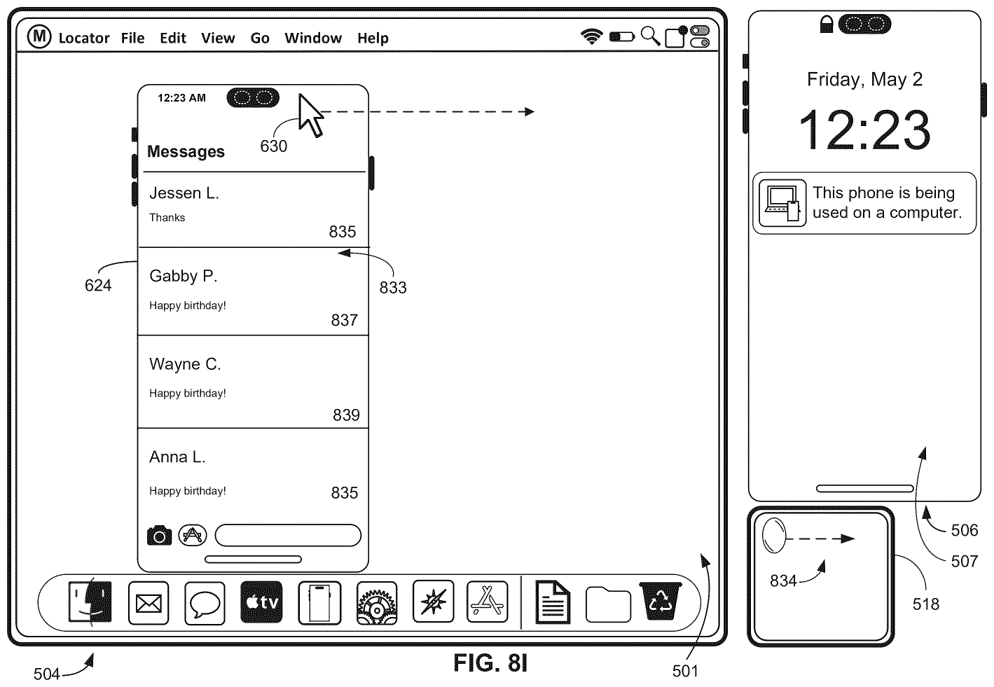

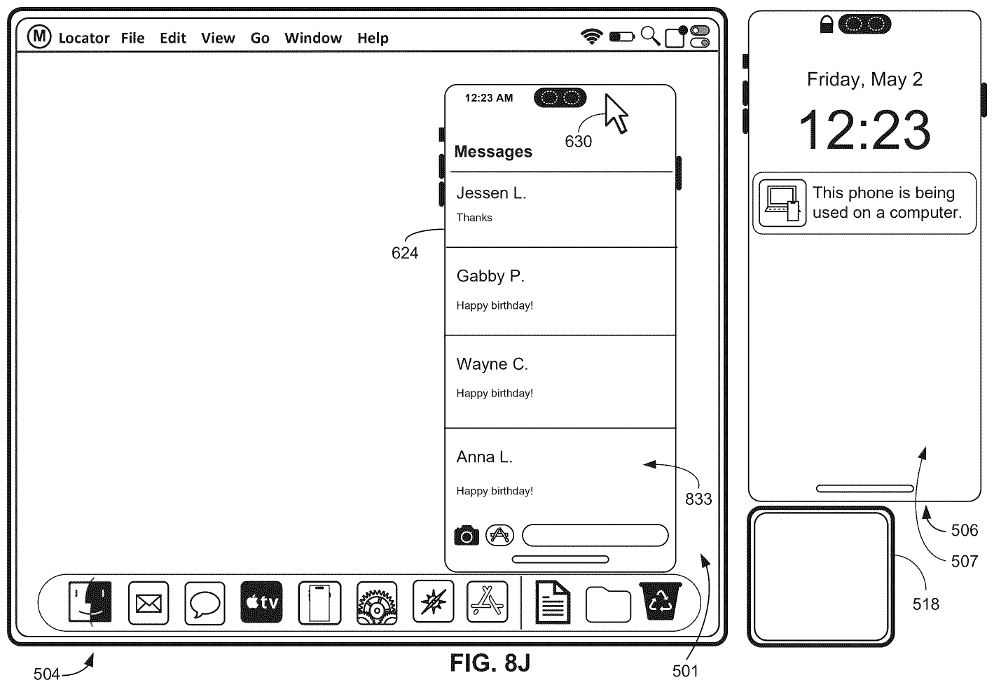

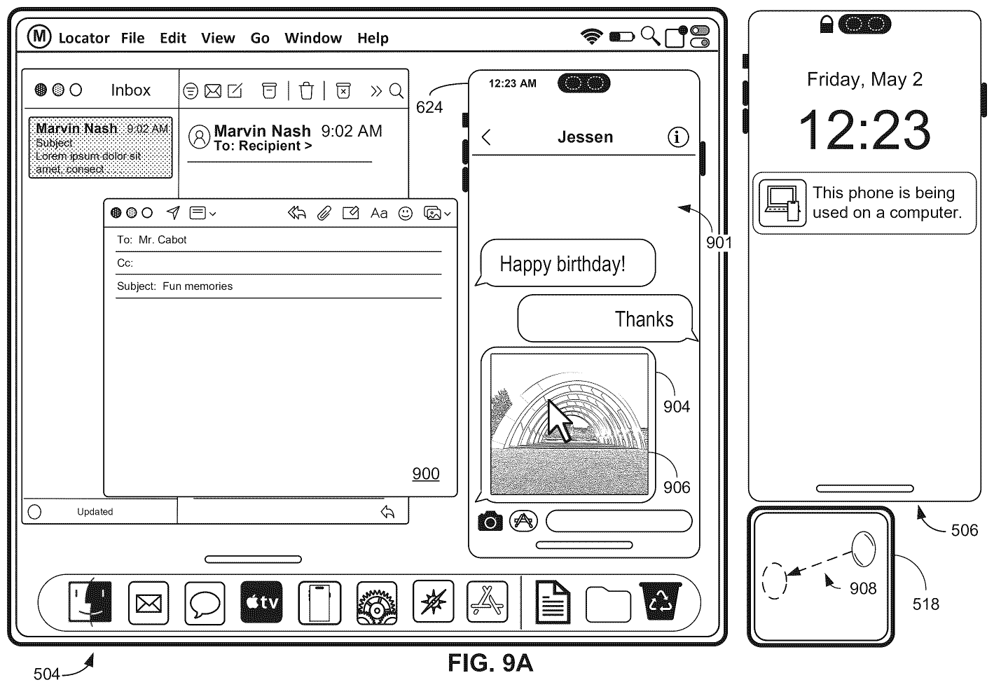

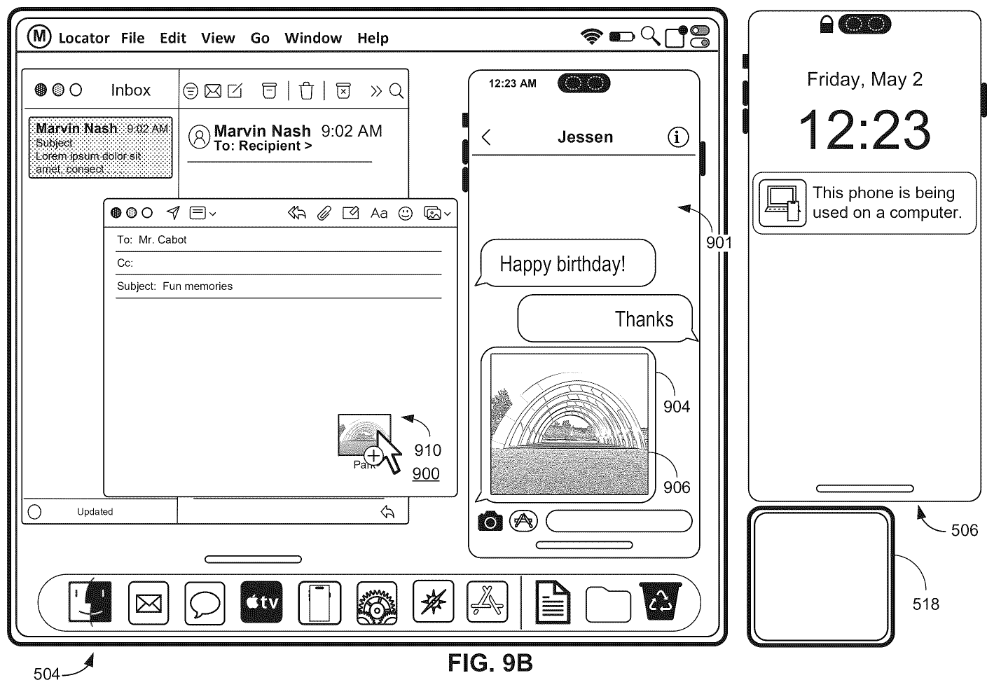

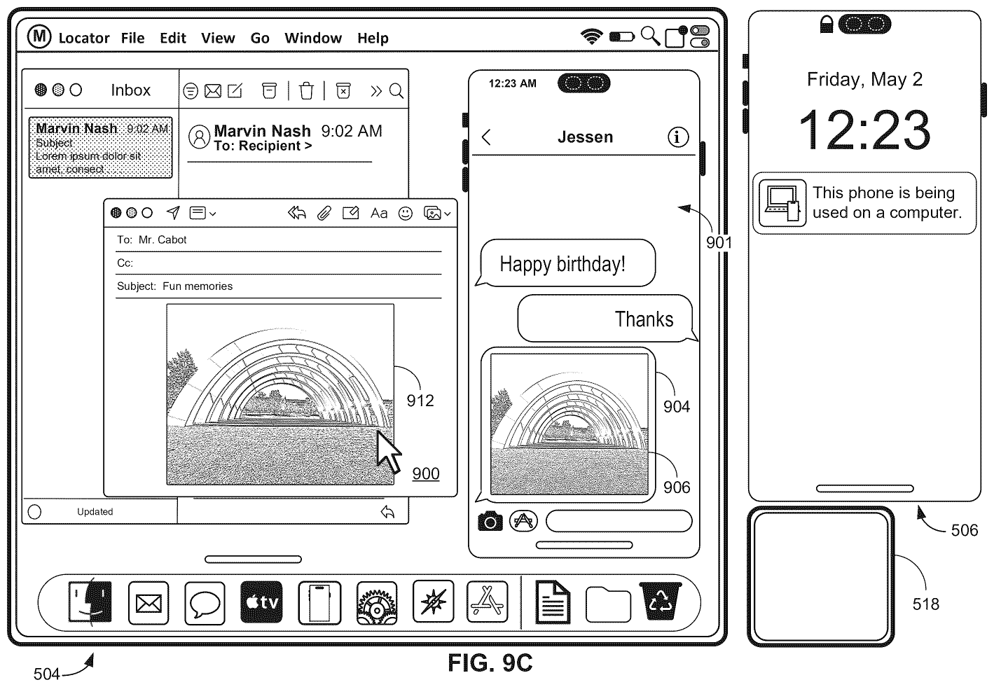

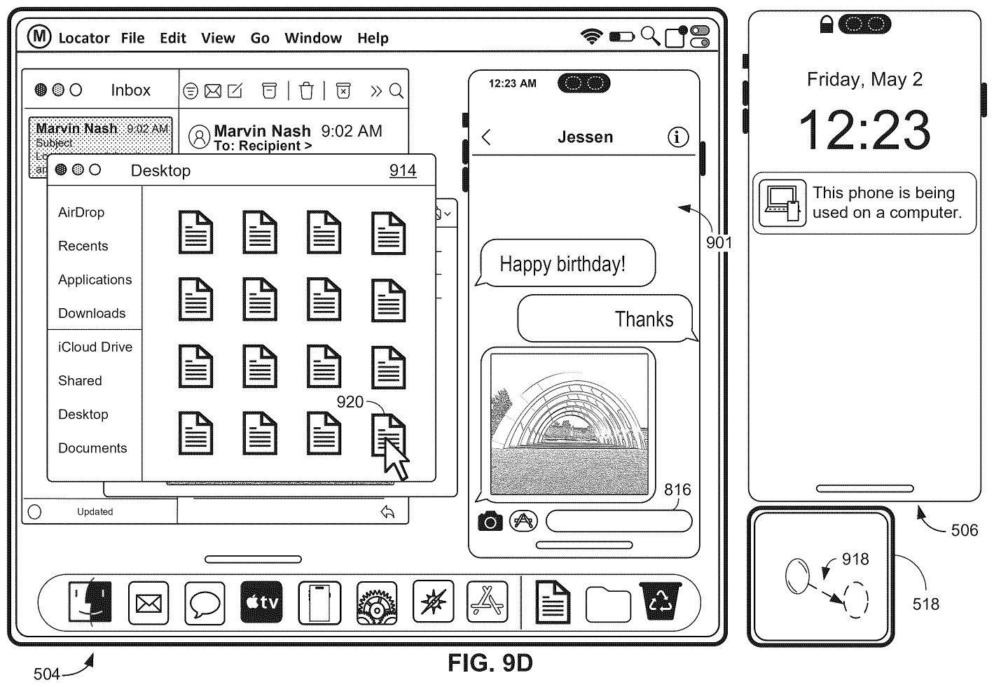

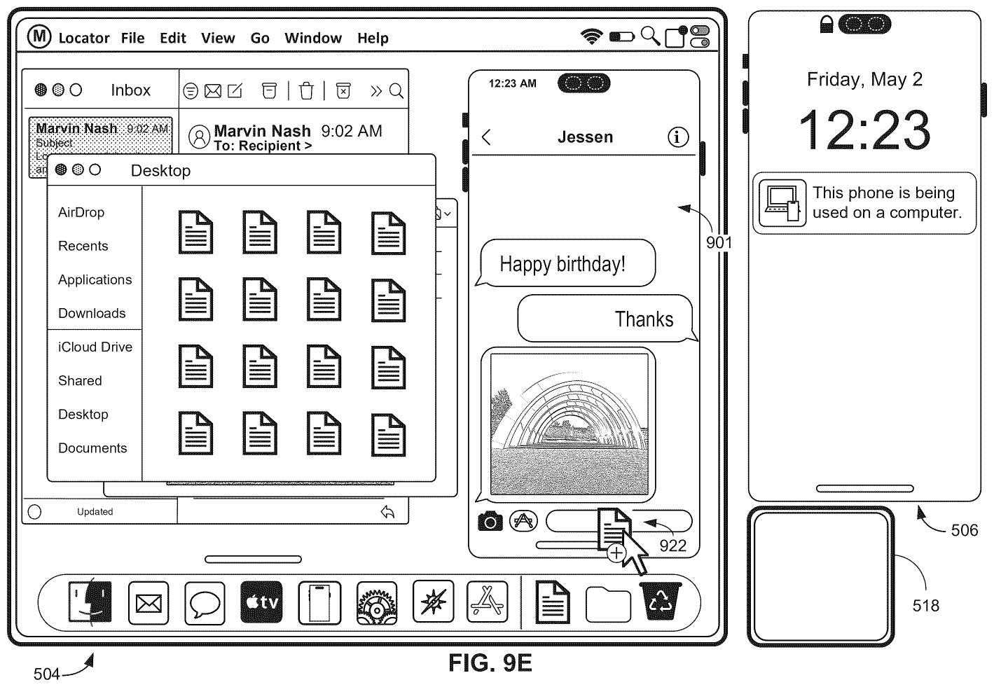

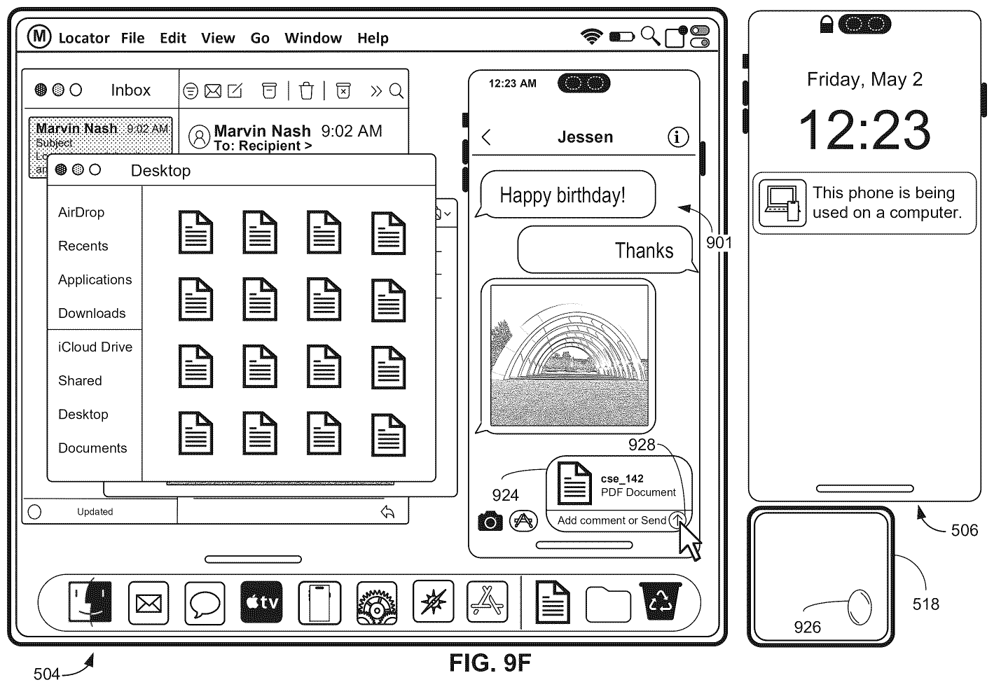

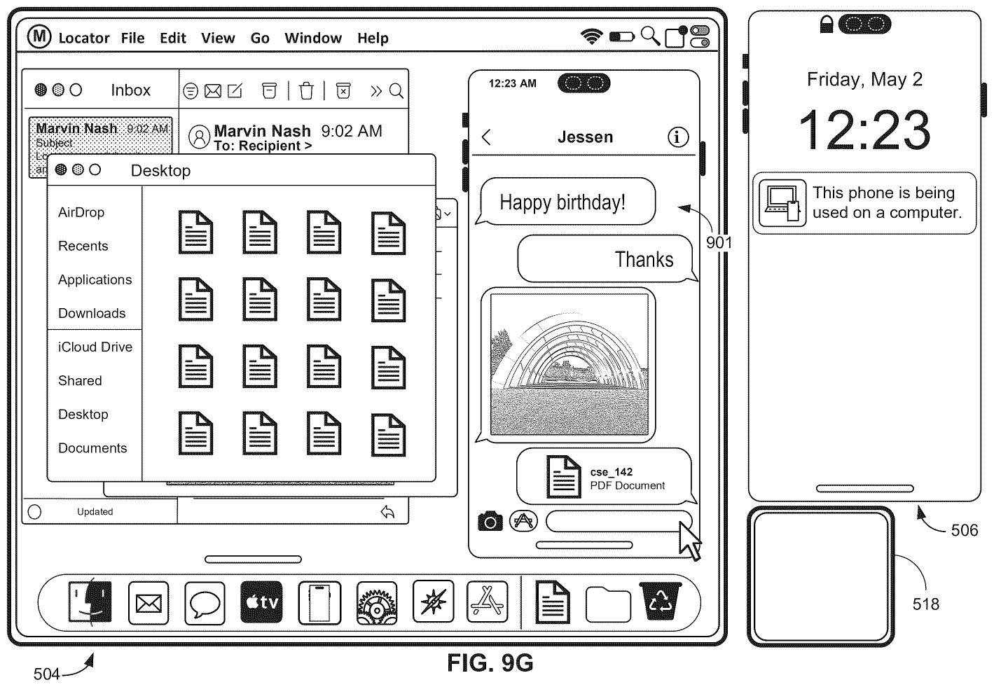

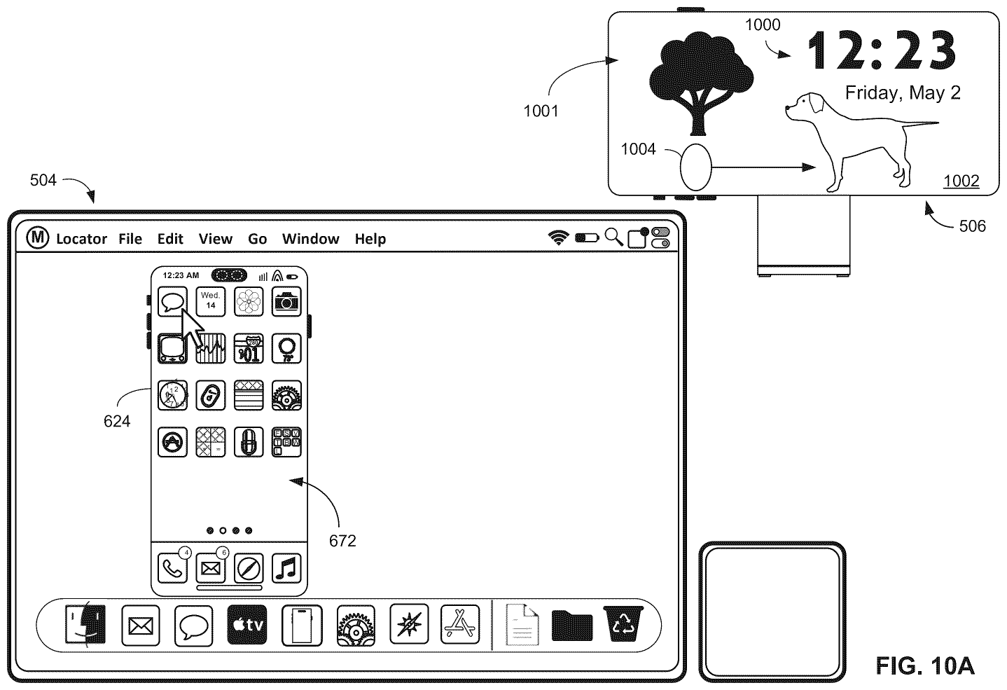

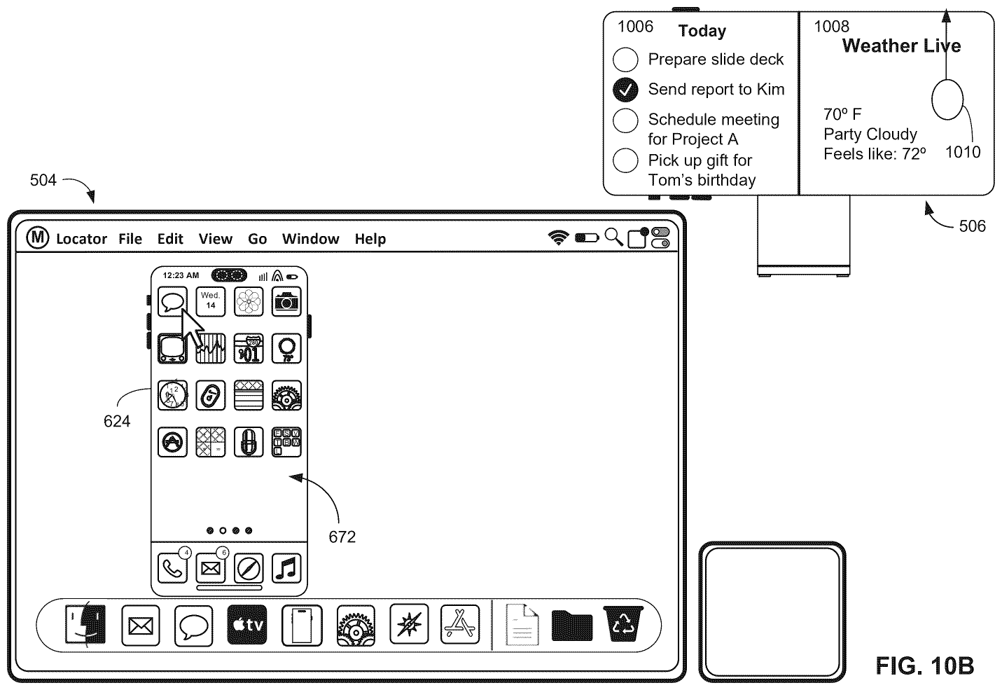

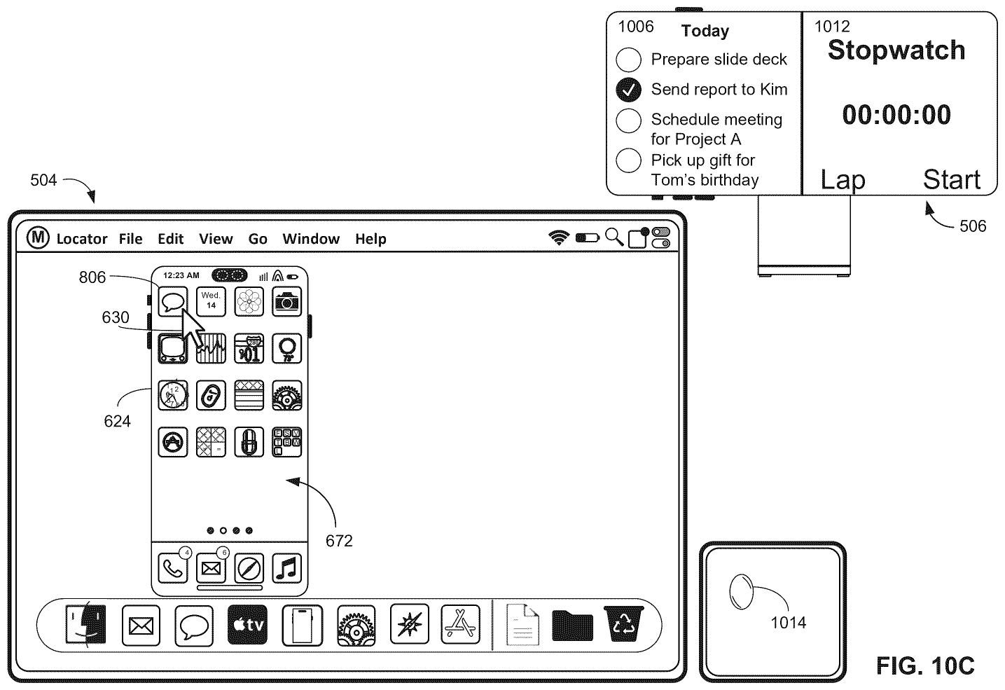

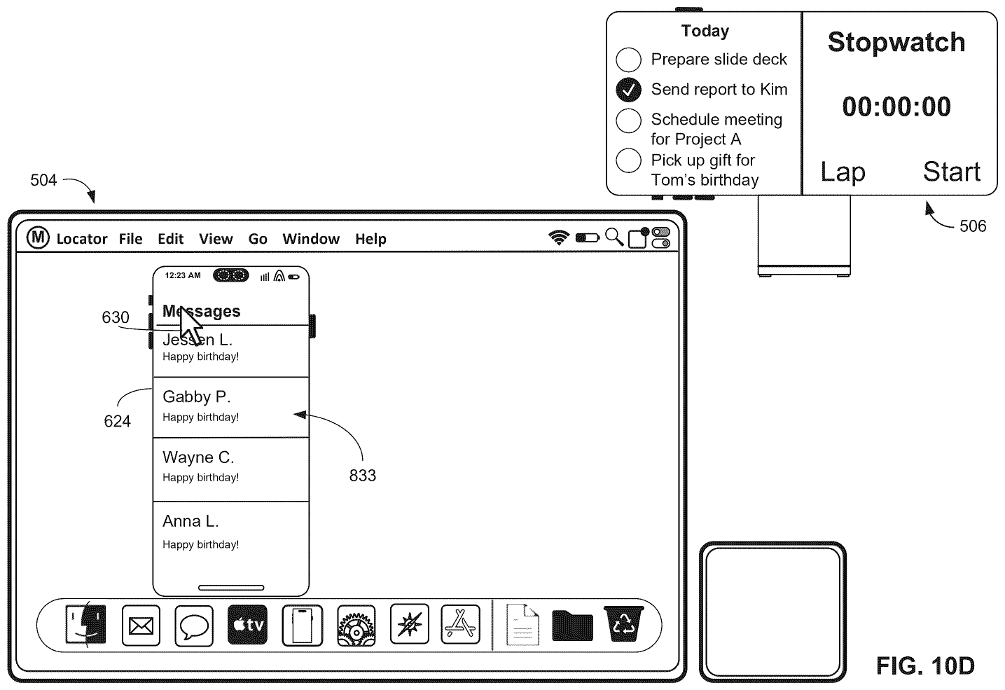

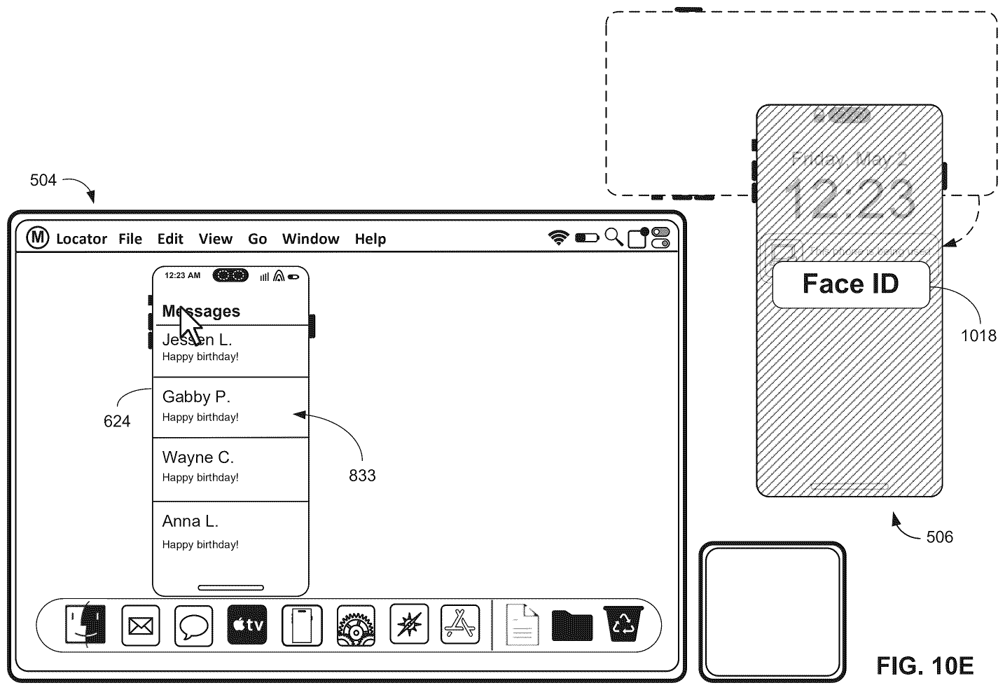

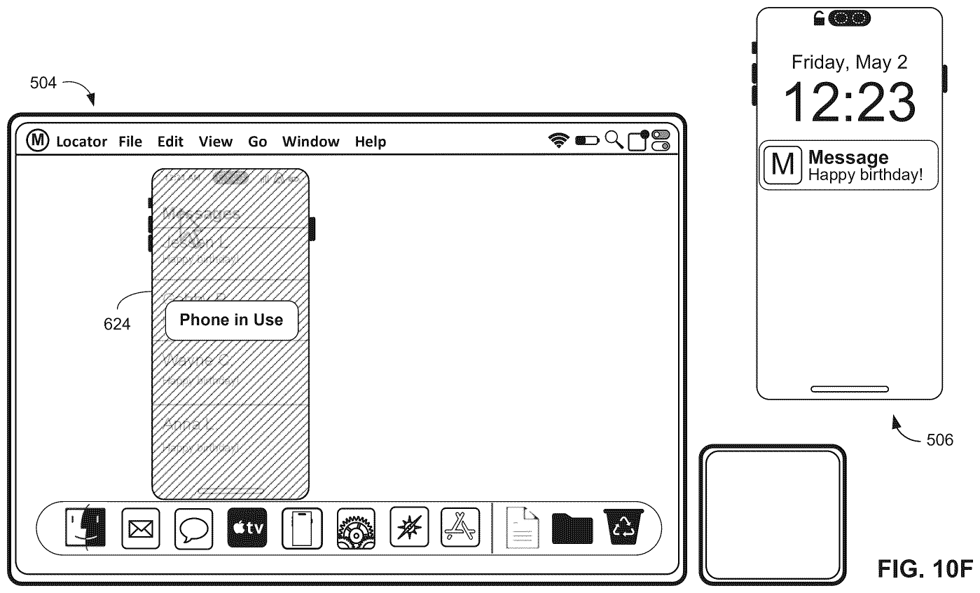

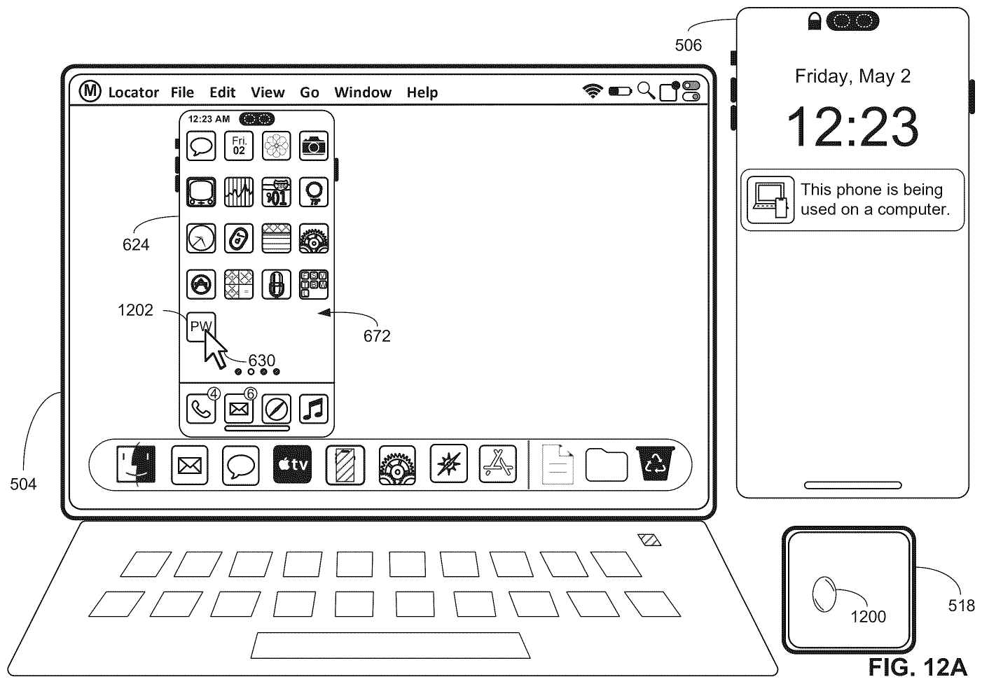

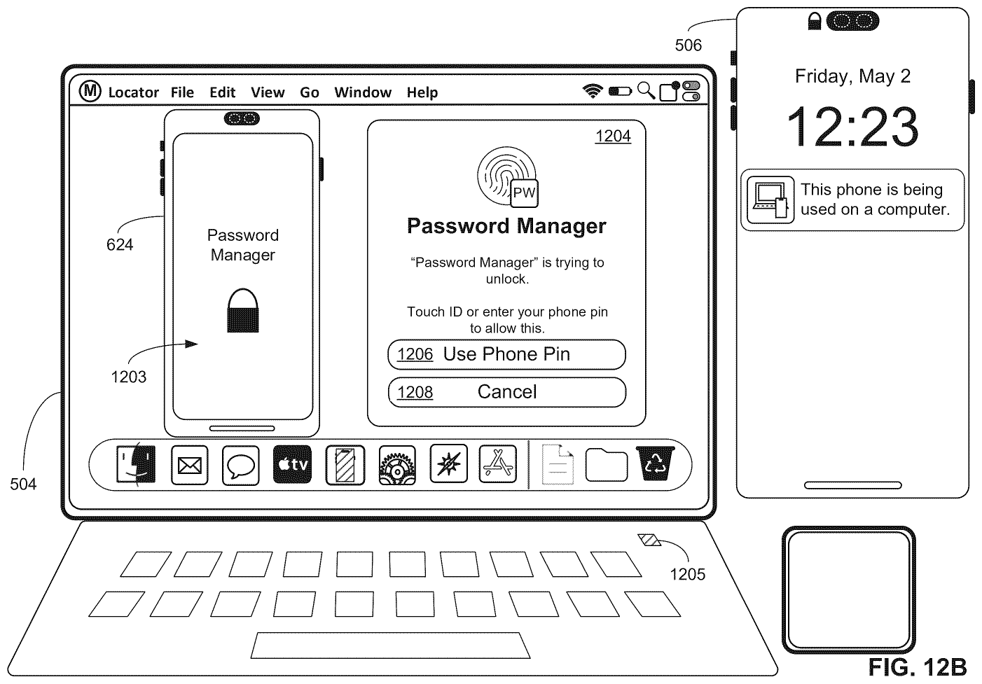

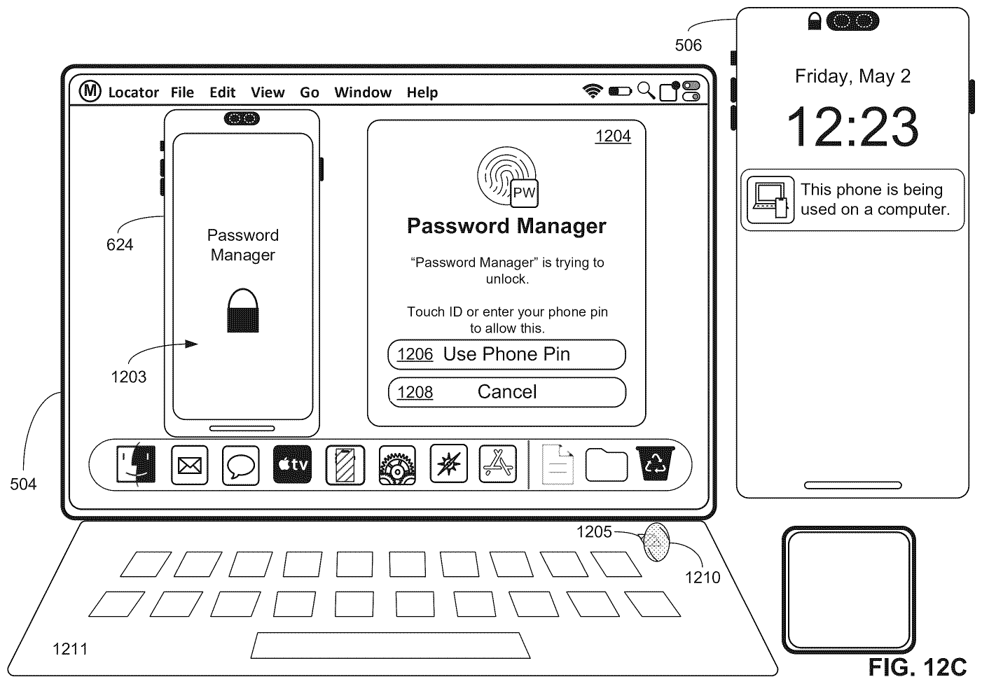

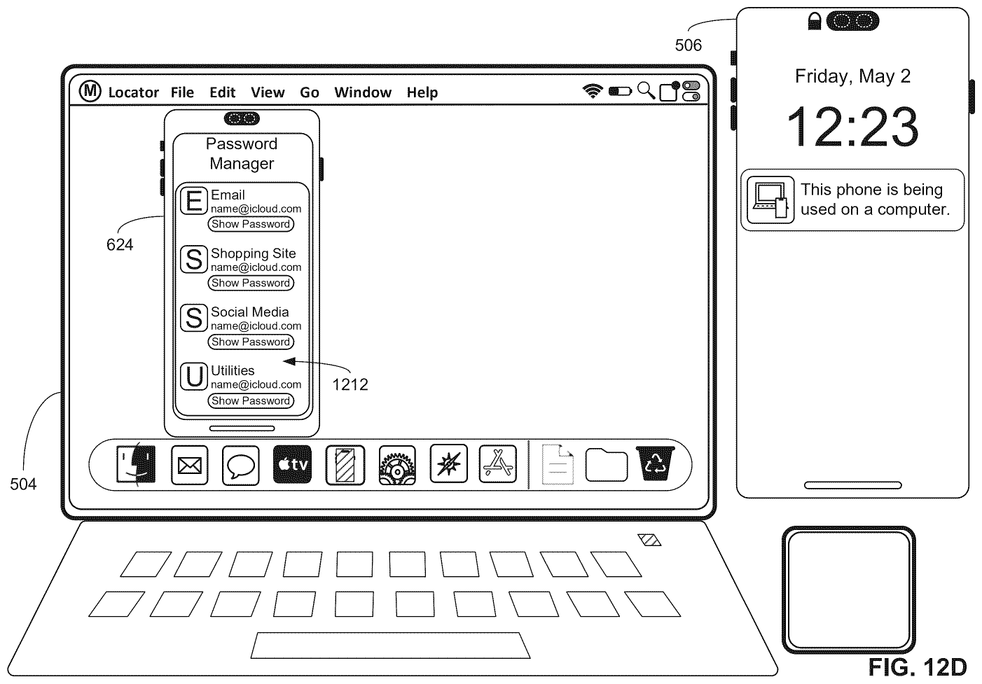

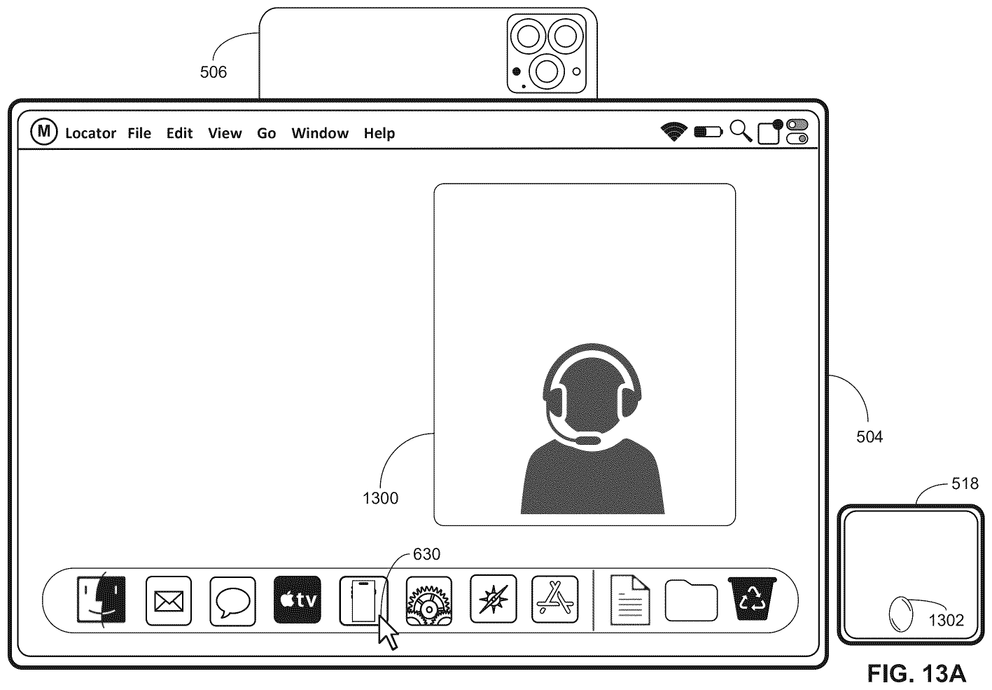

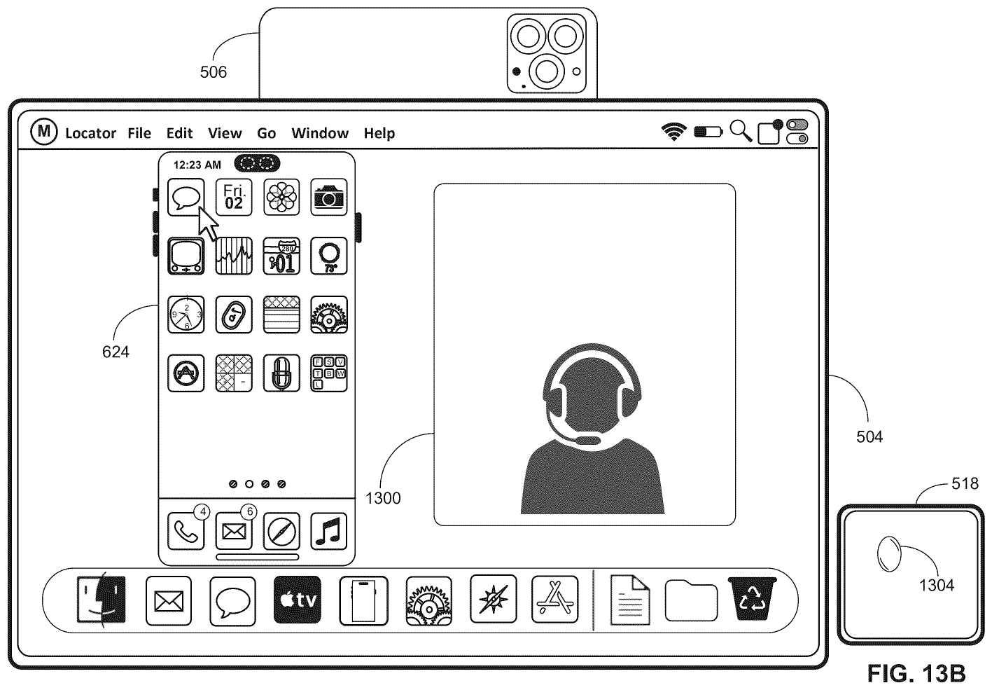

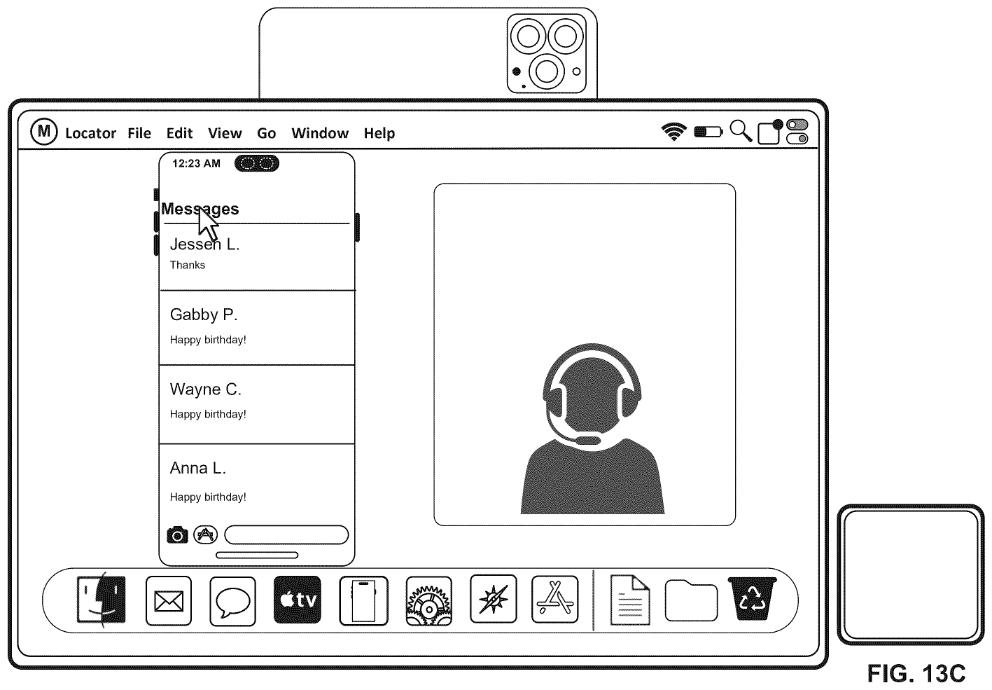

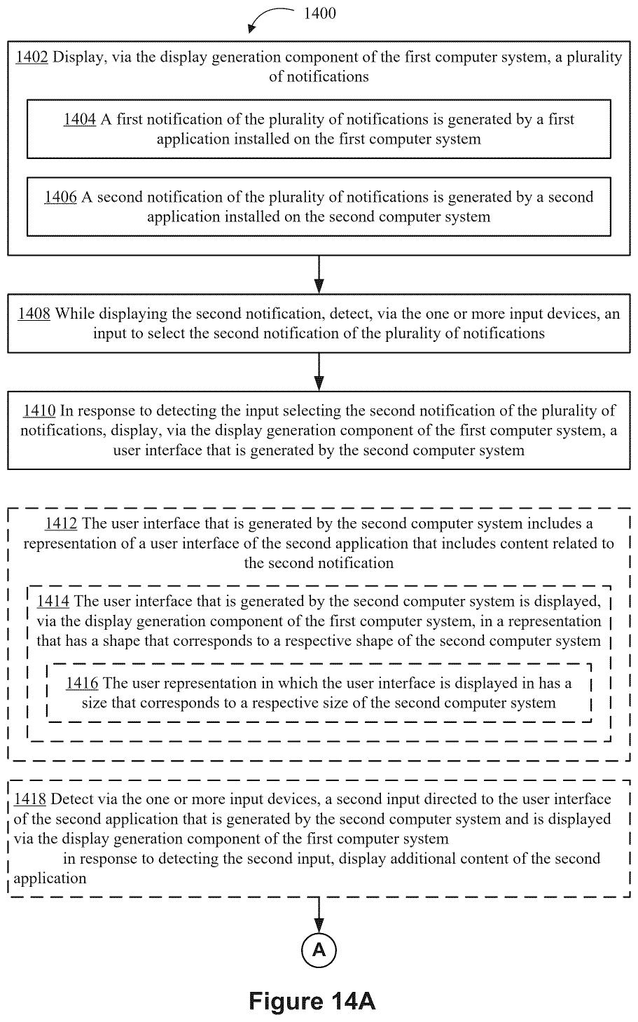

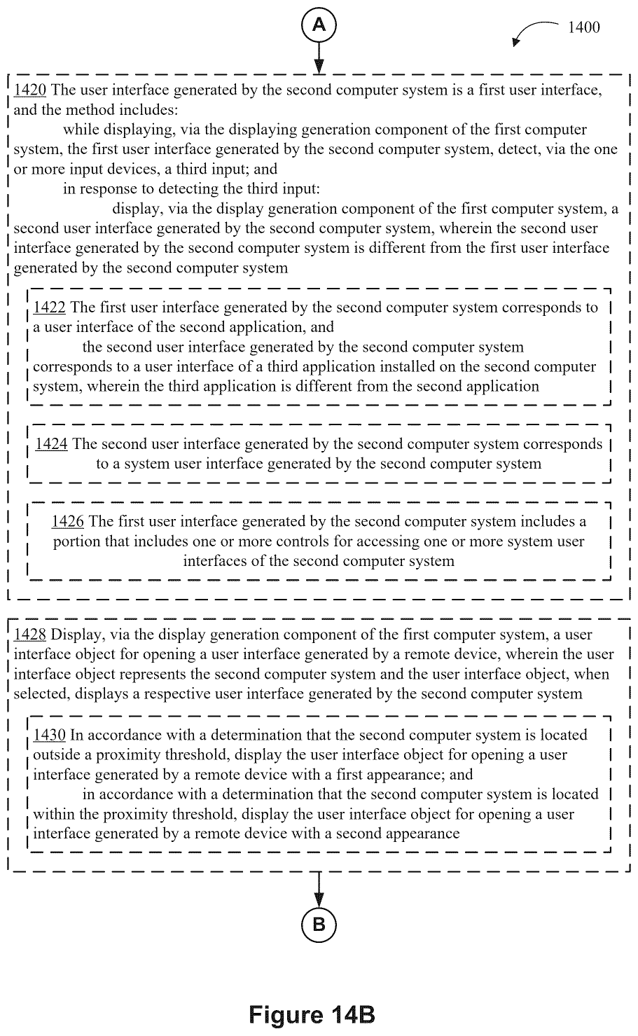

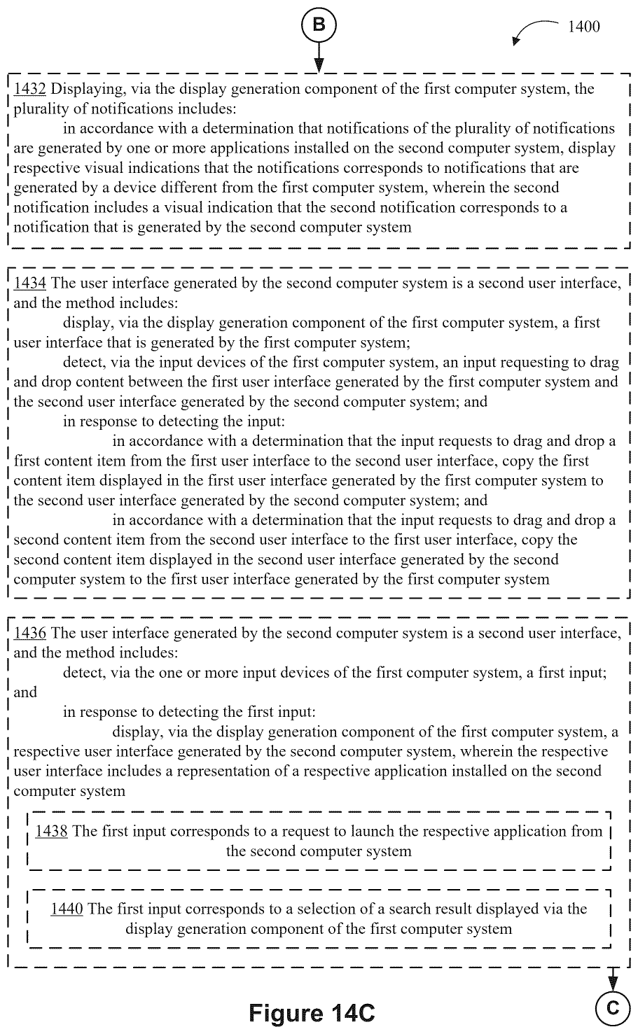

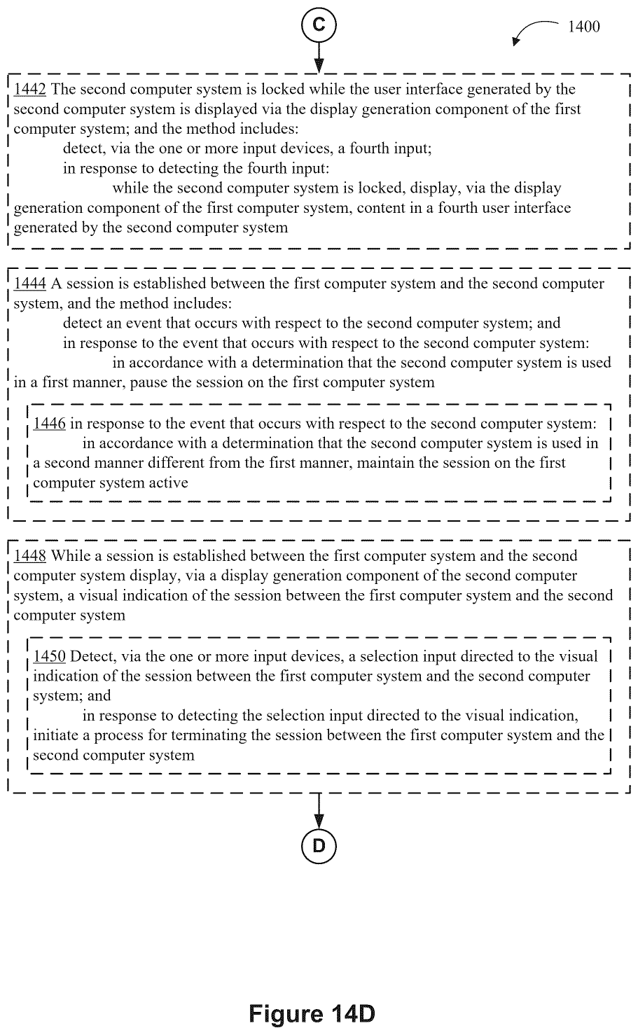

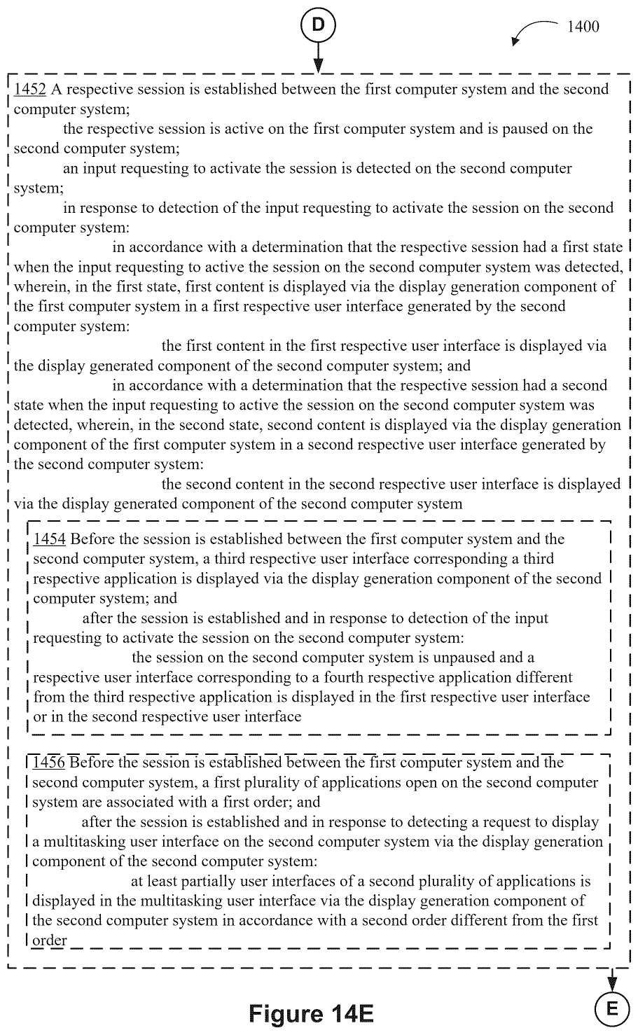

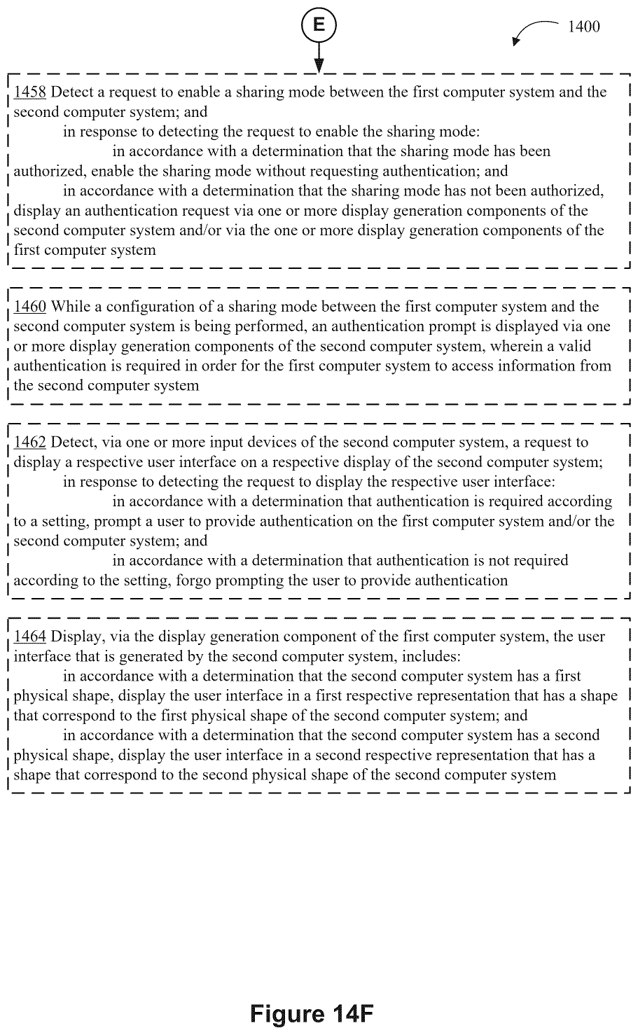

Below, FIGS. 1A-1C, 2, and 3A provide a description of example devices. FIGS. 3B-3G describe the use of Application Programming Interfaces (APIs) to perform operations. FIGS. 4A-4B and 5A-5I illustrate example user interfaces for wirelessly pairing a remote device to a computer system. FIGS. 6A-6W illustrate example user interfaces for interacting with a remote device via inputs directed at user interfaces of the remote device displayed on a computer system. FIGS. 7A-7C illustrate example user interfaces for interacting with notifications generated by applications installed on the computer system via input devices of the computer system. FIGS. 8A-8J illustrate example user interfaces for sending data from the remote device to a device other than the remote device and/or the computer system via inputs directed at the representation of the remote device displayed on the computer system. FIGS. 9A-9G illustrate example user interfaces for copying data from the remote device to the computer system via the representation of the remote device 506 displayed on the computer system. FIGS. 10A-10F illustrate example user interfaces for interacting with the remote device via the representation of the remote device while the remote device is performing standby functionality (e.g., the remote device is in a standby mode). FIGS. 12A-12D illustrate example user interfaces for interacting with a secure application of the remote device via the representation of the remote device at the computer system and authentication hardware of the computer system. FIGS. 13A-13C illustrate example user interfaces for interacting with the remote device via the representation of the remote device displayed on the computer system 504 while the remote device is providing video captured by the remote device to the computer system. FIGS. 14A-14F illustrate a flow diagram of a method for integrated interactions with multiple devices.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

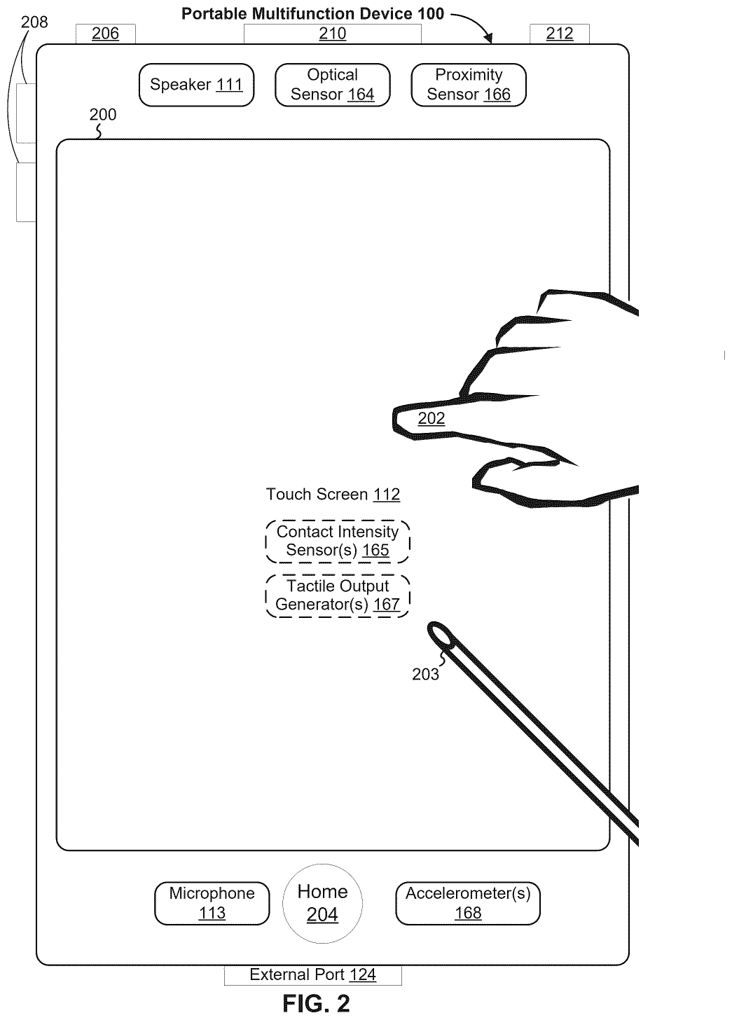

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch® and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 1400 (FIGS. 14A-14F) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Some of the examples that follow will be given with reference to a device that detects inputs on a touch-sensitive surface that is separate from the display and some of the examples that follow will be given with reference to touch screen display 112 (where the touch sensitive surface and the display are combined), as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5I, 6A-6W, 7A-7C, 8A-8J, 9A-9G, 10A-10F, 11A-11B, 12A-12D, and 13A-13C illustrate example techniques for interacting with a remote electronic device (also referred to herein as a remote device) via a computer system, e.g., a local desktop or laptop computer. FIG. 14 is a flow diagram of an exemplary method 1400 of example techniques for interacting with a remote electronic device via a computer system in accordance with some embodiments. The user interfaces in 6A-6W, 7A-7C, 8A-8J, 9A-9G, 10A-10F, 11A-11B, 12A-12D, and 13A-13C are used to illustrate the processes described below, including the processes in FIG. 14.

In some embodiments, a remote electronic device that is paired with a computer system and, optionally, within a proximity range from each other, can be interacted with via the computer system. Inputs detected by input device(s) of the computer system can cause the remote electronic device to generate user interfaces that are displayed on a display of the computer system, optionally, in a shape and/or form that corresponds to a screen of the remote electronic device. For example, FIGS. 6A-6W illustrate displaying notifications and/or other user interfaces generated by a remote electronic device 506 on a display 501 of a computer system 504, and a user opening the notifications and interacting with the user interfaces generated by the remote electronic device 506 in response to one or more inputs detected via the input devices of the computer system 504, as described in further detail below. In some embodiments, during the pairing process of the remote electronic device 506 to the computer system 504, an authentication on the remote electronic device 506 is required in order for the computer system 504 to access the remote electronic device 506, thereby improving security. In some embodiments, the authentication process is required during the pairing process and, optionally, the need for such authentication afterwards only happens after periods of inactivity, the remote device being moved beyond the required proximity range, etc. (e.g., at subsequent requests from the computer system 504 to access the remote electronic device 506), in accordance with a selected configuration. For example, FIGS. 5A-5I illustrate example user interfaces and techniques for pairing (e.g., via a wireless connection) a remote computer system 506 (e.g., a smartphone, a tablet, or another electronic device) to a computer system 504 (e.g., a desktop computer, a laptop, a tablet, or another electronic device), in accordance with some embodiments.

Although some of the examples which follow are provided with reference to inputs on a touch-sensitive surface 518 that is separate from the display 501 of the first computer system 504, in some embodiments, the computer system 504 detects inputs at a touch-sensitive display (e.g., the touch-sensitive surface 518 and the display 501 are integrated and/or combined). In some embodiments, the remote device 506 detects inputs at a touch-sensitive display 507 (e.g., the touch-sensitive surface 518 and the display 501 are integrated and/or combined).

Analogous operations are, optionally, performed on the computer system 504 and/or the remote device 506 with a display and a separate touch-sensitive surface in response to detecting contacts on the touch-sensitive surface while displaying the user interfaces shown in the figures, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) while a location or object is targeted, such as when the location of the hand(s) and/or finger(s) are on or near the object or the location or while a focus selector is on the location or object.

FIG. 5A illustrates a first room 590 and a second room 592 next to each other. Top view 580 of rooms 590 and 592 are illustrated at the bottom left of the figure. A computer system 504 (e.g., a desktop, laptop, or tablet computer, or another electronic device) is positioned on a desk 582 in the first room 592. A remote device 506A (e.g., a smartphone, a tablet, or other portable/mobile electronic device) is positioned next to the computer system 504 on the same desk 582. The remote devices 506B and 506D are located in the same first room 590 as the computer system 504 but on different surfaces, and remote devices 506D and 506E are positioned in the second room 592. In some embodiments, to pair a remote device with a computer system 504 or to interact with the remote device in response to inputs detected by input devices of the computer system 504, the remote device is required to be within a predetermined proximity range of the computer system 504. For example, FIG. 5A illustrates a proximity range 500 with a proximity threshold distance “D” 502 from the computer system 504. Optionally, remote devices are paired to the computer system 504 via Bluetooth or other short-range wireless connectivity protocol. In some embodiments, it is not required that the remote device(s) are in the same room with the computer system to meet the proximity threshold distance “D” 502. In some embodiments, remote devices within the proximity range 500 (e.g., located within a threshold distance “D” 502 of the computer system 504) can be paired to the computer system 504, while remote devices outside the proximity range 500 (e.g., located at a more than the threshold distance “D” from the computer system 504) are too far to be paired with the computer system 504. For example, the remote device 506A and the remote device 506B (e.g., in a standby and/or ambient mode) are available to be paired with the computer system 504 or interacted with by inputs detected via input device(s) of the computer system 504 because remote devices 506A and 506B are within the proximity range 500 (e.g., Bluetooth Low Energy range, 100 ft, 50 ft, 25 ft, 10 ft, 5 ft, 3 ft, 1 ft, etc.). In another example, the remote device 506C (e.g., charging via a wall outlet) located in the second room 592 (e.g., different from the first room 590 where the computer system 504 is located), is available to be paired with the computer system 504 or interacted with by inputs detected via input device(s) of computer system 504 even though remote device 506C is located in the second room 592 that is different from the first room 590 in which the computer system 504 is located because the remote device 506C is within the proximity range 500 of the computer system 504. In another example, the remote device 506D is not available for pairing with the computer system 504 or for interaction from the computer system 504 even though the computer system 504 and the remote device 506D are located in the same room 590 because the remote device 506D is not within (e.g., outside) the proximity range 500. In another example, the remote device 506E is not available for pairing with the computer system 504 or for interaction with the computer system 504 because the remote device 506E is not within the proximity range 500.

In some embodiments, the proximity range 500 and/or the proximity threshold distance “D” 502 are based on a communication protocol (e.g., Bluetooth), and, therefore, may not be a constant distance surrounding the computer system as objects, such as walls, may interfere with the wireless communication range. In some embodiments, the proximity threshold distance “D” 502 can also be configured by a user (e.g., via a settings user interface). For example, the user may configure the proximity range 500 and/or the proximity distance threshold ‘D” 502 to be less than what is required by the communication protocol.

In some embodiments, the proximity threshold distance “D” 502 includes a first proximity distance threshold “D1” 502A and a second proximity distance threshold “D2” 502B. The second proximity distance threshold “D2” 502B is greater (e.g., farther) than the first proximity distance threshold “D1” 502A. For example, the first proximity distance threshold “D1” 502A is closer to the computer system 504 than the second proximity distance threshold “D2” 502B. A remote device within the first proximity distance threshold “D1” 502A is available for interaction (e.g., real-time interactions) from the computer system 504, and the remote device can send one or more notifications from the remote device to the computer system 504. For example, the remote device 506A is available for interactions from the computer system 504 and can send one or more notifications from the remote device 506A to the computer system 504 because the remote device 506A is within the first proximity distance threshold “D1” 502A. A remote device within the second proximity distance threshold “D2” 502B can also send one or more notifications from the remote device to the computer system 504, but is not available for interaction from the computer system 504. In another example, the remote device 506C can send one or more notifications from the remote device 506C to the computer system 504, but is not available for interaction from the computer system 504 because the remote device 506C is only within the second proximity distance threshold “D2” 502B and not within the first proximity distance threshold “D1” 502A. In some embodiments, a remote device outside the first proximity distance threshold “D1” 502A and the second proximity distance threshold “D2” 502B can send one or more notifications from the remote device to the computer system 504 via a communication protocol other than the short-range wireless connectivity protocol (e.g., wi-fi or other long-range wireless connectivity and/or networking protocol). For example, the remote device 506E, outside the proximity distance threshold and, therefore outside the range of the wireless connectivity protocol, can send one or more notifications from the remote device to the computer system 504 via a long-range wireless connectivity and/or networking protocol (e.g., the remote device 506E and computer system 504 are connected to the same local area network, connected to the Internet, etc.). In some embodiments, the long-range wireless connectivity and/or networking protocol is used when the remote device and the computer system 504 cannot connect via the short-range communication protocol (e.g., interference, incompatible short-range communication protocols, etc.).

FIG. 5B illustrates a configuration user interface 514 for pairing a remote device 506 (e.g., remote device 506A, 506B, or 506C in FIG. 5A) with the computer system 504. In some embodiments, the configuration user interface 514 is automatically displayed in accordance with a determination that the remote device 506 is within the proximity threshold distance “D” 502 from the computer system 504 (e.g., within the proximity range 500). In some embodiments, a user input is required to display the configuration user interface 514, as described in further detail below.

In some embodiments, in accordance with a determination that the remote device 506 is closer to the computer system 504 than the proximity threshold distance “D” 502, the computer system 504 automatically displays, on the display 501 of the computer system 504, a remote device icon 508 in a dock 503 (e.g., the remote device icon 508 appears in the dock 503), as illustrated in FIG. 5B. In some embodiments, the computer system 504 displays the remote device icon 508 in accordance with a determination that the remote device 506 and the computer system 504 are associated with the same user account (e.g., a network and/or cloud account). In some embodiments, the remote device icon 508 is hidden (e.g., not displayed) if the remote device 506 (and other remote device(s) that are paired with the first device 504) is more than the proximity threshold distance “D” 502 away from the computer system 504.

In some embodiments, the remote device icon 508 is an icon for opening (e.g., displaying) a user interface generated by a remote device 506 (e.g., for accessing and/or interacting with the remote device 506 from the computer system 504). In accordance with a determination that the remote device 506 is moved to within the proximity threshold distance “D” 502 from the computer system 504, the computer system 504 automatically displays, on the display 501 (e.g., in the dock 503) of the computer system 504, the remote device icon 508. In some embodiments, the computer system 504 animates the display of remote device icon 508 and/or outputs a sound to indicate the appearance of the remote device icon 508 (e.g., to alert and/or prompt the user for a user input). For example, animations of the display of the remote device icon 508 include the remote device icon 508 shaking, wiggling, bouncing, etc. In some embodiments, the configuration user interface 514 is displayed in response to a user input at the remote device icon 508.

In some embodiments, the appearance of remote device icon 508 changes in accordance with a determination that a remote device enters the proximity range 500 of computer system 506 (e.g., a remote device that is recognized by computer system 504, as opposed to any device that is within range), and the appearance of remote device icon 508 changes in accordance with a determination that a remote device exits the proximity range 500 of the computer system 504. For example, the remote device icon 508 is dark (e.g., greyed out or otherwise visually deemphasized) to indicate that the remote device 506 is not accessible from the computer system 504 (e.g., not available for interaction from the computer system 504). In some embodiments, the remote device 506 is not accessible from the computer system 504 because the remote device 506 is outside the proximity range 500, or because the remote device 506 has not yet been paired to the computer system 504. Conversely, if the remote device is within proximity of the computer system 504 then the icon is emphasized or not black or grayed out.

In some embodiments, in accordance with a determination that the remote device 506 is within the proximity range 500, the computer system 504 automatically displays the remote device icon 508 and the configuration user interface 514 on the display 501 of the computer system 504.

In FIG. 5B, the computer system 504 detects, via trackpad 518, an input 516 (e.g., a tap input) while pointer 630 is positioned or directed at affordance 513. The input 516 selects the affordance 513. While in FIG. 5B, the input 516 is detected by trackpad 518 of the computer system 504, the input 516 can also be detected by display 501 that is optionally a touch-sensitive display 507 (e.g., a touchscreen), or one or more other input devices that are in communication with computer system 504, as described. In response to selecting the affordance 513, the computer system 504 proceeds with the pairing process of the remote device 506 to computer system 504, as describe in further detail below with reference to FIGS. 5C-5I. Alternatively, the pairing process can be aborted or discontinued in response to a user input selecting affordance 515 via an input at the trackpad 518. FIG. 5C is a transition from FIG. 5B in response to the input 516 selecting the affordance 513. In response to the input 516, the computer system 504 proceeds with pairing of the computer system 504 and the remote device 506, including prompting the user to provide authentication. In FIG. 5C, a prompt 520 is displayed in the configuration user interface 514 that instructs the user to unlock the remote device 506 to continue with the pairing process.

Further, in FIG. 5C, the remote device 506 detects, via a touch-sensitive display 507 of the remote device 506, an input 522 (e.g., a swipe input in an upward direction, from the bottom toward the top of the remote device 506) unlocking the remote device 506. In response to input 522, the remote device 506 initiates an authentication process for unlocking, as described in further detail below with reference to 5D. FIG. 5D is a transition from FIG. 5C in response to the sipe input 522. In response to the input 522, the remote device 506 begins the authentication process that is required for the pairing of the remote device 506 to the computer system 504. In some embodiments, the authentication method is based on biometrics (e.g., fingerprint, face recognition, retinal scan, and/or other biometrics), passwords, passcodes, authentication codes, and/or other means for authentication or combination of authentication means. For example, in FIG. 5D, device 506 prompts a user to enter a passcode to unlock the remote device 506 via the touch-sensitive display 507 of the remote device 506. In some embodiments, the passcode can include any sequence of alphanumeric characters.

In FIG. 5D, the remote device 506 detects, via the touch-sensitive display 507 of the remote device 506, an input 524 (e.g., a tap input) directed at the final digit that completes the passcode for unlocking the remote device 506. In some embodiments, entering the correct passcode, unlocks the remote device 506, as described in further detail to FIG. 5E. FIG. 5E is a transition from FIG. 5D in response to the input 524 selecting the digit zero that completed the passcode for unlocking the remote device 506. In response to the input 524 and in accordance with a determination that the correct passcode has been entered at the second device 506, the remote device 506 is unlocked and the remote device 506 and the computer system 504 continue the pairing process. In some embodiments, the pairing process requires permission from the user to connect the remote device 506 to the computer system 504. For example, in FIG. 5E, the configuration user interface 514 displays a prompt 526 requesting permission or confirmation from the user that the remote device 506 can be connected to the computer system 504. In some embodiments, the user can select affordance 528 to continue with the pairing process and affordance 530 to exit or abort the pairing process. Accordingly, to pair the remote device 506 and the computer system 504, the pairing process requires confirmation received at the computer system 504 and authentication received at the remote device 506, thereby improving security and privacy of the pairing.

In FIG. 5E, the computer system 504 detects, via the trackpad 518, an input 532 (e.g., a tap input) while the pointer 630 is positioned or directed at the affordance 528. The input 532 selects the affordance 528. In response to the input 532, the user provides permission for pairing the remote device 506 to the computer system 504 and the pairing process continues. FIG. 5F is a transition from FIG. 5E in response to the detection of the input 532 selecting affordance 528. In response to the input 532, the pairing process proceeds by requiring another permission on the remote device 506 (e.g., optionally in addition to the permission required on the computer system 504). For example, in FIG. 5F, the configuration user interface 514 displays a prompt 534 instructs the user to proceed with the pairing process on the remote device 506. In accordance with a determination that the remote device 506 is unlocked and the computer device 504 has received permission to proceed with the pairing process, remote device 506 displays a prompt 536 requesting permission to connect the remote device 506 to the computer system 504. In some embodiments, the user can select affordance 538 to continue with the pairing process and affordance 540 to exit or abort the pairing process.

In FIG. 5F, the remote device 506 detects, via the touch-sensitive display of the remote device 506, an input 542 (e.g., a tap input) directed at the affordance 538. In response to the input 542, the user provides permission for pairing the remote device 506 to the computer system 504 and the pairing process continues. FIG. 5G is a transition from FIG. 5F in response to the detection of the input 542 selecting the affordance 538. In response to the input 542, the remote device 506 begins the authentication process (e.g., the authentication process as described above in further detail to FIG. 5D) that is required for the pairing of the remote device 506 to the computer system 504. For example, in FIG. 5G, the remote device 506 prompts the user to enter the passcode, via the touch-sensitive display of the remote device 506, to pair the remote device 506 to the computer system 504, and the remote device 506 detects, via the touch-sensitive display of the remote device 506, an input 544 (e.g., a tap input) directed at the final digit that completes the passcode for pairing the remote device 506 to the computer system 504. In some embodiments, entering the correct passcode pairs the remote device 506 and the computer system 504, concludes the pairing process, and begins a configuration process for configuring authentication for subsequent connections of the computer system 504 to the remote device 506. FIG. 5H is a transition from FIG. 5G in response to the input 544. In response to the input 544 and in accordance with a determination that the correct passcode has been entered, the computer system 504 displays, via the display 501, a prompt 546 for configuring authentication. In some embodiments, a user can specify whether authentication should be requested every time the computer system 504 connects to the remote device 506 or whether authentication is required only during the pairing process. For example, configuration option 548 for automatic authentication, when selected, causes the computer system 504 to automatically connect the computer system 504 to the remote device 506 without requesting authentication from the user, whereas configuration option 550 in configuration user interface 514, when selected, causes the computer system 504 to request authentication from the user each time the computer system 504 requests access to remote device 506.

In some embodiments, when automatic authentication is enabled (e.g., configuration option 548 is selected), the user does not need to authenticate (e.g., provide the passcode for the remote device 506 via the touch-sensitive display of the remote device 506 or via an input device, such as the trackpad 518 and/or a keyboard, of the computer system 504) every time the computer system 504 and the remote device 506 reconnect. In another example, when automatic authentication is enabled (e.g., configuration option 548 is selected), the user does not need to authenticate within a threshold amount of time (e.g., 1 minute, 2 minutes, 5 minutes, 10 minutes, 30 minutes, 1 hour, 2 hours, 5 hours, 10 hours, and/or a different threshold amount of time) from the last authenticated connection between the computer system 504 and the remote device 506. In yet another example, when automatic authentication is enabled (e.g., configuration option 548 is selected), the user does not need to authenticate when the user is in a trusted location and/or when the user is wearing a trusted device, like a watch coupled to the same user account, the watch is within the proximity range 500, and/or the watch is paired to the computer system 504. In some embodiments, when automatic authentication is not enabled (e.g., configuration option 550 is selected), the user needs to authenticate (e.g., provide the passcode for the remote device 506 via the touch-sensitive display of the remote device 506 or via an input device, such as the trackpad 518 and/or a keyboard, of the computer system 504) every time the computer system 504 and the remote device 506 reconnect. The authentication method is described in further detail to FIGS. 5D and 5G. In some embodiments, reconnection is required when the remote device 506 is disconnected from the computer system 504 (e.g., the remote device 506 is moved outside the proximity range 500), or when the user disconnects the remote device 506 from the computer system 504.

In FIG. 5H, the computer system 504 detects, via the trackpad 518, an input 552 (e.g., a tap input) while pointer 630 is positioned or directed at the affordance 554. The input 552 selects the affordance 554. In response to selecting affordance 554, the configuration process concludes. FIG. 5I is a transition from FIG. 5H in response to the tap input 552 selecting the affordance 554 for concluding the configuration process. In response to the tap input 552, the computer system 504 concludes (e.g., finishes) the configuration process. In FIG. 5I, the computer system 504 optionally displays, via the display 501, a user interface 560 of the remote device 506 generated by the remote device 506. In some embodiments, the user interface 560 of the remote device 506 displayed by the computer system 504 is the same as the user interface 560 of the remote device 506 displayed by the remote device 506. For example, the remote device 506 generates the user interface 560, which is displayed at the computer system 504 and/or the remote device 506. In some embodiments, the user interface 560, generated by the remote device 506, is only displayed by the computer system 504 via the display 501.

Operations and user interfaces associated with the user interface 560 are described below in more detail with respect to at least FIGS. 6A-6W, 8A-8J, 9A-9G, 10A-10F, 12A-12D, and 13A-13C.

FIGS. 6A-6W illustrate example user interfaces for interacting with the remote device 506 via a user interface of the remote device displayed by the computer system 504 on the display 501, in accordance with some embodiments.

FIG. 6A illustrates the computer system 504 displaying, via the display 501, a proximity user interface 600 indicating that the remote device 506 is at a distance greater than the proximity threshold distance “D” 502 from the computer system 504. The proximity user interface 600 includes instructions to bring the remote device 506 and the computer system 504 within the proximity range 500 (e.g., such that the distance between the computer system 504 and the remote device 506 is less than the proximity threshold distance “D” 502).

In some embodiments, the appearance of the remote device icon 508 is based on whether the remote device 506 is within the proximity range 500 and/or whether the 506 remote device is paired to and available for interactions from the computer system 504. For example, in FIG. 6A, the computer system 504 displays, on the display 501, a dark version (e.g., greyed out or otherwise visually deemphasized) of the remote device icon 508 to indicate that the remote device 506 is not paired with the computer system 504 and/or not available for interactions from the computer system 504 because the computer system 504 and the remote device 506 are not within the proximity range 500. FIG. 6B is a transition from FIG. 6A in accordance with a determination that the remote device 506 is at a distance less than the proximity threshold distance “D” 502 from the computer system 504 (e.g., within the proximity range 500). In some embodiments, in accordance with a determination that the remote device 506 is within the proximity range 500, the remote device 506 automatically pairs to the computer system 504 (e.g., the remote device 506 is available for interactions from the computer system 504).

In some embodiments, in response to the remote device 506 pairing to the computer system 504, the remote device 506 displays, via the touch-sensitive display 507, an indication 606 that the remote device 506 is paired to and available for interactions from the computer system 504. For example, the remote device 506 displays the indication 606 (e.g., a persistent notification that indicates an ongoing activity, such as the remote device 506 paired to the computer system 506) in a wake-screen user interface 607.

In some embodiments, the appearance of the device icon 508 changes when the remote device 506 enters the proximity range 500 and/or when the remote device 506 is paired to and available for interactions from the computer system 504. For example, in FIG. 6B, when the remote device 506 is paired to the computer system 504, the computer system 504 changes the appearance of the remote device icon 508 from the dark version (as shown in FIG. 6A) to a light version of the remote device icon 508 (e.g., distinct from the dark version) to indicate that the remote device 506 is paired to and available for interactions from the computer system 504

In some embodiments, notifications generated by applications installed on the remote device 506 are displayed on the display 501 of the computer system 504 (e.g., while the remote device 506 and the computer system 504 are paired and within the proximity range 500). For example, the food delivery application installed on the remote device 506 generates the notification 608 and the notification 610. The remote device 506 displays the notification 608 on the touch-sensitive display 507, and the computer system 504 displays the notification 610 on the display 501 of the computer system 504. In some embodiments, the application(s) generating the notifications are installed on the remote device 506 and, optionally, are not installed and/or not available for installation on the computer system 504. For example, the food delivery application is installed on the remote device 506 and not available for installation on the computer system 504.

In some embodiments, notifications generated by applications installed on the remote device 506 are displayed on the display 501 of the computer system 504 concurrently with the notifications generated by applications installed on the computer system 504. Accordingly, the computer system 504 displays notifications that would otherwise not be displayed without the remote device 506 being paired to the computer system 504 because the applications installed on the remote device 506 are not installed and/or not available for installation on the computer system 504, thereby increasing the availability of notifications from applications not installed on the computer system 504 and installed on the remote device 506. In some embodiments, the remote device 506 generates, by applications installed on the remote device 506, notifications before the remote device 506 is paired to the computer system 504, and those notifications are displayed on the display 501 of the computer system 506 when the remote device 506 is paired to the computer system 506.

In some embodiments, the computer system 504 displays notifications generated by application(s) installed on the remote device 506 and notifications generated by application(s) installed on the computer system 504. For example, in FIG. 6B, the computer system 504 displays, on the display 501, the notification 610 generated by the food delivery application installed on the remote device 506 and a notification 614 generated by a messaging application installed on the remote device 506 concurrently with a notification 616 generated by an email application installed on the computer system 504, a notification 618 generated by a photo editor application installed on the computer system 504, and a notification 620 generated by a video streaming application installed on the computer system 504.

In some embodiments, the computer system 504 displays, via the display 501, notifications generated by application(s) installed on the remote device 506 and/or notifications generated by application(s) installed on the computer system 504 in a region 615 of the display 501 (e.g., a dedicated region for notifications, such as a notification center). For example, the computer system 504 displays the notifications 616, 618, and 620 generated by application(s) installed on the computer system 504 in the notification center 615, and the computer system displays the notifications 610 and 614 generated by application(s) installed on the remote device 506 in the same notification center 615.

In some embodiments, the notifications generated by application(s) installed on the remote device 506 include a visual indicator 622 to identify that those notifications are generated by application(s) installed on the remote device 506. For example, in FIG. 6B, the computer system 506 displays, on the display 501, the notifications 610 and 614 generated by applications installed on the remote device 506 with the visual indicator 622 because those notifications are generated by applications installed on the remote device 506. The visual indicator 622 is displayed within and/or proximate to the notifications 610 and 614. The notifications 616, 618, and 620 generated by applications installed on the computer system 506 are displayed without the visual indicator 622 because those notifications are generated by applications installed on the computer system 506.

In FIG. 6B, the computer system 504 detects, via the trackpad 518, an input 604 (e.g., a tap input) while the pointer 630 is positioned or directed at the notification 610. The input 604 selects the notification 610. In response to the input 604, the computer system 504 displays a user interface 626 of the food delivery application, where the user interface 626 is generated by the food delivery application installed on the remote device 506. FIG. 6C is a transition from FIG. 6B in response to the input 604 selecting the notification 610. In response to the input 604, the computer system displays, on the display 501, the user interface 626 of the food delivery application, where the user interface 626 is generated by the food delivery application installed on the remote device 506. In some embodiments, the user interface 626 includes content from the food delivery application (e.g., information regarding the food delivery). For example, computer system 504 displays, on the display 501, the user interface 626 of the food delivery application including a status indicator 627 indicating that the food delivery order is on the way with an estimated time of arrival, and a map view 634 of the current location of the food delivery order 631.

In some embodiments, the computer system 504 displays, on the display 501, the user interface generated by an application installed on the remote device 506 in a representation 624 of the remote device 506. For example, the representation 624 of the remote device 506 includes a representation of the screen of the remote device 506 (e.g., a representation of a display including displayed content of the remote device 506). In some embodiments, the representation 624 of the remote device 506 corresponds to a shape and/or size of a housing or a display of the remote device 506. For example, the physical shape and/or size of the display of the representation 624 is the same as the physical shape and/or size of the remote device 506.

In some embodiments, in response to a selection of a notification displayed on the display 501 of the computer system 504, the computer system 504 ceases to display the notification. For example, in FIG. 6C, in response to the input 604 (e.g., in FIG. 6B), the computer system 504 ceases to display the notification 610 of the food delivery application. In some embodiments, in response to a selection of a notification displayed on the display 501, the remote device 506 ceases to display the notification corresponding to the selected notification displayed on the display 501 of the computer system 504. For example, in FIG. 6C, in response to the input 604 (e.g., in FIG. 6B), the remote device 506 ceases to display the notification 608 of the food delivery application. In some embodiments, the food delivery application, installed on the remote device, generated both the notification 608 (e.g., displayed on the remote device 506) and the notification 610 (e.g., displayed on the computer system 504).

In FIG. 6C, the computer system 504 detects, via the trackpad 518, an input 624 (e.g., a swipe input) to move the pointer 630. In response to the input 624, the pointer 630 is positioned within the representation 624 of the remote device 506 (e.g. the pointer 630 is positioned or directed at the user interface 626 generated by the food delivery application installed on the remote device 506). FIG. 6D is a transition from FIG. 6C in response to the input 624. In response to the input 624, the computer system 504 positions or directs the pointer at the user interface 626 generated by the food delivery application installed on the remote device 506.

In FIG. 6D, the computer system 504 detects, via the touchpad 518, an input 632 (e.g., a depinch-to-zoom). In response to the input 632, the user interface 626 displays additional content of the food delivery application. FIG. 6E is a transition from FIG. 6D in response to the input 632. In response to the input 632 via the trackpad 518, the computer system 506 displays, on the display 501, the user interface 626 with additional content generated by the food delivery application installed on the remote device 506. For example, in response to the 632, the food delivery application updates the user interface 626 to include a zoomed in version of the map view 634, and the computer system 504 displays, on the display 501 and within the representation 624 of the remote device 506, the updated user interface 626 generated by the food delivery application installed on the remote device 506.

FIG. 6F is similar in many aspects to FIG. 6E, except that in FIG. 6F, the remote device detects, via the touch-sensitive display 507 of the remote device 506, an input 636 (e.g., a swipe input). In response to the input 636, the remote device can be unlocked and displays, on the touch-sensitive display 507, the user interface 638 of the food delivery application installed on the remote device 506. FIG. 6G is a transition from FIG. 6F in response to the input 636. In response to the input 636, the remote device 506 is unlocked and displays, on the touch-sensitive display 507, the user interface 638 of the food delivery application generated by the food delivery application installed on the remote device 506.

In some embodiments, the remote device 506, when unlocked, displays, on a touch-sensitive display, a user interface that includes the same content as the user interface displayed on display 501 of the computer system 504. For example, the user interface 638 of the food delivery application displayed on the touch-sensitive display of the remote device 506 includes the same content as the user interface 626 of the food delivery application displayed on the display 501 of the computer system 504.

In some embodiments, in response to an input at the remote device 506, a session between the computer system 504 and the remote device 506 is paused. In some embodiments, pausing the session includes the computer system 504 and/or the remote device 506 obscuring the user interface generated by an application installed on the remote device 506 and displayed on the display 501 of the computer system 504. For example, in FIG. 6G, in response to the input 636 detected by the touch-sensitive display 507 of the remote device 506 to unlock the remote device 506, the computer system 506 displays, on the display 501 and within the representation 624 of the remote device 506, an overlay that partially obscures the user interface 626 (e.g., such that the user interface 626 is visually deemphasized). In this example, the overlay includes a visual indicator 604 indicating that the remote device 506 is in use at the remote device 506.

In some embodiments, in response to the remote device 506 detecting the input 636, the remote device 506 ceases to be available for interactions from the computer system 504 (e.g., inputs at the user interface 626 does not cause the remote device 506 to perform operations). For example, inputs received at the trackpad 518 of the computer system 506 do not cause the remote device 506 to perform operations while the session between the computer system 504 and the remote device 506 is paused.

FIG. 6H is similar in many aspects to FIG. 6G, except that in FIG. 6H, the remote device 506 detects, via the touch-sensitive display 507, an input 642 (e.g., a swipe input in an upward direction, from the bottom toward the top of the remote device 506) to display a home-screen user interface on the touch-sensitive display 507 of the remote device 506. FIG. 6I is a transition from FIG. 6H in response to the input 642. In response to the input 642, the remote device 506 displays, on the touch-sensitive display 507, the home-screen user interface 644, which is distinct from the user interface 638.

In some embodiments, the computer system 504 replaces the display of the user interface 638 with the home-screen user interface 646. The home-screen user interface 646, displayed on the display 501 and within the representation 624 of the remote device 506, includes the same content as the home-screen user interface 644. For example, in FIG. 6I, the session between the computer system 504 and the remote device 506 is paused, and the computer system displays the overlay that partially obscures the home-screen user interface 644. In this example, because the session between the computer system 504 and the remote device 506 is still paused, the remote device 506 remains unavailable for interactions from the computer system 504.

In some embodiments, the computer system 504 does not change the content displayed within the representation 624 of the remote device 506 while the session between the computer system 504 and the remote device 506 is paused. For example, in response to the input 642, the remote device 506 displays, on the touch-sensitive display 507, the home screen user interface 644, and the computer system 504 continues to display the obscured version of the user interface 626 of the food delivery application.

In FIG. 6I, the remote device 506 detects, via an input device 647 (e.g., a physical button), an input 648 to lock the remote device 506. In response to the input 648, the remote device 506 locks. FIG. 6J is a transition from FIG. 6I in response to the input 648. In response to the input 648, the remote device 506 locks and the remote device 506 ceases to display the home-screen user interface 644. In some embodiments, the remote device 506 replaces the home-screen user interface 644 with a lock-screen user interface 649, where the remote device 506 displays, on the touch-sensitive display 649 of the remote device 506, the lock-screen user interface 649.

In some embodiments, in response to the remote device 506 entering the locked state, the session between the computer system 504 and the remote device 506 resumes, and the overlay that partially obscures the representation 624 of the remote device 506 and/or a user interface displayed within the representation 624 of the remote device 506 ceases to be displayed. For example, as shown in FIG. 6J, in response to the input 648, the remote device 506 enters a locked state, and the computer system 504 displays, on the display device 501, an unobscured version of the home-screen user interface 646 in the representation 624 of the remote device 506. In some embodiments, in response to the remote device 506 entering the lock state, the remote device 506 is available for interactions from the computer system 504. For example, inputs at the home-screen user interface 646 can cause the remote device 506 to perform operations (e.g., launching an application installed on the remote device 506).

FIG. 6K is similar in many aspects to FIG. 6J, except that in FIG. 6K, the computer system 504 ceases to display the user interface 646 and the computer system 504 detects, via the touch-sensitive input device 518, a input 650 (e.g., a tap input) while the pointer 630 is positioned or directed at the notification 614 to select the notification 614 generated by the messaging application installed on the remote device 506. FIG. 6L is a transition from FIG. 6K in response to the input 650 to select the notification 614. In response to the input 650, the computer system 504 displays, on the display 501, the user interface 652 of the messaging application, where the user interface 652 is generated by the messaging application installed on the remote device 506.

As discussed in greater detail to FIG. 5C, in some embodiments, in response to selection of the notification 614, the computer system 504 ceases to display the notification 614 of the messaging application and the remote device 506 ceases to display the notification 612 of the messaging application, where the notifications 612 and 614 are generated by the messaging application installed on the remote device 506.

In some embodiments, the user interface 652 includes one or more messages received and/or stored by the remote device 506. For example, in FIG. 6L, the messaging application generates the user interface 652 including a message 653, where the computer system 504 displays, on the display 501 within the representation 624 of the remote device 506, the user interface 652 and the message 653 generated by the messaging application.

In FIG. 6L, the computer system 504 detects, via the trackpad 518, an input 654 (e.g., a swipe) to move the pointer 630. In response to the input 654, the pointer 630 is positioned or directed at a top edge of the representation 624 of the remote device 506. FIG. 6M is a transition from FIG. 6L, in response to the input 654. In response to the input 654, the pointer 630 is positioned or directed at the representation 624 of the remote device 506.

In some embodiments, in accordance with a determination that the pointer 630 is positioned or directed at a top edge of the representation 624 of the remote device 506, the computer system 504 displays the representation 624 with a quick-actions bar 656 for accessing one or more system user interfaces of the remote device 506. The quick-actions bar 656 includes a back affordance 658 for returning to a previous user interface and/or undoing the most recent action, a home affordance 660 to navigate to the home screen, an application switcher affordance 662 for displaying and navigating to recently used applications, a quick settings affordance 664 for accessing a quick settings menu, a close affordance 666 for closing the virtual phone, and/or any other affordances to interact with the second device 506.

In FIG. 6M, the computer system 504 detects, via the trackpad 518, an input 655 (e.g., a tap input) to select the home affordance 658. In response to the input 655 selecting the home affordance 658, the computer system 504 displays a home-screen user interface 672 generated by the remote device 506.

In FIG. 6N, the computer system 504 detects, via the trackpad 518, an input 657 (e.g., a swipe input) while the pointer 630 is positioned or directed at a bottom of the representation 624 of the remote device 506 to cause the computer system 504 to display, on the display 501 and within the representation 624 of the remote device, the home-screen user interface 672 generated by the remote device 506. FIG. 6O is a transition from FIG. 6M in response to the input 655 and/or is a transition from FIG. 6N in response to the input 657. In response to the input 655 or the input 657, the computer system 504 displays, on the display 501 and within the representation 624 of the remote device 506, the home-screen user interface 672.

FIG. 6P is similar in many aspects to FIG. 6O, except that the pointer 630 is positioned or directed at the application switcher affordance 662. In FIG. 6P, the computer system 504 detects, via the trackpad 518, an input 674 (e.g., a tap input) to select the application switcher affordance 662. In response to the input 674 selecting the application switcher affordance 662, the computer system 504 displays an application switcher user interface 680 generated by the remote device 506.

FIG. 6Q is similar in many aspects to FIG. 6O, except that the pointer 630 is positioned or directed at the bottom of the representation 624 of the remote device 506. In FIG. 6Q, the computer system 504 detects, via the trackpad 518, an input 676 (e.g., a swipe input) while the pointer 630 is positioned or directed at a bottom of the representation 624 of the remote device 506 to cause the computer system 504 to display, on the display 501 and within the representation 624 of the remote device, the application switcher user interface 680 generated by the remote device 506. In some embodiments, the input 676 is held for a threshold time interval 678 to cause the display of the application switcher user interface 680. FIG. 6R is a transition from FIG. 6P in response to the input 674 and/or is a transition from FIG. 6Q in response to the input 676. In response to the input 674 or the input 676, the computer system 504 displays, on the display 501 and within the representation 624 of the remote device 506, the application switcher user interface 680. The application switcher user interface 680 includes representations of one or more recently used applications installed on the remote device 506. In some embodiments, selection of a representation of a recently used application installed on the remote device 506 causes the computer system 504 to display, on the display 501 and within the representation 624 of the remote device 506, a user interface of the recently used application generated by the recently used application.

FIG. 6S is similar in many aspects to FIG. 6O, except that the pointer 630 is positioned or directed at the quick settings affordance 664. In FIG. 6S, the computer system 504 detects, via the trackpad 518, an input 682 (e.g., a tap input) to select the quick settings affordance 664. In response to the input 682 selecting the quick settings affordance 664, the computer system 504 displays a quick settings user interface 686 generated by the remote device 506.

FIG. 6T is similar in many aspects to FIG. 6O, except that the pointer 630 is positioned or directed at the top-right edge of the representation 624 of the remote device 506. In FIG. 6T, the computer system 504 detects, via the trackpad 518, an input 684 (e.g., a swipe input) while the pointer 630 is positioned or directed at a top-right edge of the representation 624 of the remote device 506 to cause the computer system 504 to display, on the display 501 and within the representation 624 of the remote device, the quick settings user interface 686 generated by the remote device 506. FIG. 6U is a transition from FIG. 6S in response to the input 682 and/or is a transition from FIG. 6T in response to the swipe 684. In response to the input 682 or the input 684, the computer system 504 displays, on the display 501 and within the representation 624 of the remote device 506, the quick settings user interface 686 for controlling multiple system-wide functions and/or modes of the compute system (e.g. enabling/disabling airplane more, wi-fi, Bluetooth, screen mirroring, lock screen, screen rotation, and/or other functions).

FIG. 6V is the similar in many aspects to FIG. 6U, except that the pointer 630 is positioned or directed at the close affordance 666. In FIG. 6V, the computer system 504 detects, via the trackpad 518, an input 691 (e.g., a tap input) to select the close affordance 666. In response to the input 691 selecting the close affordance 666, the computer system 504 ceases to display the representation 624 of the remote device 506 and any user interface displayed within the representation 624. FIG. 6W is a transition from FIG. 6V in response to the input 691 selecting the close affordance 666. In response to the input 691 selecting the close affordance 666, the computer system 504 ceases to display the representation 624 of the remote device 506 and any user interface displayed within the representation 624.

In some embodiments, in response to the input 691 selecting the close affordance 666, the session between the computer system 504 and the remote device 506 terminates and/or the computer system 504 is no longer paired to the remote device 506, and thus the remote device 506 is no longer available for interactions from the computer system 504. In FIG. 6W, when the remote device 506 is no longer paired to and no longer available for interactions from the computer system 504, the remote device 506 ceases to display the indication 606.

FIGS. 7A-7C illustrate example user interfaces for interacting with notifications generated by applications installed on the computer system via input devices of the computer system, in accordance with some embodiments.

In some embodiments, the computer system 504 displays, on the display 501, notifications generated by one or more applications installed on the computer system 504 concurrently with notifications generated by the one or more applications installed on the remote device 506. Inputs detected by input device(s) of the computer system 504 and directed at a notification generated by an application installed on the computer system 504 can cause the computer system 504 to display, on the display 501 of the computer system 504, a user interface of the application installed on the computer system 504.

FIG. 7A is similar in many aspects to FIG. 6B, except the pointer 630 is positioned or directed at the remote device icon 508 in the dock 503, where the remote device icon 508 is displayed by the computer system 504 on the display 501. The computer system 504 detects, via the trackpad 518, an input 700 (e.g., a tap input) while the pointer is positioned or directed at the remote device icon 508 to select the remote device icon 508. FIG. 7B is a transition from FIG. 7A in response to the input 700 selecting the remote device icon 508. In response to the input 700, the computer system 504 displays the representation 624 of the remote device 506 and the home-screen user interface 672 of the remote device 506, where the home-screen user interface is generated by the remote device 506. In some embodiments, selecting the remote device icon 508 causes the computer system 504 to display the last-used user interface generated by the remote device 506 and/or an application installed on the remote device 506.

In FIG. 7B, the computer system 504 detects, via the trackpad 518, an input 702 (e.g., a tap input) while the pointer is positioned or directed at the notification 616 generated by the email application installed on the computer system 504 to select the notification 616. FIG. 7C is a transition from FIG. 7B in response to the input 702 selecting the notification 616. In response to the input 702, the computer system 504 displays a user interface 704 of the email application, where the user interface 704 is generated by the email application installed on the computer system 504.

In some embodiments, the computer system 504 concurrently displays, on the display 501, user interfaces generated by the computer system 504 and user interfaces generated by the remote device 506. In FIG. 7C, the computer system displays the user interface 704 of the email application generated by the email application installed on the computer on top of the representation 624 of the remote device 506 and the home-screen user interface 672.

FIGS. 8A-8J illustrate example user interfaces for sending data from the remote device 506 to a device other than the remote device 506 and/or the computer system 504 via the representation 624 of the remote device 506 displayed on the computer system 504, in accordance with some embodiments.

In some embodiments, the computer system 504 detects one or more inputs, via the touch-sensitive surface 518, to input data to the remote device 506 and send the inputted data to a device other than the computer system 504 and/or the remote device 506. For example, FIGS. 8A-8H illustrate the computer system 504 detecting inputs, via the touch-sensitive surface 518, to input data to the remote device 506 via a messaging user interface displayed by the computer system 504 on the display 501 within the representation 624 of the remote device 506 and cause the remote device 506 to send the inputted data from the remote device 506 to a device other than the remote device 506 and/or the computer system 504.

In some embodiments, the computer system detects an input, via the touch-sensitive surface 518, to reposition the display of the representation 624 of the remote device 506 (and any user interface(s) displayed within the representation 504) from a first region of the display 501 to a different region of the display 501. For example, FIGS. 8I-8J illustrate the computer system 504 detecting an input, via the touch-sensitive surface 518, while the pointer is positioned or directed at the representation 624 of the remote device 506, to reposition the display of the representation 624 of the remote device 506 and the display of the user interface 652 of the messaging application installed on the remote device 506, from a first region of the display 501 of the computer system 504, to a different region of the display 501 of the computer system 504.

FIG. 8A illustrates the remote device 506 within the proximity threshold distance “D” 502 to the computer system 504. In some embodiments, in response to the remote device 506 being within the proximity threshold distance “D” 502 to the computer system 504, the computer system 504 displays an indicator 800 to indicate that the remote device 506 is within range and available to be paired to by the computer system 504. For example, in FIG. 8A, the computer system 504 displays the indicator 800 as a pop-up notification, proximate to the remote device icon 508, indicating that the remote device 506 is within the proximity threshold distance “D” 502 to the computer system 504. In some embodiments, the indicator 800 indicates that the computer system 504 can be paired to the remote device 506, or that the computer system 504 is paired to the remote device 506.

In some embodiments, the remote device icon 508 is changed to indicate the pairing status between the computer system 504 and the remote device 506. For example, based on the pairing status between the computer system 504 and the remote device 506, the computer system 504 displays, on the display device 501, the remote device icon 508 with different characteristics (e.g., color, brightness, size, or any other characteristic) to indicate the current pairing status between the computer system 504 and the remote device 506. As shown in FIG. 8A, the light version of the remote device icon 508 is displayed because the remote device 506 is available for pairing (e.g., within the threshold range 500) with the computer system 504.

FIG. 8B illustrates the computer system 504 detecting, via the trackpad 518, an input 802 (e.g., a tap input) to select the remote device icon 508. In response to the input 802, the computer system 504 displays the representation 624 of the remote device 506 and/or the home-screen user interface 672. FIG. 8C is a transition from FIG. 8B in response to the input 802 selecting the remote device icon 508. In response to the input 802, the computer system 504 displays the representation 624 of the remote device 506 and/or the home-screen user interface 672. In some embodiments, selecting the remote device icon 508 causes the computer system 504 to display, on the display 501 and within the representation 624 of the remote device 506, the last-used user interface generated by the remote device 506 and/or generated by an application installed on the remote device 506.

In FIG. 8C, the computer system 504 detects, via the trackpad 518, an input 804 (e.g., a tap input) to select a messaging application icon 806 generated by the messaging application installed on the remote device 506. In response to the input 804 selecting the messaging application icon 806, the remote device 506 launches (e.g., opens and/or executes) the messaging application, and the computer system 504 displays the user interface 652 of the messaging application generated by the messaging application installed on the remote device 506. FIG. 8D is a transition from FIG. 8C in response to the input 804 selecting the messaging application icon 806. In response to the input 804 selecting the messaging application icon 806, the remote device 506 launches (e.g., opens and/or executes) the messaging application, and the computer system 504 displays the user interface 652 of the messaging application generated by the messaging application installed on the remote device 506. In some embodiments, the user interface 652 includes one or more messages received and/or stored by the remote device 506, and/or a content-entry field 816. For example, in FIG. 8D, the messaging application generates the user interface 652 including a message 653, where the computer system 504 displays, on the display 501 within the representation 624 of the remote device 506, the user interface 652 and the message 653 generated by the messaging application. In FIG. 8D, the computer system 504 detects, via the trackpad 518, an input 814 (e.g., a tap input) to select the content-entry field 816. In response to the input 814 selecting the content-entry field 816, the computer system 504 displays an on-screen keyboard 820.

FIG. 8E is a transition from FIG. 8D in response to the input 814 to select the content-entry field 816. In response to the input 814 selecting the content-entry field 816, the computer system 504 displays an on-screen keyboard 820. In some embodiments, the computer system 504 detects, via the trackpad 518, inputs directed at the on-screen keyboard 820 and those inputs can input text into the messaging application 806 installed on the remote device 506. In FIG. 8E, the computer system 504 detects, via the trackpad 518, an input 822 (e.g., a tap input) to select a suggested word 824. In response to the input 822 selecting the suggested word 824, the suggested word is entered into the content-entry field 816 of the messaging application installed on the remote device 506.

FIG. 8F is a transition from FIG. 8E in response to the input 822 selecting the suggested word 824. In response to the input 822 selecting the suggested word 824, the computer system 504 displays the suggested word 824 within the content-entry field 816 of the user interface 652 of the messaging application generated by the messaging application installed on the remote device 506. In FIG. 8F, the computer system 504 detects, via the trackpad 518, an input 824 (e.g., a tap input) to select an affordance 826 to send the message in the content-entry field 816. In response to the input 824 selecting the affordance 826, the message in the content-entry field 816 is sent to a device other than the computer system 504 and/or the remote device 506.

FIG. 8G is a transition from FIG. 8F in response to the input 824 to select the affordance 826. In response to the input 824 selecting the affordance 826, the message in the content-entry field 816 is sent to a device other than the computer system 504 and/or the remote device 506 (e.g., a smartphone, a tablet, a desktop computer, a laptop, a tablet, an intermediary server, or another electronic device).

In some embodiments, the messaging application updates the user interface 652 to include the sent message 828, and the computer system displays, via the display 501, the updated user interface 652 of the messaging application generated by the messaging application installed on the remote device 506. For example, in FIG. 8G, in response to the input 824 (e.g., a tap input) selecting the affordance 826, the messaging application installed on the remote device 506 sends the text in the content-entry field 816 from the remote device 506 to another device, and the messaging application updates the user interface 652 to include the sent message 828 (e.g., a message with the suggested word 824 that was sent in response to selection of the affordance 826). In this example, the computer system 504 displays, on the display 501, the updated user interface 652 that includes the sent message 828.

FIG. 8H is similar to FIG. 8G, except the computer system 504 ceases to display, on the display 501, the on-screen keyboard 820 and the pointer 630 is positioned at an affordance 832 to display a different user interface of the messaging application installed on the remote device 504. In FIG. 8H, the computer system 504 detects, via the trackpad 518, an input 830 (e.g., a tap input) to select the affordance 832 to display the different user interface of the messaging application. For example, the affordance 832 is a back affordance to display a user interface of a list of conversations of the messaging application. In response to the input 830 selecting the back affordance 832, the computer system 504 displays the user interface 833 of the list of conversations of the messaging application installed on the remote device 506.

FIG. 8J is a transition from FIG. 8H in response to the input 830 to select the back affordance 832. In response to the input 830 selecting the back affordance 832, the computer system 504 displays, on the display 501, the user interface of the list of conversations of the messaging application. In some embodiments, each conversation (e.g., conversations 835, 837, 839, and 841) of the list of conversations can be selected to cause the computer system to display the respective conversation (e.g., a conversation contains one or more messages) generated by the messaging application installed on the remote device 506. In FIG. 8J, the computer system 504 detects, via the trackpad 518, an input 834 (e.g., a swipe input) to move the representation 624 of the mobile device 506 and/or the user interface(s) within the representation 624. Prior to the input 624, the computer system 524 displays the representation 624 of the mobile device 506 and/or the user interface(s) within the representation 624 in a first region of the display 501. In response to the input 834, the computer system 504 displays the representation 624 of the mobile device 506 and/or the user interface(s) within the representation 624 in a second region of the display 501 different from the first region of the display 501. FIG. 8J is a transition from FIG. 8I in response to the input 824 to move the representation 624 of the mobile device 506 and/or the user interface(s) within the representation 624 from the first region of the display 501 to a second region of the display 501. In response to the input 824, the computer system displays the representation 624 of the mobile device 506 and/or the user interface(s) within the representation 624 in a second region of the display 501 different from the first region of the display 501.

In some embodiments, movement of the representation 624 of the remote device 506 does not cause the session between the remote device 506 and the computer system 504 to pause and/or cease. For example, the remote device 506 remains available for interactions from the computer system 504 while the representation 624 of the remote device is moved and/or redisplayed in a different region of the display 501.

FIGS. 9A-9G illustrate example user interfaces for copying data from the remote device 506 to the computer system 506 via the representation 624 of the remote device 506 displayed on the computer system 504, in accordance with some embodiments.

In some embodiments, the computer system 504 detects one or more inputs, via the touch-sensitive surface 518, to drag-and-drop data between the computer system 504 and the remote device 506 via a user interface of an application installed on the remote device 506 and a user interface of an application installed on the computer system 504. The dragged-and-dropped data from the computer system 504 to the remote device 506 is stored on the remote device 506, and the data can be sent from the remote device 506 to a device other than the computer system 504 and/or the remote device 506. The dragged-and-dropped data from the remote device 506 to the computer system 504 is stored on the remote device 506, and the data can be sent from the computer system to a device other than the computer system 504 and/or the remote device 506.

FIG. 9A illustrates a user interface 900 of the email application generated by the email application installed on the computer system 504 for composing a new email and a user interface 901 of the messaging application generated by the messaging application installed on the remote device 506. The user interface 901 includes a message 904 with an image 906 that was received by the remote device 506. The computer system 504 displays the user interface 901 within the representation 624 of the remote device 506. In FIG. 9A, the computer system 504 detects, via the trackpad 518, an input 908 (e.g., a drag-and-drop input) to copy the image 906 from the remote device 506 to the computer system 504 via the user interface 901 of the messaging application installed on the remote device 506 to the user interface 900 of the email application installed on the computer system 504. In response to the input 908, the computer system 504 displays, on the display 501, a thumbnail 910 proximate to the pointer 630 as the pointer moves during the input 908.

FIG. 9B is a transition from FIG. 9A in response to the input 908 to copy the image 906 from the remote device 506 to the computer system 504 via the user interface 901 of the messaging application installed on the remote device 506 to the user interface 900 of the email application installed on the computer system 504. In response to the input 908, in FIG. 9B, the computer system 504 displays, on the display 501, a thumbnail 910 proximate to the pointer 630 as the pointer moves during the input 908. In FIG. 9B, the computer system detects, via the trackpad 518, the end of the input 908 to copy the image 906 from the remote device 506 to the computer system 504 via the user interface 901 of the messaging application installed on the remote device 506 to the user interface 900 of the email application installed on the computer system 504. In response to the end of the input 908, the computer system “drops” (e.g., copies) the image 906 from the remote device 506 to the computer system 504.

FIG. 9C is a transition from FIG. 9B in response to the end of the input 908 to copy the image 906 from the remote device 506 to the computer system 504 via the user interface 901 of the messaging application installed on the remote device 506 to the user interface 900 of the email application installed on the computer system 504. In response to the end of the input 908, the computer system 504 “drops” (e.g., copies) the image 906 from the remote device 506 to the computer system 504 as image 912. In some embodiments, the computer system 504 copies the image 906 from the messaging application installed on the remote device 506 to the email application installed on the computer system 504, via the respective user interfaces. For example, as shown in FIG. 9C, the image 906 is copied from the user interface 901 of the messaging application 901 to the user interface 900 of the email application. In this example, the image 906 of the messaging application is attached to the new email shown in the user interface 900 of the email application as image 912. In some embodiments, the image 912 is stored on the computer system 504. For example, when the new email is sent from the computer system 504 with the attached image 912, the image 912 is sent from the computer system 504 and not the remote device 506.

FIG. 9D illustrates a user interface 914 of the file explorer application generated by the file explorer application installed on the computer system 504 for viewing one or more files (e.g., file 920) stored on the computer system 504 and the user interface 901 of the messaging application generated by the messaging application installed on the remote device 506. The user interface 901 includes a content-entry field 816. The computer system 504 displays the user interface 901 within the representation 624 of the remote device 506. In FIG. 9D, the computer system 504 detects, via the trackpad 518, an input 918 (e.g., a drag-and-drop input) to copy the file 920 from the computer system 504 to the remote device 506 via the user interface 914 of the file explorer application installed on the computer system 504. In response to the input 918, the computer system 504 displays, on the display 501, a thumbnail 922 proximate to the pointer 630 as the pointer moves during the input 918.

FIG. 9E is a transition from FIG. 9D in response to the 918 to copy the file 920 from the computer system 504 to the remote device 506 via the user interface 914 of the file explorer application installed on the computer system 504. In response to the input 918, the computer system 504 displays, on the display 501, a thumbnail 922 proximate to the pointer 630 as the pointer moves during the input 918. In FIG. 9E, the computer system 504 detects, via the trackpad 518, the end of the input 918 to copy the file 920 from the computer system 504 to the remote device 506 via the user interface 914 of the file explorer application installed on the computer system 504 to the user interface 901 of the messages application installed on the remote device 506. In response to the end of the input 918, the computer system “drops” (e.g., copies) the file 920 from the computer system 504 to the remote device 506.

FIG. 9F is a transition from FIG. 9E in response to the end of the input to copy the file 920 from the computer system 504 to the remote device 506 via the user interface 914 of the file explorer application installed on the computer system 504 to the user interface 901 of the messages application installed on the remote device 506. In response to the end of the input 918, the computer system 504 “drops” (e.g., copies) the file 920 from the computer system 504 to the remote device 506 as a message with an attached file 924. In some embodiments, the file 920 is copied to the messages application installed on the remote device 506 when the end of the drag-and-drop gesture is received while the pointer 630 is positioned or directed at the content-entry field 816 of the user interface 901 of the messages application installed on the remote device 506. For example, the file 920 is copied from the computer system 504 to the remote device 506 when the pointer 630 (and the thumbnail 922) is positioned or directed at the content-entry field 816 when the computer system 504 detects the end of the drag-and drop gesture 918. In FIG. 9F, the computer system 504 detects, via the trackpad 518, an input 926 (e.g., a tap input) to select the affordance 928 to send the message with the attached file 924 from the remote device 506 to another device (e.g., a device other than the remote device 506 and/or the computer system 504). In response to the input 926 selecting the affordance 928, the messages application installed on the remote device 506 sends the message with the attached file 924.

FIG. 9G is a transition from FIG. 9F in response to the input 926 to select the affordance 928. In response to the input 926 selecting the affordance 928, the messages application installed on the remote device 506 sends the message with the attached file 924.

FIGS. 10A-10F illustrate example user interfaces for interacting with the remote device 506 via the representation 624 of the remote device 506 while the remote device 506 is performing standby functionality (e.g., the remote device 506 is in a standby mode), in accordance with some embodiments.

In some embodiments, the remote device 506 is paired and available for interactions from the computer system 504 while concurrently performing standby functions and available for input, via the touch-sensitive display 507 to control the standby functions at the remote device 506. For example, a user can cause the remote device 506 to change which standby functions are displayed on the touch-sensitive display 507 of the remote device 506 while the remote device 506 remains available for interactions with applications installed on the remote device via a user interface of the application displayed on the computer system 504.

FIG. 10A illustrates the remote device 506 in a standby mode while paired with the first device 504. In some embodiments, the remote device displays a standby user interface 1001 concurrently with the computer system 504 displaying a different user interface generated by the remote device 506. For example, in FIG. 10A, the remote device displays, on the touch-sensitive display 507, a user interface 1001 of the standby mode and the computer system 504 displays, on the display 501, the home-screen user interface 672 of the remote device 506, where the home-screen user interface 672 is generated by the remote device 506.

In some embodiments, the remote device 506 enters the standby mode when the remote device 506 satisfies one or more criteria (e.g., charging criteria, device orientation criteria, or other criteria). For example, the remote device 506 enters the standby mode when the remote device 506 is charging (e.g., receiving power from a wall charger or a battery bank) and the remote device 506 is in a landscape orientation. In some embodiments, while the remote device 506 is in a standby mode, information about the remote device and/or one or more applications installed on the remote device 506 can be displayed on the touch-sensitive display 507 of the remote device 506. The information includes at least one or more widgets, one or more photos (e.g., a photo slideshow and/or photo backgrounds), and/or one or more clocks (e.g., local time and/or other times of interest) can be displayed. For example, in FIG. 10A, the remote device 506 displays, on the touch-sensitive display 507, a clock 1000 with a photo background 1002, where the clock 1000 and the photo background 1002 are generated by the remote device 506.

In FIG. 10A, the remote device 506 detects, via the touch-sensitive display 507, an input 1004 (e.g., a swipe input) to cause the remote device 506 to display different information in the user interface 1001 of the standby mode. In response to the swipe input 1004, the remote device 506 displays, on the touch-sensitive display 507, a to-do widget 1006 and a weather widget 1008.

FIG. 10B is a transition from FIG. 10A in response to the swipe input 1004 to cause the remote device 506 to display different information in the user interface 1001 of the standby mode. In response to the swipe input 1004, the remote device 506 displays, on the touch-sensitive display 507, the to-do list widget 1006 and the weather widget 1008. In some embodiments, the to-do list widget 1006 is generated by a to-do list application installed on the remote device 506, and the weather widget 1008 is generated by a weather application installed on the remote device 506. In some embodiments, the user can interact with the to-do list widget 1006 to select and/or deselect items in the to-do list. For example, the user can select “Send report to Kim” at the to-do list widget 1006, and the associated to-do list application will update the associated to-do list entry as “completed.” In FIG. 10B, the remote device 506 detects, via the touch-sensitive display 507, an input 1010 (e.g., a swipe input) to cause the remote device 506 to display different information in the user interface 1001 of the standby mode. In response to the input 1010, the remote device 506 displays, on the touch-sensitive display 507, a stopwatch widget 1012 in place of the weather widget 1006.

FIG. 10C is a transition from FIG. 10B in response to the input 1010 to cause the remote device 506 to display different information in the user interface 1001 of the standby mode. In response to the input 1010, the remote device 506 displays, on the touch-sensitive display 507, a stopwatch widget 1012 in place of the weather widget 1006. In FIG. 10C, the computer system 504 detects, via the trackpad 518, an input 1014 (e.g., a tap input) to select the messaging application icon 806 generated by the messaging application installed on the remote device 506. In response to the input 1014 selecting the messaging application icon 806, the remote device 506 launches (e.g., opens and/or executes) the messaging application, and the computer system 504 displays the user interface of a list of conversations of the messaging application.

FIG. 10D is a transition from FIG. 10C in response to the input 1014 to select the messaging application icon 806 generated by the messaging application installed on the remote device 506. In response to the input 1014 selecting the messaging application icon 806, the remote device 506 launches (e.g., opens and/or executes) the messaging application, and the computer system 504 displays the user interface 833 of a list of conversations of the messaging application. In some embodiments, user interaction with the user interface 833 of a list of conversations of the messaging application via inputs detected at the trackpad 518 do not cause the standby mode to cease. For example, interactions with the virtual representation 624 of the remote device 506 and/or the user interface 833 of the list of conversations of the messaging application can occur while the standby mode of the remote device 506 is ongoing (e.g., the remote device 506 continues to display information associated with the standby mode).

FIG. 10E is similar in many aspects to FIG. 10D, except the remote device 506 is now in an unlocking process. In some embodiments, the remote device 506 enters the unlocking process because the remote device 506 no longer satisfies the conditions to be in standby mode (e.g., the remote device 506 is no longer in a landscape orientation. In FIG. 10E, while performing the unlocking process, a facial identification prompt 1018 is displayed at the remote device 506. The representation 624 of the remote device 506 and the user interface 833 of the messaging application installed on the remote device continue to be displayed by the computer system 504 on the display 501 during the unlocking process. FIG. 10F is a transition from FIG. 10D in response to a facial identification input that meets unlocking criteria. In some embodiments, in response to the remote device 506 being unlocked, the session between the computer system 504 and the remote device 506 is paused (e.g., the pausing process is described in further detail to FIG. 6G).

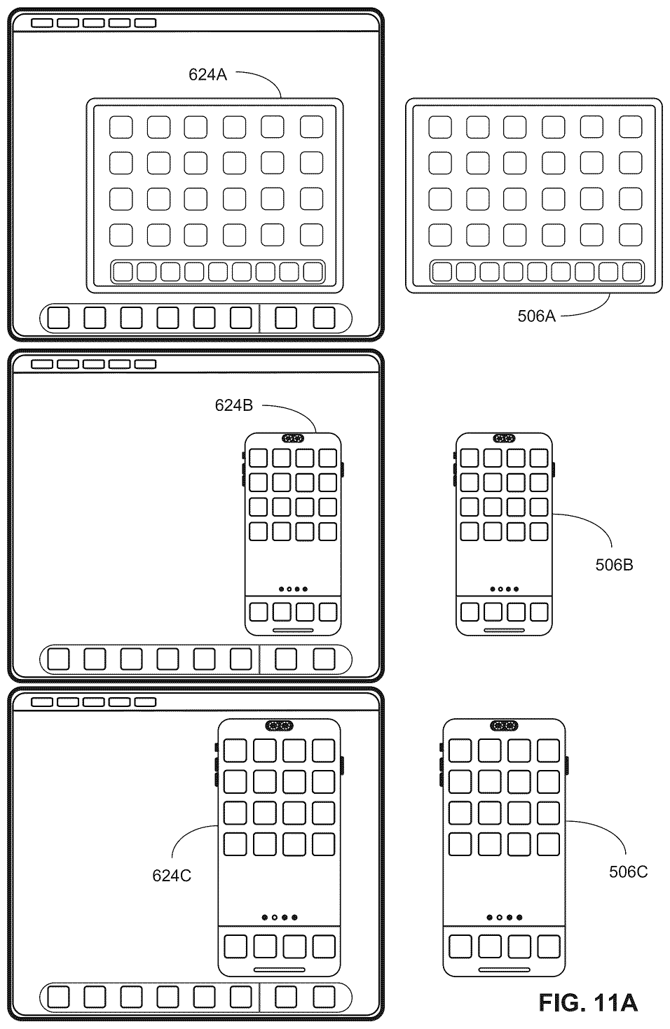

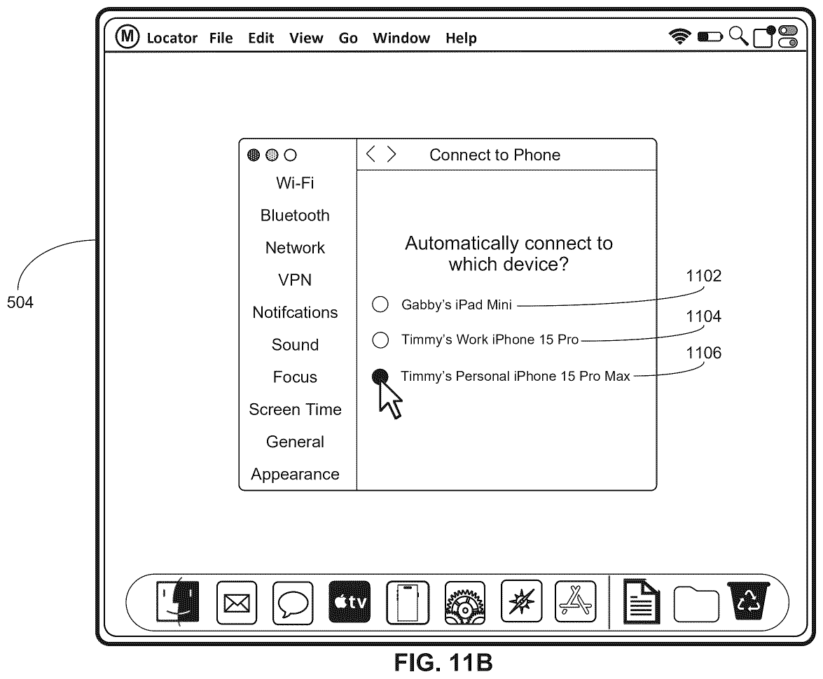

FIGS. 11A-11B illustrate example user interfaces for selecting which remote device of a plurality of remote devices to automatically pair to the computer system 504, in accordance with some embodiments.

In some embodiments, a plurality of remote devices are paired with the computer system 504, and each remote device can have different physical dimensions (e.g., size, shape, aspect ratio, or other physical dimensions). The dimensions of the representation of a respective remote device corresponds with the physical dimensions of the respective remote device. In some embodiments, the user selects which remote device of the plurality of remote devices to automatically pair with the computer system 504 such that the selected and paired remote device is available for operations from the computer system 504.

FIG. 11A illustrates different configurations the remote device 506. In some embodiments, the size of the representation matches the physical size of the second device. The size of the representation may be fixed (e.g., not adjustable by the user) to provide a unified user experience, or the size of the representation may be user adjustable.

In some embodiments, the physical size of various remote device (e.g., small remote device 506B, medium remote device 506C, and/or large remote device 506A) are different. For example, the physical size of the large remote device 506A is larger than the physical size of the medium remote device 506B, which is in turn larger than the small remote device 506B. The size of the representations of the respective various remote devices (e.g., small remote device 506B, medium remote device 506C, and/or large remote device 506A) are also different. For example, the size of the large representation 624A is larger than the medium representation 624C that corresponds with the medium remote device e 506C, which is in turn larger than the small representation 624B that corresponds with the small remote device 506B.

FIG. 11B illustrates a user interface 1100 to select which remote device from a plurality of remote devices to automatically pair to the computer system 504. The plurality of remote devices can include “Gabby's iPad Mini” (herein after referred to as the family remote device) 1102, “Timmy's Work iPhone 15 Pro” (herein after referred to as the work remote device) 1104, and/or “Timmy's Personal iPhone 15 Pro Max” (herein after referred to as the personal remote device) 1106. As shown in FIG. 11B, the personal remote device 1106 is selected as the device that is automatically paired when the computer system 504 is within range. For example, because the personal remote device is selected for automatic pairing, the personal remote device automatically paired with the computer system 504 even when the family remote device 1102 and/or the work remote device 1104 are also within the proximity range 500 of the computer system 504.

In some embodiments, the family remote device 1102, the work remote device 1104, and/or the personal remote device 1106 are pairable with the computer system 504 because those devices are connected to the same user account and/or the same family user account.

FIGS. 12A-12D illustrate example user interfaces for interacting with a secure application of the remote device via the representation of the remote device at the computer system and authentication hardware of the computer system, in accordance with some embodiments.

FIG. 12A illustrates the computer system 504 displaying, on the display 501 and within the representation 624 of the remote device 506, the home-screen user interface 672 generated by the remote device 506. In FIG. 12A, the home-screen user interface 672 includes one or more icons associated with one or more applications that can be executed on the remote device 506. For example, the home-screen user interface 672 includes an icon to launch a password manager at the remote device 506. In FIG. 12A the computer system 504 detects, via the trackpad 518, an input 1200 (e.g., a tap input) to select the password manager application icon 1202. In response to the input 1200 selecting the password manager application icon 1202, the computer system 504 displays a user interface 1203 of the locked password manager within the representation 624 and an authentication prompt 1204 requesting an authentication input from the user (e.g., biometrics including fingerprint and/or facial recognition, a password, passcode, and/or any other forms of authentication information). FIG. 12B is a transition from FIG. 12A in response to the input 1200 to select the password manager application icon 1202. In response to the input 1200 selecting the password manager application icon 1202, the computer system 504 displays a user interface 1203 of the locked password manager within the representation 624 and an authentication prompt 1204 requesting an authentication input from the user (e.g., biometrics including fingerprint and/or facial recognition, a password, passcode, and/or any other forms of authentication information). In some embodiments, as shown in FIG. 12B, the authentication prompt includes a passcode affordance 1206 that, when selected, allows the user to enter a passcode associated with the remote device 506 instead of providing biometrics to authenticate, and the authentication prompt includes an affordance 1208 to exit or abort the authentication process. In some embodiments, the passcode is entered via the keyboard 1211 of the computer system 504 or via the trackpad 518 of the computer system 504 (e.g., via an on-screen keyboard or a user interface for unlocking the remote device 506 displayed within the representation 624).

FIG. 12C is similar in many aspects to FIG. 12B, except that in FIG. 12C, the computer system detects, via a biometric sensor 1205 of the computer system 504, an authentication input 1210. In FIG. 12C, the computer system 504 detects, via the biometric sensor 1205 of the computer system 504, an authentication input 1210. In response to the authentication input 1210 meeting authentication criteria (e.g., the authentication input 1210 matches an authorized authentication input stored on the computer system 504 and/or the remote device 506), the remote device 506 unlocks the password manager application, and the computer system 504 displays a user interface of the unlocked password manager application generated by the password manager application installed on the remote device. FIG. 12D is a transition from FIG. 12C, in response to the authentication input 1210. In response to the authentication input 1210 meeting authentication criteria (e.g., the authentication input 1210 matches an authorized authentication input stored on the computer system 504 and/or the remote device 506), the remote device 506 unlocks the password manager application, and the computer system 504 displays a user interface of the unlocked password manager application generated by the password manager application installed on the remote device. In some embodiments, as shown in FIG. 12D, the computer system 504 displays a user interface 1212 of the unlocked password manager so the user can access the contents of the password manager application (e.g., stored usernames and associated passwords).

FIGS. 13A-13C illustrate example user interfaces for interacting with the remote device 506 via the representation 624 of the remote device 506 displayed on the computer system 504 while the remote device 506 is providing video captured by the remote device 506 to the computer system 504, in accordance with some embodiments.

FIG. 13A illustrates the remote device 506 capturing video 1300, via one or more cameras, that is transmitted to the computer system 504. The captured video 1300 is displayed on the display 501 of the computer system 504. In some embodiments, the captured video 1300 is displayed instead of video captured by a webcam associated with the computer system 504 (e.g., an integrated webcam or a connected external webcam). For example, the captured video 1300 can be broadcast in a video conference via a video conferencing application. In some embodiments, the video captured by the one or more cameras of the remote device 506 may be higher quality (e.g., higher resolution, better contrast, better color capture, etc.). In some embodiments, the remote device 506 can be repositioned to better capture video 1300, in contrast to a webcam associated with the computer system 504 (e.g., an integrated webcam of the computer system 504 cannot be repositioned independent of the position of the computer system 504). In FIG. 13A, the computer system 504 detects, via the trackpad 518, an input 1302 (e.g., a tap input) to select the remote device icon 508. In response to the input 1302 selecting the remote device icon 508, the computer system displays the representation 624 of the remote device 506, and/or the computer system 504 displays the home-screen user interface 672 on the display 501.

FIG. 13B is a transition from FIG. 13A in response to the input 1302 to select the remote device icon 508. In response to the input 1302 selecting the remote device icon 508, the computer system displays the representation 624 of the remote device 506, and/or the computer system 504 displays the home-screen user interface 672 on the display 501. In some embodiments, launching the virtual representation 624 does not interrupt the video 1300 that is captured via the remote device 506. Stated another way, the virtual representation 624 (and interactions associated with the virtual representations 624 to control the remote device 506) can occur concurrently with the remote device 506 capturing and transmitting the video 1300 to the computer system 504. In FIG. 13B, the computer system 504 detects, via the trackpad 518, an input 1304 (e.g., a tap input) to select the messaging application icon 806. In response to the input 1304 selecting the messaging application icon 806, the computer system 504 displays the user interface 833 of the messaging application generated by the messaging application installed on the remote device 506.

FIG. 13C is a transition from FIG. 13B in response to the input 1304 to select the messaging application icon 806. In response to the input 1304 selecting the messaging application icon 806, the computer system 504 displays the user interface 833 of the messaging application generated by the messaging application installed on the remote device 506. In some embodiments, the messaging application and the capturing and transmitting the video 1300 are executing concurrently at the remote device 506. Interactions with the representation 624 (e.g., interactions that cause performance of functionalities at the remote device 506) do not cause the remote device 506 to cease capturing and transmitting the video 1300 from the remote device 506 to the computer system 504.

FIGS. 14A-14F are flow diagrams illustrating method 1400 of integrated interactions with multiple devices, in accordance with some embodiments. Some operations in method 1400 are, optionally, combined and/or the order of some operations is, optionally, changed.

As described herein, method 1400 provides improved techniques for integrated interaction with multiple devices. In particular, a remote electronic device that is paired with a computer system and, optionally, within a proximity range from the computer system, can be interacted with via the computer system. Inputs detected by input device(s) of the computer system can cause the remote electronic device to generate user interfaces that are displayed on a display of the computer system, optionally, in a shape and/or form that corresponds to a screen of the remote electronic device. For example, a user can interact with the remote device via inputs directed at user interfaces of the remote device displayed via a display of the computer system. Further, notifications generated by applications installed on the remote device (e.g., optionally not installed on the computer system), are automatically displayed via the display of the computer system (e.g., in accordance with a determination that the remote electronic device and the computer system are paired and optionally within a proximity range from each other), and can be interacted with (e.g., opened on the display of the computer system) via inputs directed at the notifications of the remote device displayed on the display of the computer system. Interacting with user interfaces of a remote device (e.g., generated by a remote device or applications installed on the remote device) via inputs detected by input devices of the computer system and directed at user interfaces of the remote device displayed via the display of the computer system, provides an integrated user experience by reducing the need for a user to switch between multiple devices, thereby reducing the time and/or number of inputs needed to perform operations on the remote device (e.g., open notifications, respond to messages, and interact with user interfaces that are optionally not available on the computer system).

Method 1400 is performed at a computer system (e.g., the first computer system and/or the second computer system). For example, the computer system includes the computer system 504 and/or the remote device 506 of FIG. 6B. In some embodiments, the computer system includes a display generation component (e.g., a heads-up display, a head-mounted display (HMD), a display, a touchscreen, a projector, a tablet, a smartphone, and other displays) and one or more input devices (e.g., one or more optical sensors, eye-tracking devices, touch-screens, keyboards, mouses, and/or other input devices). In some embodiments, a first computer system (e.g., computer system 504) is in communication with a second computer system (e.g., a remote device or a remote computer system such as remote device 504). In some embodiments, the display is a touch-screen display and the touch-sensitive surface is on or integrated with the display. In some embodiments, the display is separate from the touch-sensitive surface.

In some embodiments, the second computer system is a smartphone, a tablet, or other computer system that is different from the first computer system and optionally has a form factor that is different from the first computer system, where having a form factor includes having a different sized housing, different shaped housing, and/or different input mechanisms). In some embodiments, the second computer system connects to the first computer system wirelessly (e.g., via Bluetooth or other protocol for wireless connection). In some embodiments, the second computer system connects to the first computer system automatically in accordance with a determination that the second computer system is in proximity of the first computer system (e.g., within a proximity threshold or perimeter).

The first computer system (e.g., computer system 504) displays (1402), via the display generation component of the first computer system, a plurality of notifications (e.g., notifications 610, 614, 616, 618, 620, as shown in FIG. 6B), wherein a first notification (e.g., notification 610 and/or notification 614, as shown in FIG. 6B) of the plurality of notifications is generated (1404) by a first application installed on the first computer system (e.g., the first application is available to launch, open, or otherwise run on the first computer system), and a second notification of the plurality of notifications is generated (1406) by a second application (e.g., the second application is different or the same as the first application) installed on the second computer system (e.g., the second application is available to launch, open, or otherwise run on the second computer system). In some embodiments, the second application is not installed on the first computer system. In some embodiments, the plurality of notifications are displayed automatically (e.g., without additional user input). For example, the first notification is displayed and/or generated in response an event occurring in the first application, and/or the second notification is displayed and/or generated in response to an event occurring in the second application. In some embodiments, the plurality of notifications, including the first notification and the second notification are push notifications. While displaying the second notification, the first computer system detects (1408), via the one or more input devices, an input (e.g., a tap input, a press input, a swipe input, and/or other selection input) to select the second notification of the plurality of notifications. In response to detecting the input selecting the second notification of the plurality of notifications, the first computer system displays (1410), via the display generation component of the first computer system, a user interface that is generated by the second computer system (e.g., the remote computer system). In some embodiments, the user interface includes content related to the second notification.

In some embodiments, an input detected via input device(s) of a first computer causes a second computer system to generate a user interface. For example, in response to the tap input 700 selecting the remote device icon 508, the computer system 504 displays the representation 624 of the remote device 506 and the home-screen user interface 672 of the remote device 506, where the home-screen user interface is generated by the remote device 506, as described in relation to FIG. 7A. Further, the user interface generated by the second computer system is displayed on a display of the first computer system and optionally in a shape that corresponds to a screen of the second computer system. In some embodiments, notifications generated by two or more different computer systems (e.g., the first and second computer systems) are displayed on a display of a single computer system. For example, notifications from multiple computer system are displayed on a display of, and are accessible from, a single computer system, e.g., the first computer system. In some embodiments, some of the notifications, including the second notification, are generated by applications installed on the second computer system that are not installed on the first computer system. In some embodiments, the second computer system has input device(s) that are separate and/or different from the one or more input devices of the first computer system, and a user can interact with the user interface generated by the second computer system using the input device(s) of the first computer system. For example, the computer system 504 displays, via the display 501, the notification 610 generated by the food delivery application installed on the remote device 506, the notification 614 generated by a messaging application installed on the remote device 506 concurrently with a notification 616 generated by an email application installed on the computer system 504, a notification 618 generated by a photo editor application installed on the computer system 504, and a notification 620 generated by a video streaming application installed on the computer system 504, as described in relation to FIG. 6A.

In some embodiments, the second computer system is locked (e.g., authentication is required before the user interface generated by the second computer system can be displayed on the second computer system, or access is otherwise restricted) in accordance with a determination that the user interface generated by the second computer system is displayed via the display generation component of the first computer system.

In some embodiments, the user interface that is generated by the second computer system and is displayed on a display of the first computer system is a mirror image of a user interface that would be displayed on the second computer system in response to selection of the same notification displayed on a display of the second computer system. For example, content that would be displayed on the second computer system in the user interface generated by the second computer system is displayed on the first computer system. For example, the user interface 638 of the food delivery application installed on the remote device 506 displayed via the remote device 506 is the same as the user interface 626 of the food delivery application installed on the remote device 506 displayed via the computer system 504, as described in relation to FIGS. 6F and 6G.

In some embodiments, the remote (e.g., second) computer system is available for interaction from the first computer system in accordance with a determination that the remote computer system and the first computer system are located within a proximity threshold or perimeter from each other. For example, the remote devices 506A, 506B, and 506C are located within the proximity range 500 (e.g., within the proximity threshold distance ‘D’ 502) of the computer system 504, as described in relation to FIG. 5A. In some embodiments, the remote computer system is paired to the first computer system during an initial pairing or onboarding process. For example, the remote device 506 and the computer system 504 perform the pairing and/or configuration process (e.g., the process described at least in part by the configuration user interface 514 for pairing the remote device 506 with the computer system 504), as described in relation to FIGS. 5B-5I. For example, the remote computer system and the first computer system are initially linked to allow communications between the remote and first computer systems. For example, Bluetooth can be used to link the remote computer system to the first computer system (e.g., a laptop and a mobile phone can be lined via Bluetooth). In some embodiments, whether the remote computer system is available for interaction from the first computer system without additional authentication as soon as the remote computer system and the first computer system meet proximity criteria (e.g., criteria established by the communication protocol), can be a matter of user configuration (e.g., via a setting user interface). In some embodiments, authentication can be required only once during the pairing process between the first computer system and the remote computer system. For example, the configuration option 548 for automatic authentication causes the computer system to automatically connect the computer system 504 to the remote device 506, when the remote device 506 is within the proximity range 500 of computer system 504, and without requesting authentication from the user (e.g., authentication is only required once during the pairing process between the remote device 506 and the computer system 504), as described in relation to FIG. 5H.

In some embodiments, the first computer system has (e.g., includes or is in communication with) a display generation component (e.g., a display device such as a head-mounted display (HMD), a display, a projector, a touch-sensitive display (also known as a “touch screen” or “touch-screen display”), or other device or component that presents visual content to a user, for example, on or in the display generation component itself or produced from the display generation component and visible elsewhere. In some embodiments, the first computer system and/or the second computer system has a touchpad. In some embodiments, the first computer system is a head-mounted display device that provides three-dimensional virtual and/or augmented reality experiences, and the device has one or more cameras that detect air gestures performed using a user's hand, and, optionally, the gaze of the user. In some embodiments, the first computer system and/or the second computer system has a touch-sensitive display (also known as a “touch screen” or “touch-screen display”). As described herein, although examples below are given with touch-gestures on a touch-screen display or a trackpad, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures). For example, selection inputs that are described as touch inputs on a touch-sensitive surface can be performed using air gestures (e.g., a pinch, a long pinch, a pinch and drag, a double pinch, and/or other direct or indirect air gestures). In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input. Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, operations performed with respect to method 1400 are discussed with reference to operations performed on a device with a touch-sensitive display system. In such embodiments, a focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display. However, analogous operations are, optionally, performed on a device with a display and a separate touch-sensitive surface in response to detecting the contacts on the touch-sensitive surface while displaying the user interfaces on the display, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

In some embodiments, the user interface that is generated by the second computer system includes (1412) a representation of a user interface of the second application that includes content related to the second notification. For example, if the second application that is installed on the second computer system is a food delivery application, and the second notification corresponds to an event that has occurred in the food delivery application, the user interface that is generated by the second computer systems corresponds to a user interface of the food delivery application and optionally includes information about the event that has occurred in the food delivery application (e.g., an estimated time of arrival of a delivery, a location of a respective delivery vehicle on a map, a name and phone of a contact for the delivery, and/or other information related to the second notification). For example, the user interface 626 of the food delivery application is generated by the food delivery application installed on the remote device 506, and includes content related to the food delivery application, such as a status indicator 627 indicating that the food delivery order is on the way with an estimated time of arrival and a map view 634 of the current location of the food delivery order 631, as described in relation to FIGS. 6C-6F. Notifications associated with different applications would display different content of the respective applications. For example, the user interface 652 of the messaging application generated by the messaging application installed on the remote device 506 displays different content than the user interface 626 of the food delivery application, as described in relation to FIGS. 6C-6F and 8D-8I. The user interface including the representation of the second application and contents related to the second notification reduces the time and/or number of inputs needed to perform operations on the remote device (e.g., open notifications, respond to messages, and interact with user interfaces that are optionally not available on the computer system).

In some embodiments, the user interface that is generated by the second computer system is displayed, (1414) via the display generation component of the first computer system, in a representation that has a shape that (e.g., generally) corresponds to (e.g., is proportional to and/or has a same aspect ratio) a respective shape of the second computer system (or corresponds to a respective shape of a screen of the second computer system). In some embodiments, the plurality of notifications, including the first notification and/or the second notification are displayed in a first region of the display generation component of the first computer system (e.g., a dedicated region such as notification center in a desktop application), and a representation of the user interface generated by the second computer system (e.g., the remote computer system) is displayed in a second region of the display generation component of the first computer system. For example, the second region corresponds to a representation of the screen of the second computer system (e.g., a representation of a smartphone's display including displayed content). In some embodiments, the second region corresponds to a shape and/or size of a housing or a display of the second computer system. For example, the large representation 624A of the large remote device 506A is displayed with a shape and/or aspect ratio that corresponds to the physical shape and/or aspect ratio of the large remote device 506A, and the small representation 624B of the small remote device 506B is displayed with a shape and/or aspect ratio that corresponds to the physical shape and/or aspect ratio of the small remote device 506A, where the shape and/or aspect ratio of the small representation 624B and the small remote device 506B are different from the large representation 624A and the large remote device 506A, as described in relation to FIG. 11A. In some embodiments, the second region is overlayed over other content displayed by the display generation component (e.g., display) of the first computer system. For example, if the second computer system corresponds to a smartphone and the first computer system is a laptop, a representation of the user interface generated by the smartphone (e.g., in response to selection of the second notification) is displayed in a region on a display of the laptop, where the region has a shape, size, and/or form that corresponds to the shape, size, and/or form of the smartphone or a screen of the smartphone. In another example, if the second computer is a tablet and the first computer system is a desktop computer, the representation of the user interface generated by the tablet (e.g., in response to selection of the second notification) is displayed in a region on a display of the desktop computer, where the region has a shape, size, and/or form that corresponds to the shape, size, and/or form of the tablet or a screen of the tablet. In some embodiments, if the second computer is a laptop, and the first computer is a mixed reality headset, a representation of the user interface generated by the laptop (e.g., in response to selection of the second notification) is displayed in a region in a mixed reality three-dimensional environment displayed via a display generation component of the mixed reality headset, where the region has a shape, size, and/or form that corresponds to the shape, size, and/or form of the laptop or the screen of the laptop. In some embodiments, the representation of the screen or user interface of the second computer system (e.g., the remote computer system) is displayed as an overlay on the display of the first computer system. Displaying the user interface in a representation that corresponds to the respective shape of the second computer system improves operation of the remote device because the generated user interface is the same when displayed on the remote device as on the computer system (e.g., the remote device only needs to generate the user interface once for a known resolution, aspect ratio, etc.), and reduces the time and/or number of inputs needed to perform operations on the remote device because the user can perform similar gestures on the computer system as on the remote device (e.g., navigating to a previous user interface, the home screen user interface, the application-switcher user interface, etc.).

In some embodiments, the representation in which the user interface is displayed in has (1416) a size that corresponds to a respective size of the second computer system. In some embodiments, displaying, via the display generation component of the first computer system, the user interface that is generated by the second computer system includes, in accordance with a determination that the second computer system (e.g., the remote device) has a first shape (and a first screen size), the representation in which the user interface is displayed in has the first shape (and, optionally, the first screen size). In some embodiments, displaying, via the display generation component of the first computer system, the user interface that is generated by the second computer system in accordance with a determination that the second computer system (e.g., the remote device) has a second shape different from the first shape (and, optionally, a second screen size different from the first screen size), the representation in which the user interface is displayed in has the second shape (and, optionally, the second screen size). For example, the computer system 504 displays different sized representations of differently sized remote devices, such as the small representation 624B of the small remote device 506B, the medium representation 624C of the medium remote device 506C, and/or the large representation 624A of the large remote device 506A, as described in relation to FIG. 11A. Displaying the user interface in a representation that corresponds to the respective size of the second computer system improves operation of the remote device because the generated user interface is the same when displayed on the remote device as on the computer system (e.g., the remote device only needs to generate the user interface once for a known resolution, aspect ratio, etc.), and reduces the time and/or number of inputs needed to perform operations on the remote device because the user can perform similar gestures on the computer system as on the remote device (e.g., navigating to a previous user interface, the home screen user interface, the application-switcher user interface, etc.).

In some embodiments, the first computer system detects (1418), via the one or more input devices, a second input (e.g., a navigation input, an input selecting a control of the second application, or other input that causes the second computer system to navigate to additional content of the second application) directed to the user interface of the second application that is generated by the second computer system and is displayed via the display generation component of the first computer system, and in response to detecting the second input, the first computer system displays additional content of the second application (e.g., content of the second application that includes more information related to the second notification, and/or content of the second application that is not related to the second notification). For example, in response to input(s), the user interface 652 of the messaging application displays an on-screen keyboard 820, and a suggested word 824 displayed in the on-screen keyboard 820 is entered and sent as a message 828, as described in FIGS. 8D-8G. In another example, in response to an input selecting the affordance 832 (e.g., a back affordance), the user interface 652 navigates to a different user interface 833 of the list of conversations of the messaging application, where the user interface 833 displays different content than the user interface 652, as described in relation to FIGS. 8H-8I. T In some embodiments, the second input is performed with the one or more input devices of the first computer system (e.g., a trackpad on a laptop corresponding to the first computer system), and the second input is mapped to a corresponding input that can be recognized by input device(s) of the second computer system (e.g., a touch input on a touch-sensitive display of a smartphone, a tablet, a watch, and/or other device with a touch-sensitive display). In some embodiments, the navigation input corresponds to a swipe gesture, a flick gesture, a touch gesture (e.g., a tap, a tap and hold) selecting a control, and/or other touch-based gesture. In some embodiments, the navigation input corresponds to an air gesture such as a pinch, a long pinch, a pinch followed by a drag, and/or other gesture that uses user's attention to determine a respective user interface element (e.g., in a mixed reality three-dimensional environment) that has input focus. Navigating within a user interface of the remote device displayed on the computer system reduces the time and/or number of inputs needed to perform operations on the remote device (e.g., the user does not need to provide inputs at the remote device, and instead can provide those inputs at the computer system to cause the operation to be performed on the remote device).

In some embodiments, the user interface generated by the second computer system is a first user interface. In some embodiments, while displaying, via the displaying generation component of the first computer system, the first user interface generated by the second computer system, the first computer system detects (1420), via the one or more input devices, a third input (e.g., a navigation input to navigate to a different user interface, such as a home user interface, a system generated user interface, and/or an application user interface generated by the second computer system). In some embodiments, the third input is performed with the one or more input devices of the first computer system, and the third input is mapped to a corresponding input or gesture that can be recognized by input device(s) of the second computer system (e.g., a touch input that can be detected by a touch-sensitive screen of the second computer system). In response to detecting the third input, the first computer system displays, via the display generation component of the first computer system, a second user interface generated by the second computer system (e.g., a home user interface, a system generated user interface, a multi-tasking user interface, an application user interface), wherein the second user interface generated by the second computer system is different from the first user interface generated by the second computer system. In some embodiments, in response to an input using the input device(s) of the second computer system, a user can navigate to other user interfaces generated by the second computer system. In some embodiments, the second user interface generated by the second computer system (e.g., the remote device) corresponds to a user interface of the second application or to a user interface of other applications. In some embodiments, the second user interface generated by the second computer system corresponds to a system user interface. For example, the second user interface includes the home-screen user interface 672, the application switcher user interface 680, and/or the quick settings user interface 686, as described in relation to FIGS. 6O, 6R, and 6U.

In some embodiments, the third input is an input that is directed to the user interface generated by the computer system (e.g., directed to controls and/or content in the user interface). In accordance with a determination that the third input is directed to the user interface generated by the second computer system, the third input causes the first computer system to navigate to another user interface of the second application, also generated by the second computer system and displayed via the display generation component of the first computer system. For example, the third input includes the input 830 selecting the affordance 832 (e.g., a back affordance) to navigate to a different user interface 833 of the messaging application, as described in FIGS. 8H-8I. In another example, the third input includes the input 657 to navigate to the home-screen user interface 672, the input 676 to navigate to the application switcher user interface 680, and/or the input 684 to navigate to the quick-settings user interface 686, as described in relation to FIGS. 6N-6O, 6Q-6R, and 6T-6U. In some embodiments, the third input is an input that is not necessarily directed to the user interface generated by the computer system. In some embodiments, the third input is mapped to a respective input that is recognizable and detectable by the second computer system, including, but not limited to, a left-to-right swipe that causes the computer system to display a user interface of a camera application while the second computer system is locked (e.g., or other input that causes an application to be displayed while the second computer system is locked); a swipe up from a bottom to a middle of a screen of the second computer system and hold to display a multi-tasking user interface (e.g., or other input to display a multi-tasking user interface, such as an application switcher); a swipe down from top-right edge to cause display of system user interface for controlling multiple system-wide functions and/or modes of the compute system (e.g. enabling/disabling airplane more, wi-fi, Bluetooth, screen mirroring, lock screen, screen rotation, and/or other functions); and/or other inputs recognizable on the second computer system (e.g., optionally not detectable by the input devices of the first computer system and/or recognizable by the first computer system). Navigating to other user interfaces of the remote device displayed on the computer system reduces the time and/or number of inputs needed to perform operations on the remote device (e.g., the user does not need to provide inputs at the remote device, and instead can provide those inputs at the computer system to cause the operation to be performed on the remote device).

In some embodiments, the first user interface generated by the second computer system corresponds (1422) to a user interface of the second application, and the second user interface generated by the second computer system corresponds to a user interface of a third application installed on the second computer system, wherein the third application is different from the second application.

In some embodiments, the third application is also different from the first application. For example, the first application is a food delivery application, the second application is a messaging application, and the third application is a password manager application, where the three applications are installed on the remote device 506 and not the computer system 504, as described in relation to FIGS. 6C-6H, 8D-8I, and 12A-12D. In some embodiments, the third application is not installed on the first computer system. In some embodiments, the third input is directed to the first user interface of the second application system and causes the computer system to display a respective user interface of an application that is different from the second application. For example, if the third input is directed to a link displayed in a user interface of an email application, the first computer system navigates from the user interface of the email application to a user interface of a web browser application, where the user interface of the browser application is generated by the second computer system and displayed via the display generation component of the first computer system. In some embodiments, the second user interface generated by the second computer system corresponds to an interface of an application that is different from the first application, such as a camera application installed on the second computer system, and/or other user interface generated by the second computer system (e.g., as opposed to the first computer system).

In some embodiments, the third input is not directed to the user interface generated by the second application, and can be directed to one or more controls generated by the second computer system that are used to control and open user interface generated by the second computer system. Navigating to other user interfaces of other applications installed on the remote device and displayed on the computer system reduces the time and/or number of inputs needed to perform operations on the remote device (e.g., the user does not need to provide inputs at the remote device, and instead can provide those inputs at the computer system to cause the operation to be performed on the remote device).

In some embodiments, the second user interface generated by the second computer system corresponds (1424) to a system user interface generated by the second computer system. In some embodiments, the second user interface generated by the second computer system corresponds to a system user interface, including a home screen user interface of the second computer system, a system user interface of the second computer system (e.g., a control center, an application library user interface), a multi-tasking user interface of the second computer system (e.g., user interface for switching between applications and/or switching between multiple instances of the same or different applications), and/or other user interface generated by the second computer system (e.g., as opposed to the first computer system). For example, the second user interface generated by the second computer system (e.g., a system user interface) includes the home-screen user interface 672, the application switcher user interface 680, and/or the quick-settings user interface 686, as described in relation to FIGS. 6O, 6R, and 6U. Navigating to system user interfaces of the remote device displayed on the computer system reduces the time and/or number of inputs needed to perform operations on the remote device (e.g., the user does not need to provide inputs at the remote device, and instead can provide those inputs at the computer system to cause the operation to be performed on the remote device).

In some embodiments, the first user interface generated by the second computer system (e.g., the remote device) includes (1426) a portion (e.g., a panel, a bar, a chrome, a system control portion, and/or other user interface section with user interface controls) that includes one or more controls for accessing one or more system user interfaces of the second computer system. In some embodiments, the one or more controls includes a control for accessing a home user interface, a control for accessing a control center user interface, a control for accessing an application library user interface, a control for accessing a multi-tasking user interface, a control for accessing a search user interface, a control for accessing one or more application-specific functions (e.g., a camera application or an artificial intelligence assistant), and/or one or more other controls for accessing other user interfaces of the second computer system. For example, the controls include the back affordance 658, the home affordance 660, the application switcher affordance 662, the quick-settings affordance 664, and the close affordance 666, as described in relation to FIG. 6M.

In some embodiments, the portion of the first user interface that includes the one or more controls for accessing the one or more system user interfaces of the second computer system is displayed in response to the input selecting the second notification. In some embodiments, the portion of the first user interface that includes the one or more controls for accessing the one or more system user interfaces of the second computer system is generated in response to the input selecting the second notification and displayed in response to an additional user input (e.g., a hover or selection input over another portion of the first user interface displayed via the display generation component of the first computer system).

In some embodiments, if the first user interface generated by the second computer system is displayed on a display of the first computer system (e.g., in response to an input selecting a notification displayed on the display of the first computer system), the portion of the first user interface that includes the one or more controls for accessing the one or more system user interfaces of the second computer system is not generated and/or is not displayed on the display of the first computer system. For example, a gesture or a touch input via one or more input devices of the second computer system is used to access the same functionality available via selection of the one or more controls in the portion of the first user interface. For example, the gesture or touch input to access the same functionality available via selection of the one or more controls in the portion of the first user interface includes the input 657 to navigate to the home-screen user interface 672, the input 676 to navigate to the application switcher user interface 680, and/or the input 684 to navigate to the quick-settings user interface 686, as described in relation to FIGS. 6N-6O, 6Q-6R, and 6T-6U. Displaying controls in a portion of the user interface for accessing system user interfaces of the remote device reduces the time and/or number of inputs needed to perform operations on the remote device (e.g., direct navigation to the system user interface associated with the corresponding control).

In some embodiments, the first computer system displays (1428), via the display generation component of the first computer system, a user interface object (e.g., a remote device icon) for opening a user interface generated by a remote device, wherein the user interface object represents the second computer system and the user interface object, when selected, displays a respective user interface generated by the second computer system. In some embodiments, the user interface object for opening a user interface generated by a remote device (e.g., launching) the remote device corresponds to an icon representing the remote device. In some embodiments, the user interface object (e.g., a remote device icon) is displayed in a system user interface. For example, an icon representing the remote device is displayed in a dock (e.g., an interface for launching and/or interacting with applications installed on the first computer system). In some embodiments, the user interface object for opening a user interface generated by the remote device includes a representation of a form factor of the remote device. For example, if the remote device is a smartphone, the user interface object includes a representation of the smartphone with a corresponding shape, form, and/or proportions of the smartphone. In another example, if the remote device is a laptop, the user interface object includes a representation of the laptop with a corresponding shape, form, and/or proportions of the laptop. In another example, if the remote device is a smartwatch, the user interface object includes a representation of the smartwatch with a corresponding shape, form, and/or proportions of the smartwatch. For example, the computer system 504 displays, on the display 501, the remote device icon 508 in the dock 503, as described in FIGS. 5A-5B and 6A.

In some embodiments, the user interface object for opening a user interface generated by the remote device is persistently displayed in the system user interface of the first computer system. In some embodiments, the user interface object appears in the system user interface of the first computer system in accordance with a determination that a remote device is within a proximity threshold of the first computer system. Displaying the remote device icon in a dock of the computer system that is selectable to cause the computer system to display a user interface of the remote device reduces the time and/or number of inputs needed to perform operations on the remote device.

In some embodiments, in accordance with a determination that the second computer system is located outside a proximity threshold (e.g., at a distance greater than a maximum threshold distance away from the first device), the first computer system displays (1430) the user interface object for opening a user interface generated by a remote device with a first appearance, and in accordance with a determination that the second computer system is located within the proximity threshold (e.g., at a distance less than a maximum threshold distance away from the first device), the first computer system displays the user interface object for opening a user interface generated by a remote device with a second appearance. In some embodiments, the first appearance provides a visual indication that the remote device is inactive (e.g., not accessible via the first computer system), and the second appearance provides a visual indication that the remote device is active (e.g., accessible via the first computer system). In some embodiments, the user interface object for launching the remote device changes color, translucency, size, and/or other visual characteristic. For example, the computer system 504 displays, on the display 501, the dark version of the remote device icon 508 in the dock 503, as described in relation to FIGS. 5A-5G and 6A. Displaying the remote device icon with different appearances (e.g., a dark version when the remote device is not available and a light version when the remote device is available) provides feedback about the state of the remote device and its availability for interactions from the computer system.

In some embodiments, displaying, via the display generation component of the first computer system, the plurality of notifications includes, in accordance with a determination that notifications of the plurality of notifications are generated by one or more applications installed on the second computer system, the first computer system displays (1432) respective visual indications that the notifications corresponds to notifications that are generated by a device different from the first computer system (e.g., the second computer system or another computer system), wherein the second notification includes a visual indication that the second notification corresponds to a notification that is generated by the second computer system (e.g., a corresponding notification is optionally first generated on the second computer and instructions to generated the same notification on the first computer system are received at the first computer system from the second computer system). In some embodiments, the visual indication corresponds to a badge displayed in or near the second notification indicating that the second notification corresponds to a notification that is generated by a phone (e.g., as opposed to the laptop that corresponds to the first computer system). For example, the notifications generated by the remote device 506 and/or generated by an application installed on the remote device 506 (e.g., the food delivery application, the messaging application, etc.) include a visual indicator 622 to identify that those notifications are generated by the remote device 506 and/or applications installed on the remote device 506, as described in relation to FIG. 6A. Displaying the visual indicator (e.g., a badge) with the generated by the remote device (and/or by applications installed on the remote device) and displayed by the computer system provides feedback about the source of the notification (e.g., from the remote device or the computer system).

In some embodiments, the user interface generated by the second computer system is a second user interface, and the first computer system displays (1434), via the display generation component of the first computer system, a first user interface that is generated by the first computer system. The first computer system detects, via the input devices of the first computer system, an input requesting to drag and drop content (e.g., a touch and drag, if touch-based, or a pinch and drag, if an air gesture) between the first user interface generated by the first computer system and the second user interface generated by the second computer system. In response to the first computer system detecting the input, in accordance with a determination that the input requests to drag and drop a first content item (e.g., a photo, a file, a document, a song, and/or other content that is selectable and can be dragged and dropped) from the first user interface to the second user interface, the first computer system and/or the second computer system copies the first content item displayed in the first user interface generated by the first computer system to the second user interface generated by the second computer system (e.g., a copy of the first content item is displayed in the second user interface and can be selected and interacted with in the second user interface), and in accordance with a determination that the input requests to drag and drop a second content item (e.g., a photo, a file, a document, a song, and/or other content that is selectable and can be dragged and dropped) from the second user interface to the first user interface, the first computer system and/or the second computer system copies the second content item displayed in the second user interface generated by the second computer system to the first user interface generated by the first computer system (e.g., a copy of the first content item is displayed in the first user interface and can be selected and interacted with in the first user interface). In some embodiments, the first user interface generated by the first computer corresponds to a home user interface or a desktop user interface of the first computer system. In some embodiments, the first user interface generated by the first computer corresponds to an application user interface generated by an application installed on the first computer system. In some embodiments, the second user interface generated by the second computer system corresponds to an application user interface (e.g., user interface generated by the second application or other application installed on the second computer system), or to a system user interface generated by the second computer system. For example, in response to input(s), information (e.g., the image 904, the file 920, and/or other data) is copied from the remote device 506 (and/or an application installed on the remote device 506) via the representation 624 of the remote device 506 displayed on the computer system 504 to the computer system 504 (and/or an application installed on the computer system 504) and/or vice, as described in relation to FIGS. 9A-9G. Transferring data (e.g., images, files, etc.) between the remote device and the computer system via the user interface of the remote device displayed by the computer system reduces the time and/or number of inputs needed to perform operations on the remote device (e.g., the user does not need to provide inputs at both the remote device and the computer system to transfer data between the devices).

In some embodiments, the user interface generated by the second computer system is a second user interface, and the first computer system detects (1436), via the one or more input devices of the first computer system, a first input (e.g., a tap, a tap and hold, and/or other touch-based selection input, or a pinch, a long pinch, a double pinch, and/or other air gesture). In response to the first computer system detecting the first input, the computer system displays, via the display generation component of the first computer system, a respective user interface (e.g., user interface 626, as shown in FIG. 6D) generated by the second computer system, wherein the respective user interface includes a representation of a respective application installed on the second computer system (e.g., the remote computer system). In some embodiments, the first input is detected by input devices of the first computer system and the remote computer system responds to the first input. In some embodiments, in response to the first input detected via input device(s) of the first computer system, the respective application is launched, and the respective user interface of the respective application is displayed on a display of the first computer system (e.g., displayed in an overlay on the first computer system that represents a screen of the remote computer system). In some embodiments, launching an application includes starting an application that was not previously running (e.g., where the state of the application is optionally determined based on stored information with respect to running the application); opening and/or redisplaying an application that was previously running in the background (e.g., minimized or otherwise hidden); opening a new user interface of the application or a user interface from one or more already opened and visible user interfaces of the application; or, otherwise bringing a user interface of the application to a foreground.

In some embodiments, the first input is a selection input directed at a user interface element displayed in a user interface generated by the second computer system (e.g., the remote computer system), and displayed via the display of the first computer system. In some embodiments, the user interface element corresponds to an application icon, a notification, a link, and/or a user interface element that navigates to a user interface of an application that was previously not displayed. In some embodiments, the notification at which the selection input is directed is generated by applications installed on the second computer system and displayed via the display of the first computer system (e.g., outside the region displayed via the display of the computer system that corresponds to a representation of a display of the second computer system). For example, in response to input 1014 while the pointer 630 is directed at the messaging application icon 806 displayed by the computer system 504 in the home-screen user interface 672 of the remote device 506 generated by the remote device 506, the remote device launches the messaging application and the computer system displays, on the display 501, the user interface 833 of the messaging application, as described in relation to FIGS. 10C-10D. Displaying, via the computer system, a user interface of an application installed on the remote device reduces the time and/or number of inputs needed to perform operations on the remote device (e.g., displaying the user interface of the application installed on the remote device is in response to an input at the computer system instead of the remote device).

In some embodiments, the first input (e.g., detected via the one or more input devices of the first computer system) corresponds (1438) to a request to launch the respective application from the second computer system (e.g., the remote computer system). In some embodiments, the first input detected by input devices of the first computer system is directed to an application icon displayed on a home user interface generated by the remote computer system and displayed on a display of the first computer system. In some embodiments, the first input is directed to an application icon displayed in application library user interface of the second computer system, a search user interface of the second computer system, a dock panel of the second computer system, and/or other user interface from which applications installed on the remote computer system can be launched. For example, in response to input 1014 while the pointer 630 is directed at the messaging application icon 806 displayed by the computer system 504 in the home-screen user interface 672 of the remote device 506 generated by the remote device 506, the remote device launches the messaging application and the computer system displays, on the display 501, the user interface 833 of the messaging application, as described in relation to FIGS. 10C-10D. Selecting an application icon displayed in the user interface generated by the remote device and displayed by the computer system reduces the time and/or number of inputs needed to perform operations on the remote device (e.g., launching and/or executing an application installed on the remote device and/or displaying a user interface of the application).

In some embodiments, the first input (e.g., detected via the one or more input devices of the first computer system) corresponds (1440) to a selection of a search result displayed via the display generation component of the first computer system. In some embodiments, the search result is displayed in conjunction with other search results in response to a search input or search query provided by a user. For example, a search input provided in a search user interface generated by the second computer system and displayed via the display of the first computer system. In some embodiments, the search result is a respective application icon that corresponds to the respective application. For example, a respective application icon corresponding to the respective application is displayed in a search user interface in response to a search query, and the first input selects the respective application icon, thereby causing the second computer system to generate the respective user interface. For example, an input to select the password manager application icon 1202 can be a selection from one or more search results displayed by the computer system 504, as described in relation to FIG. 12A. Selecting an application icon displayed search results reduces the time and/or number of inputs needed to perform operations on the remote device (e.g., launching and/or executing an application installed on the remote device and/or displaying a user interface of the application).

In some embodiments, the second computer system (e.g., the remote computer system) is locked while the user interface generated by the second computer system is displayed via the display generation component of the first computer system, and the first computer system detects (1442), via the one or more input devices, a fourth input (e.g., a navigation input to navigate to a different user interface, such as a home user interface, a system generated user interface, and/or an application user interface generated by the second computer system). In response to the first computer system detecting the fourth input, while the second computer system is locked, the first computer system displays, via the display generation component of the first computer system, content in a fourth user interface generated by the second computer system (e.g., a home user interface, a system generated user interface, a multi-tasking user interface, an application user interface). In some embodiments, the fourth input corresponds to a swipe input (e.g., an edge swipe input), detected via a touch-sensitive surface of the first computer system, that causes the first computer system to display a home user interface of the second computer system. For example, swipe input 657 in FIG. 6N, detected via trackpad 518 of the computer system 504 causes the computer system 504 to display home-screen user interface 672 (generated by the remote device 506) in representation 624 of the remote device 506, via display 501 of computer system 504, as described in relation to FIGS. 6N-6O. In some embodiments, the fourth input corresponds to a selection input that selects a control that causes the first computer system to display a home user interface of the second computer system. For example, tap input 655 directed at home affordance 660 and detected via trackpad 518 of the computer system 504, causes the computer system 504 to display to display home-screen user interface 672 (generated by the remote device 506) in representation 624 of the remote device 506, via display 501 of computer system 504, as described in relation to FIGS. 6M and 6O. In some embodiments, the fourth input corresponds to a swipe-and-hold input (e.g., optionally another edge swipe input), detected via a touch-sensitive surface of the first computer system, that causes the first computer system to display a multi-tasking user interface of the second computer system. For example, swipe-and-hold input 676 in FIG. 6Q, detected via trackpad 518 of the computer system 504 causes the computer system 504 to display application switcher user interface 680 (generated by the remote device 506) in representation 624 of the remote device 506, via display 501 of computer system 504, as illustrated in relation to FIG. 6R. In some embodiments, the fourth input corresponds to a selection input that selects a control that causes the first computer system to display a multi-tasking user interface of the second computer system. For example, tap input 674 directed at application switcher affordance 662 and detected via trackpad 518 of the computer system 504, causes the computer system 504 to display to application switcher user interface 680 (generated by the remote device 506) in representation 624 of the remote device 506, via display 501 of computer system 504, as described in FIGS. 6P and 6R. In some embodiments, the fourth input corresponds to swipe input 684 (or tap input 630 directed at quick settings affordance 664) that cause the computer system 504 to display to quick settings user interface 686 (generated by the remote device 506) in representation 624 of the remote device 506, via display 501 of computer system 504, as described in relation to FIGS. 6S-6U.

In some embodiments, the fourth user interface is the same or different from the first or second user interfaces generated by the second computer system. In some embodiments, a user can interact with, and view content generated by the second computer system via the first computer system while the second computer system is locked. In some embodiments, the first computer system and the second computer system are associated (logged into or authenticated) with the same user account (e.g., when the fourth input is detected), such as the same cloud account or other user profile. Displaying content from the remote device while locked via the computer system reduces the time and/or number of inputs needed to perform operations on the remote device (e.g., displaying content of the remote device via the computer system) because the remote device does not need to be unlocked (e.g., the remote device is authenticated via the same user account).

In some embodiments, a session is established between the first computer system and the second computer system, and the second computer system detects (1444) an event that occurs with respect to the second computer system. In some embodiments, the event that occurs with respect to the second computer system includes a user input detected by the input device(s) of the second computer system. For example, an input to unlock the second computer system, an input to request display of a home screen user interface, an input to request display of a respective application user interface; and input selecting a notification displayed on a display of the second computer system. In some embodiments, the event that occurs with respect to the second computer system does not correspond to user input. In some embodiments, the event that occurs with respect to the second computer system includes displaying notifications (e.g., while the second computer system is locked or in standby mode); displaying widgets; displaying activities or session notifications, and/or other content that the second computer system generates and displays without user input. In some embodiments, the notifications and widgets are displayed over a wake screen, a locked screen, an ambient mode screen. In some embodiments, the event that occurs with respect to the second computer system is changing a state of the second computer system that corresponds to a standby or ambient mode (e.g., placing the second computer system on a stand, on a wireless charging device, and/or other placement of the second computer system that would cause the second computer system to enter a standby or ambient mode). In response to the event that occurs with respect to the second computer system, in accordance with a determination that the second computer system is used in a first manner (e.g., a home screen or an application user interface is displayed via the display of the second computer system), the first computer system and/or the second computer system pauses the session on the first computer system (e.g., causing the session to become inactive). In some embodiments, pausing the session on the first computer includes obscuring the user interface that is generated by the second computer system and is displayed via the display generation component of the first computer system. In some embodiments, in conjunction with pausing the session on the first computer, the session on the second computer changes state from inactive to active. For example, the session on the second computer is un-paused when the first session on the first computer is paused. In some embodiments, the user interface that was generated by the second computer system and displayed via the display generation component of the first computer system is displayed via the display generation component of the second computer system in conjunction with activating the session on the second computer system. For example, when the session is paused on the first computer system and the session is unpaused on the second computer system, a respective state of the user interface that was displayed by the first computer system is displayed by the second computer system (e.g., whatever content was generated by the second computer system and displayed on the first computer system prior pausing the session on the first computer system is displayed by the second computer system in accordance with a determination that the session is activated or unpaused on the second computer system). For example, when a user unlocks and gains access to the second computer system (e.g., by providing authentication information), the screen of the second computer system shows the same content from the second computer system that was displayed on the first computer system. For example, in response interactions detected at the remote device 506, the session between the computer system 504 and the remote device 506 is paused, as described in relation to FIGS. 5G-5J. When the remote device is used in a first manner, the session between the remote device and the computer system is paused, thereby improving security/privacy by pausing the session between the remote device and the computer system (e.g., pausing and/or ceasing to display the user interface of the remote device via the computer system and/or causing the remote device to be unavailable for interactions from the computer system).

In some embodiments, in response to the event that occurs with respect to the second computer system, in accordance with a determination that the second computer system is used in a second manner different from the first manner (e.g., when notifications, widgets, or other system-generated information is displayed via the display of the second computer system, or when the second computer system enters a standby mode), the first computer system and/or the second computer system maintains (1446) the session on the first computer system active (e.g., forgoing pausing the first session). In some embodiments, the session on the first computer system is maintained active even if the second computer system displays a wake screen (e.g., the wake screen has not been dismissed), displays a lock screen (e.g., if the second computer system has not been unlocked), or even if the second computer system is operating in a restricted use state, (e.g., viewing notifications, navigating between different views of the standby mode, interacting with a virtual assistant), in which even though a user is actively interacting with the second computer system the session on the first computer system remains active. For example, in response to interactions detected at the remote device 506 while in a standby mode, the session between the computer system 504 and the remote device 506 is not paused (e.g., the computer system 504 continues to display the representation 624 of the remote device 506, and the remote device 506 continues to perform standby functions in the standby mode), as described in relation to FIGS. 10A-10D. When the remote device is used in a second manner (e.g., standby mode), the session between the remote device and the computer system is maintained, thereby increasing the functionality of the remote device (e.g., the remote device can be used both in a standby mode and via the computer system).

In some embodiments, while a session is established between the first computer system and the second computer system (e.g., a session between the first computer system and the second computer system is active when a respective user interface generated by the second computer system (e.g., the remote device) is displayed via the display generation component of the first computer system), displays (1448), via a display generation component of the second computer system, a visual indication of the session between the first computer system and the second computer system (e.g., the visual indication indicates that the second computer system is being used (e.g., accessed) via the first computer system). In some embodiments, the visual indication corresponds to a persistent notification or other user interface object that indicates an ongoing activity (e.g., a badge, a pill, or other object) that is displayed via the display generation component of the first computer system. For example, while the second computer system is being used, accessed, or content of generated by the second computer system is being viewed via the first computer system, a visual indication is displayed on the display of the second computer system to provide visual feedback to a user that the second computer system is being used or accessed on another device. For example, the remote device 506 displays, on the touch sensitive display 507, the indication 606 that the remote device 506 is paired to and available for interactions from the computer system 504, as described in relation to FIG. 6B. Displaying the visual indicator (e.g., indicating that the remote device is paired to and available for interactions from the computer system) via the remote device provides feedback about the state of the remote device (e.g., that the computer system can interact with the remote device).

In some embodiments, the second computer system detects (1450), via the one or more input devices, a selection input directed to the visual indication of the session between the first computer system and the second computer system, and in response to detecting the selection input directed to the visual indication, the first computer system and/or the second computer system initiate a process for terminating the session between the first computer system and the second computer system. For example, a selection input (e.g., such as a tap input, a tap and hold, a press input, if gesture-based, or a pinch, a long pinch, a double pinch, if an air gesture, and/or other selection inputs) directed to indication 606 (e.g. illustrated in FIGS. 6H-6V) displayed on the touch-sensitive display 507 of the remote device 507, causes the remote device 507 to generate a user interface for terminating the session. For example, in FIG. 6V-6W, in response to the tap input 691 selecting the close affordance 666, the computer system 504 ceases to display the representation 624 of the remote device 506 and any user interface displayed within the representation 624. In some embodiments, in response to detecting the selection input directed to the visual indication, the session between the first computer system and the second computer system is terminated without additional user input. In some embodiments, in response to detecting the selection input directed to the visual indication, a user interface is displayed including a control for terminating the session that, when selected, causes the first computer system and/or the second computer system to terminate the session. Proving a selectable option (e.g., a selectable visual indicator on the remote device indicating that the remote device is accessible and/or being used on another computer system) on a display of the remote device for terminating an ongoing session between the remote device and the computer system, improves security, privacy and/or reduces the number of inputs and/or time needed to terminate a session between the remote device and the computer system (e.g., because the user can terminate the session from either the computer system or the remote device).

In some embodiments, the visual indication includes an identifier that corresponds to the first computer system (e.g., a name of the first computer system, a model of the first computer system, or other label that identifies the first computer system that can be user specified or system-generated).

In some embodiments, a respective session is established between the first computer system and the second computer system (e.g., the remote computer system or device), and the respective session is active on the first computer system and is paused on the second computer system. An input requesting to activate the respective session is detected (1452) on the second computer system (e.g., an input to display a home user interface, an input to display application user interface, an input to unlock the device, an input to terminate the respective session between the first computer system and the second computer system, and/or other input that interacts with the second computer system via input devices of the second computer system). In response to detection of the input requesting to activate the respective session on the second computer system, in accordance with a determination that the respective session had a first state when the input requesting to active the respective session on the second computer system was detected, wherein, in the first state, first content is displayed via the display generation component of the first computer system in a first respective user interface generated by the second computer system, the first content in the first respective user interface is displayed via the display generated component of the second computer system, and in accordance with a determination that the respective session had a second state when the input requesting to active the respective session on the second computer system was detected, wherein, in the second state, second content is displayed via the display generation component of the first computer system in a second respective user interface generated by the second computer system, the second content in the second respective user interface (e.g., second respective user interface is the same or different from the first respective user interface) is displayed via the display generated component of the second computer system. In some embodiments, at least one of the first computer system and/or the second computer system holds (e.g., stores in memory) respective current state information with respect to the respective session established between the first computer system and second computer system and/or saves information about the session history. In some embodiments, after and/or while the respective session between the first and second computer system has been established, activity and interaction history with the second computer system via the first computer system is preserved, such that upon unpausing the respective session on the second compute system, the second computer system is in the state that was preserved during the respective session. For example, whatever content was displayed in the user interface generated by the second computer system and displayed via the display generation component of the first computer system, the same content is displayed in the same user interface via the display of the second computer system in accordance with a determination that the respective session is activated or unpaused on the second computer system. Preserving a state of the remote during an ongoing session between the remote device and the computer system enables the remote device, upon reactivating of a session on the remote device, to redisplay on the remote whatever content was displayed in the user interface generated by the remote device and displayed via the display generation component of the computer system, thereby synchronizing a state between the computer system and the remote device and displaying up-to-date content on the remote device. Displaying up-to-date content on the remote device reduces the amount of time and/or number of inputs needed to interact with two devices (e.g., because the user does not need to perform the same actions on the remote device that were performed on the computer system).

In some embodiments, the input (e.g., detected on the second computer system) requesting to activate the respective session on the second computer system corresponds to a gesture that unlocks the second computer systems (e.g., swipe input 636 in FIGS. 6F-6G). In another example, the input (e.g., detected on the second computer system) requesting to activate the respective session on the second computer system corresponds a selection input (e.g., such as a tap or a tap and hold) directed to a notification displayed on the display of the second computer system (e.g., a tap input directed to notification 612 in FIG. 6F). In another example, the input (e.g., detected on the second computer system) requesting to activate the respective session on the second computer system corresponds a selection input (e.g., such as a tap input, a tap and hold, a press input, if gesture-based, or a pinch, a long pinch, a double pinch, if an air gesture, and/or other selection inputs) directed to indication 606 (e.g. illustrated in FIGS. 6H-6V) displayed on the touch-sensitive display 507 of the remote device 507, causes the remote device 507 to generate a user interface for terminating the section.

In some embodiments, before the respective session is established between the first computer system and the second computer system, a third respective user interface corresponding a third respective application is displayed (1454) via the display generation component of the second computer system, and after the respective session is established and in response to detection of the input requesting to activate the respective session on the second computer system, the respective session on the second computer system is unpaused and a respective user interface corresponding to a fourth respective application different from the third respective application is displayed in the first respective user interface or in the second respective user interface. In some embodiments, when the second computer system is unlocked after interaction with the second computer system via the first computer system during the respective session, the second computer system displays a different application user interface than the user interface displayed before establishing the respective session. For example, the map portion 629 of the user interface 626 of the food delivery app is zoomed in in response to the input 632 detected at the computer system 504, and the remote device, when unlocked, displays the user interface 638 of the food delivery application that includes the zoomed-in version of the map view, as described in relation to FIGS. 6D-6G. Preserving a state of the remote device during an ongoing session between the remote device and the computer system, enables the remote device, upon reactivating of a session on the remote device, to redisplay on the remote whatever content was displayed in the user interface generated by the remote device and displayed via the display generation component of the computer system. Synchronizing a state of the remote between the computer system and the remote device enables the remote device to display up-to-date content on the remote device, including displaying a different application user interface than the user interface displayed on the remote device before establishing the respective session, thereby reducing the amount of time and/or number of inputs needed to interact with two devices (e.g., because the user does not need to perform the same actions on the remote device that were performed on the computer system).

In some embodiments, before the respective session is established between the first computer system and the second computer system, a first plurality of applications open on the second computer system are associated (1456) with a first order (e.g., established based on order in which the first plurality of application have been used or opened), and after the respective session is established and in response to detecting a request to display a multitasking user interface on the second computer system via the display generation component of the second computer system, at least partially user interfaces of a second plurality of applications (e.g., the second plurality of application is the same or different from the first plurality of applications depending on whether previously unopened applications are opened or previously opened application are closed on the second computer system via the first computer system) is displayed in the multitasking user interface via the display generation component of the second computer system in accordance with a second order different from the first order. For example, the application-switcher user interface 680 can display a first plurality of applications prior to the remote device 506 receiving interactions from the computer system 504 and the application switcher user interface 680 can display a second plurality of applications (e.g., a different set of applications and/or a different order of the same applications) after the remote device 506 receives interactions from the computer system 504, as described in relation to FIG. 6R. Preserving a state of the remote device during an ongoing session between the remote device and the computer system, enables synchronization of a state of the remote device between the computer system and the remote device, thereby enabling the remote device to display up-to-date content upon reactivating the respective session on the remote device, including updated content in an application switcher user interface that reflects an order of user interaction on the computer system with different applications. Synchronizing a state of the remote between the computer system and the remote device, reduces the amount of time and/or number of inputs needed to interact with two devices (e.g., because the user does not need to perform the same actions on the remote device that were performed on the computer system).

In some embodiments, the first computer system and/or the second computer system detects (1458) a request to enable (e.g., set up or configure) a sharing mode (e.g., the sharing mode corresponds to a mode in which the second computer system can be interacted with remotely or wirelessly via the first computer system) between the first computer system and the second computer system (e.g., a request to establish a session or pair the first computer system with the second computer system). In response to detecting the request to enable the sharing mode, in accordance with a determination that the sharing mode has been authorized (e.g., because authentication has already been provided during a pairing process or because a setting is enabled to forgo requiring subsequent authentication, and/or or because authentication has been received on the first computer system and/or the second computer system), enable the sharing mode without requesting authentication. In accordance with a determination that the sharing mode has not been authorized, displaying an authentication request via one or more display generation components of the second computer system (e.g., a user interface for entering a passcode or other prompt for entering biometric input, such as fingerprints or face recognition) and/or via the one or more display generation components of the first computer system. In some embodiments, after successful or valid authentication, access to the second computer system via the first computer system is enabled. For example, authentication requests on the first and/or second computer systems are described in relation to FIGS. 5B-5I (e.g., request for a passcode on the remote device 506 in FIG. 5D, or prompt 526 on the display 501 of the computer system 504 requesting permission or confirmation from the user that the remote device 506 can be connected to the computer system 504 in FIG. 5E). Requiring authentication on the remote to pair the remote device with the computer system, improves security and/or privacy (e.g., by reducing unwanted pairing and/or unauthorized access to the remote device via the computer system).

In some embodiments, while a configuration of a sharing mode between the first computer system and the second computer system is being performed (e.g., during an initial configuration of the sharing mode or pairing, such as when the first and second computer systems are paired for the first time or when no prior configuration between the first and second system has been saved), an authentication prompt is displayed (1460) via one or more display generation components of the second computer system, wherein a valid authentication is required in order for the first computer system to access information from the second computer system. In some embodiments, during an initial setup of the sharing mode between the first computer system and the second computer system, an authentication is required on at least one of the first computer system and/or the second computer system. In some embodiments, such authentication may not be required during subsequent pairing of the first computer system and the second computer system (e.g., when the first and second computer system are within a proximity threshold, access to the second computer system from the first computer system is automatically enabled without further input once the sharing mode between the first computer system and the second computer system has been configured). For example, the configuration option 548 for automatic authentication causes the computer system to automatically connect the computer system 504 to the remote device 506, when the remote device 506 is within the proximity range 500 of computer system 504, and without requesting authentication from the user (e.g., authentication is only required once during the pairing process between the remote device 506 and the computer system 504), as described in relation to FIG. 5H. Requiring authentication on the computer system to pair the remote device with the computer system, improves security and/or privacy (e.g., by reducing unwanted pairing and/or unauthorized access to the remote device via the computer system).

In some embodiments, the second computer system detects (1462), via one or more input devices of the second computer system, a request to display a respective user interface on a respective display of the second computer system (e.g., the request to display respective user interface on the respective display of the second computer system include an input to unlock the second computer system, an input selecting a notification displayed on the respective display of the second computer system, an input ending a session active between the first and second computer system, and/or other interaction inputs with the second computer system). In response to detecting the request to display the respective user interface, in accordance with a determination that authentication is required according to a setting (e.g., configuration option 550 is selected in FIG. 5H), the first computer system and/or the second computer system prompts a user to provide authentication on the first computer system and/or the second computer system, and in accordance with a determination that authentication is not required according to the setting (e.g., configuration option 548 for automatic authentication is selected in FIG. 5H), the first computer system and/or the second computer system forgo prompting the user to provide authentication. In some embodiments, in accordance with a determination that the first computer system prompts the user to provide authentication and in accordance with a determination that the authentication is successful, the respective user interface is displayed on the respective display of the second computer system. In some embodiments, in accordance with a determination that the first computer system prompts the user to provide authentication and in accordance with a determination that the authentication is unsuccessful, the respective user interface is not displayed on the respective display of the second computer system. For example, the password manager application installed on the remote device 506 requires an authentication input (e.g., authentication input 1210 detected via the biometric sensor 1205 of the computer system 504) before the computer system 504 displays the user interface 1212 of the unlocked password manager application generated by the password manager application installed on the remote device 506, as described in relation to FIGS. 12A-12D. Requiring authentication during pairing of the remote device to the computer system, if a setting is not enabled, and forging requiring authentication, if the setting is enabled, reduces the amount of time and/or number of inputs needed to access remote device via the computer system.

In some embodiments, displaying, via the display generation component of the first computer system, the user interface that is generated by the second computer system, includes, in accordance with a determination that the second computer system has a first physical shape (e.g., shape and/or size of the housing of the second compute system or a display of the second computer system), the first computer system displays (1464) the user interface in a first respective representation that has a shape that correspond to (e.g., is proportional to and/or has a same aspect ratio) the first physical shape of the second computer system (e.g., based on a shape of a display of the second computer system and/or a shape of a housing of the second computer system), and in accordance with a determination that the second computer system has a second physical shape (e.g., shape and/or size of the housing of the second compute system or a display of the second computer system), the first computer system displays the user interface in a second respective representation that has a shape that correspond to (e.g., is proportional to and/or has a same aspect ratio) the second physical shape of the second computer system (e.g., based on a shape of a display of the second computer system and/or a shape of a housing of the second computer system). For example, the large representation 624A of the large remote device 506A is displayed with a shape and/or aspect ratio that corresponds to the physical shape and/or aspect ratio of the large remote device 506A, and the small representation 624B of the small remote device 506B is displayed with a shape and/or aspect ratio that corresponds to the physical shape and/or aspect ratio of the small remote device 506A, where the shape and/or aspect ratio of the small representation 624B and the small remote device 506B are different from the large representation 624A and the large remote device 506A, as described in relation to FIG. 11A. Displaying the user interface generated by the remote device in a representation on the computer system that corresponds to the respective size and/or shape of the remote device, reduces the time and/or number of inputs needed to perform operations on the remote device via the computer system because the user can perform similar gestures on the computer system as on the remote device (e.g., navigating to a previous user interface, displaying a home screen user interface, displaying an application-switcher user interface, and/or other interactions with the remote device via the computer system).

It should be understood that the particular order in which the operations in FIGS. 14A-14F have been described is merely an example and is not intended to indicate that the described order is the only order in which the operations could be performed. One of ordinary skill in the art would recognize various ways to reorder the operations described herein.

The operations described above with reference to FIGS. 14A-14F are, optionally, implemented by components depicted in FIGS. 1A-1B. For example, display operation 1402, detect operation 1408, and display operation 1410 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a first computer system with a display generation component and one or more input devices, where the first computer system is in communication with a second computer system:
displaying, via the display generation component of the first computer system, a plurality of notifications, wherein:
a first notification of the plurality of notifications is generated by a first application installed on the first computer system, and
a second notification of the plurality of notifications is generated by a second application installed on the second computer system;
while displaying the second notification, detecting, via the one or more input devices, an input selecting the second notification of the plurality of notifications; and
in response to detecting the input selecting the second notification of the plurality of notifications:
displaying, via the display generation component of the first computer system, a user interface that is generated by the second computer system.

2. The method of claim 1, wherein the user interface that is generated by the second computer system includes a representation of a user interface of the second application that includes content related to the second notification.

3. The method of claim 1, wherein the user interface that is generated by the second computer system is displayed, via the display generation component of the first computer system, in a representation that has a shape that corresponds to a respective shape of the second computer system.

4. The method of claim 3, wherein the representation in which the user interface is displayed in has a size that corresponds to a respective size of the second computer system.

5. The method of claim 1, further comprising:
detecting, via the one or more input devices, a second input directed to the user interface of the second application that is generated by the second computer system and is displayed via the display generation component of the first computer system; and
in response to detecting the second input, displaying additional content of the second application.

6. The method of claim 1, wherein:
the user interface generated by the second computer system is a first user interface, and the method includes:
while displaying, via the displaying generation component of the first computer system, the first user interface generated by the second computer system, detecting, via the one or more input devices, a third input; and
in response to detecting the third input:
displaying, via the display generation component of the first computer system, a second user interface generated by the second computer system, wherein the second user interface generated by the second computer system is different from the first user interface generated by the second computer system.

7. The method of claim 6, wherein:
the first user interface generated by the second computer system corresponds to a user interface of the second application, and
the second user interface generated by the second computer system corresponds to a user interface of a third application installed on the second computer system, wherein the third application is different from the second application.

8. The method of claim 6, wherein:
the second user interface generated by the second computer system corresponds to a system user interface generated by the second computer system.

9. The method of claim 6, wherein:
the first user interface generated by the second computer system includes a portion that includes one or more controls for accessing one or more system user interfaces of the second computer system.

10. The method of claim 1, including:
displaying, via the display generation component of the first computer system, a user interface object for opening a user interface generated by a remote device, wherein the user interface object represents the second computer system and the user interface object, when selected, displays a respective user interface generated by the second computer system.

11. The method of claim 10, including:
in accordance with a determination that the second computer system is located outside a proximity threshold, displaying the user interface object for opening a user interface generated by a remote device with a first appearance; and
in accordance with a determination that the second computer system is located within the proximity threshold, displaying the user interface object for opening a user interface generated by a remote device with a second appearance.

12. The method of claim 1, wherein displaying, via the display generation component of the first computer system, the plurality of notifications includes:
in accordance with a determination that notifications of the plurality of notifications are generated by one or more applications installed on the second computer system, displaying respective visual indications that the notifications corresponds to notifications that are generated by a device different from the first computer system, wherein the second notification includes a visual indication that the second notification corresponds to a notification that is generated by the second computer system.

13. The method of claim 1, wherein the user interface generated by the second computer system is a second user interface, and the method includes:
displaying, via the display generation component of the first computer system, a first user interface that is generated by the first computer system;
detecting, via the input devices of the first computer system, an input requesting to drag and drop content between the first user interface generated by the first computer system and the second user interface generated by the second computer system; and
in response to detecting the input:
in accordance with a determination that the input requests to drag and drop a first content item from the first user interface to the second user interface, copying the first content item displayed in the first user interface generated by the first computer system to the second user interface generated by the second computer system; and
in accordance with a determination that the input requests to drag and drop a second content item from the second user interface to the first user interface, copying the second content item displayed in the second user interface generated by the second computer system to the first user interface generated by the first computer system.

14. The method of claim 1, wherein:
the user interface generated by the second computer system is a second user interface, and the method includes:
detecting, via the one or more input devices of the first computer system, a first input; and
in response to detecting the first input:
displaying, via the display generation component of the first computer system, a respective user interface generated by the second computer system, wherein the respective user interface includes a representation of a respective application installed on the second computer system.

15. The method of claim 14, wherein:
the first input corresponds to a request to launch the respective application from the second computer system.

16. The method of claim 14, wherein:
the first input corresponds to a selection of a search result displayed via the display generation component of the first computer system.

17. The method of claim 1, wherein:
the second computer system is locked while the user interface generated by the second computer system is displayed via the display generation component of the first computer system; and the method includes:
detecting, via the one or more input devices, a fourth input; and
in response to detecting the fourth input:
while the second computer system is locked, displaying, via the display generation component of the first computer system, content in a fourth user interface generated by the second computer system.

18. The method of claim 1, wherein a session is established between the first computer system and the second computer system, and the method includes:
detecting an event that occurs with respect to the second computer system; and
in response to the event that occurs with respect to the second computer system:
in accordance with a determination that the second computer system is used in a first manner, pausing the session on the first computer system.

19. The method of claim 18, including:
in response to the event that occurs with respect to the second computer system:
in accordance with a determination that the second computer system is used in a second manner different from the first manner, maintaining the session on the first computer system active.

20. The method of claim 1, including:
while a session is established between the first computer system and the second computer system displaying, via a display generation component of the second computer system, a visual indication of the session between the first computer system and the second computer system.

21. The method of claim 20, including:
detecting, via the one or more input devices, a selection input directed to the visual indication of the session between the first computer system and the second computer system; and
in response to detecting the selection input directed to the visual indication, initiating a process for terminating the session between the first computer system and the second computer system.

22. The method of claim 1, wherein:
a respective session is established between the first computer system and the second computer system;
the respective session is active on the first computer system and is paused on the second computer system;
an input requesting to activate the respective session is detected on the second computer system;
in response to detection of the input requesting to activate the respective session on the second computer system:
in accordance with a determination that the respective session had a first state when the input requesting to active the respective session on the second computer system was detected, wherein, in the first state, first content is displayed via the display generation component of the first computer system in a first respective user interface generated by the second computer system:
the first content in the first respective user interface is displayed via the display generated component of the second computer system; and
in accordance with a determination that the respective session had a second state when the input requesting to active the respective session on the second computer system was detected, wherein, in the second state, second content is displayed via the display generation component of the first computer system in a second respective user interface generated by the second computer system:
the second content in the second respective user interface is displayed via the display generated component of the second computer system.

23. The method of claim 22, wherein:
before the respective session is established between the first computer system and the second computer system, a third respective user interface corresponding a third respective application is displayed via the display generation component of the second computer system; and
after the respective session is established and in response to detection of the input requesting to activate the respective session on the second computer system:
the respective session on the second computer system is unpaused and a respective user interface corresponding to a fourth respective application different from the third respective application is displayed in the first respective user interface or in the second respective user interface.

24. The method of claim 22, wherein:
before the respective session is established between the first computer system and the second computer system, a first plurality of applications open on the second computer system are associated with a first order; and
after the respective session is established and in response to detecting a request to display a multitasking user interface on the second computer system via the display generation component of the second computer system:
at least partially user interfaces of a second plurality of applications is displayed in the multitasking user interface via the display generation component of the second computer system in accordance with a second order different from the first order.

25. The method of claim 1, including:
detecting a request to enable a sharing mode between the first computer system and the second computer system; and
in response to detecting the request to enable the sharing mode:
in accordance with a determination that the sharing mode has been authorized, enabling the sharing mode without requesting authentication; and
in accordance with a determination that the sharing mode has not been authorized, displaying an authentication request via one or more display generation components of the second computer system and/or via the one or more display generation components of the first computer system.

26. The method of claim 1, wherein:
while a configuration of a sharing mode between the first computer system and the second computer system is being performed, an authentication prompt is displayed via one or more display generation components of the second computer system, wherein a valid authentication is required in order for the first computer system to access information from the second computer system.

27. The method of claim 1, including:
detecting, via one or more input devices of the second computer system, a request to display a respective user interface on a respective display of the second computer system;
in response to detecting the request to display the respective user interface:
in accordance with a determination that authentication is required according to a setting, prompting a user to provide authentication on the first computer system and/or the second computer system; and
in accordance with a determination that authentication is not required according to the setting, forgoing prompting the user to provide authentication.

28. The method of claim 1, wherein:
displaying, via the display generation component of the first computer system, the user interface that is generated by the second computer system, includes:
in accordance with a determination that the second computer system has a first physical shape, displaying the user interface in a first respective representation that has a shape that correspond to the first physical shape of the second computer system; and
in accordance with a determination that the second computer system has a second physical shape, displaying the user interface in a second respective representation that has a shape that correspond to the second physical shape of the second computer system.

29. A first computer system that is in communication with a second computer system, the first computer system comprising:
a display generation component;
one or more input devices;
one or more processors; and
memory storing one or more programs, wherein the one or more programs are configured to be executed by the one or more processors, the one or more programs including instructions for:
displaying, via the display generation component of the first computer system, a plurality of notifications, wherein:
a first notification of the plurality of notifications is generated by a first application installed on the first computer system, and
a second notification of the plurality of notifications is generated by a second application installed on the second computer system;
while displaying the second notification, detecting, via the one or more input devices, an input selecting the second notification of the plurality of notifications; and
in response to detecting the input selecting the second notification of the plurality of notifications:
displaying, via the display generation component of the first computer system, a user interface that is generated by the second computer system.

30. A computer readable storage medium storing one or more programs, the one or more programs comprising instructions that, when executed by a first computer system that is in communication with a second computer system, wherein the first computer system includes and/or is in communication with a display generation component, and one or more input devices, cause the first computer system to:
display, via the display generation component of the first computer system, a plurality of notifications, wherein:
a first notification of the plurality of notifications is generated by a first application installed on the first computer system, and
a second notification of the plurality of notifications is generated by a second application installed on the second computer system;
while displaying the second notification, detect, via the one or more input devices, an input selecting the second notification of the plurality of notifications; and
in response to detecting the input selecting the second notification of the plurality of notifications:
display, via the display generation component of the first computer system, a user interface that is generated by the second computer system.
